(19) United States
(12) Patent Application Publication
(10) Pub. No.: US 2025/0330923 A1
(43) Pub. Date: Oct. 23, 2025

(54) SYSTEMS AND METHODS FOR TIME SYNCHRONIZATION OF SENSING TRANSMISSIONS MADE BY UNASSOCIATED STATIONS

(71) Applicant: COGNITIVE SYSTEMS CORP., Waterloo (CA)

(72) Inventors: Chris BEG, Waterloo, Ontario (CA); Mohammad OMER, Waterloo, Ontario (CA)

(21) Appl. No.: 18/862,820

(22) PCT Filed: May 3, 2023
(86) PCT No.: PCT/IB2023/054621

§ 371 Date: Nov. 4, 2024

Related U.S. Application Data
(60) Provisional application No. 63/339,201, filed on May 6, 2022.
(60) Provisional application No. 63/368,188, filed on Jul. 12, 2022.

(51) Int. Cl. H04W 56/00; H04W 84/12; H04W 84/18

(52) U.S. Cl. CPC H04W 56/001; H04W 84/12; H04W 84/18

(57) ABSTRACT

Systems and methods for Wi-Fi sensing by networking devices are provided. A sensing transmitter is configured to obtain timing information from an unassociated access point The sending transmitter is further configured to generate local timing information, according to the timing information and to receive a transmission request from the unassociated access point, the transmission request including a timing information update. The timing information update is used to update the local timing information. A transmission response including a timestamp based on updated local timing information is sent responsive to a transmission request.

### TECHNICAL FIELD

The present disclosure generally relates to systems and methods for Wi-Fi sensing. In particular, the present disclosure relates to systems and methods for time synchronization of sensing transmissions made by unassociated stations.

### BACKGROUND OF THE DISCLOSURE

A Wi-Fi sensing system may be configured to detect features of interest in a sensing space. The Wi-Fi sensing system may be a network of Wi-Fi-enabled devices which are part of an IEEE 802.11 network (sometimes referred to as a basic service set (BSS) or extended service set (ESS)). The features of interest may include motion of objects and motion tracking, presence detection, intrusion detection, gesture recognition, fall detection, breathing rate detection, and other applications. The sensing space may refer to any physical space in which a Wi-Fi sensing system may operate and may include a place of abode, a place of work, a shopping mall, a sports hall or sports stadium, a garden, or any other physical space.

### BRIEF SUMMARY OF THE DISCLOSURE

The present disclosure generally relates to systems and methods for Wi-Fi sensing. In particular, the present disclosure relates to systems and methods for time synchronization of sensing transmissions made by unassociated stations.

Systems and methods are provided for Wi-Fi sensing. In an example embodiment, a method for Wi-Fi sensing is described. The method is carried out by a networking device configured to operate as a sensing transmitter. The networking device operating as a sensing transmitter includes at least one processor configured to execute instructions. The method includes obtaining, by the sensing transmitter, timing information from an unassociated access point. In some embodiments, the method further includes generating, by the sensing transmitter, local timing information according to the timing information and receiving, by the sensing transmitter, a transmission request from the unassociated access point. The transmission request includes a timing information update. In some embodiments, the method further includes updating, by the sensing transmitter, the local timing information according to the timing information update. In some embodiments, the method further includes transmitting, by the sensing transmitter, a transmission response responsive to the transmission request. The transmission response includes a timestamp based on updated local timing information.

In some embodiments, the transmission request includes a sensing measurement setup request frame and the transmission response includes a sensing measurement setup response frame.

In some embodiments, the transmission request includes a sensing sounding trigger frame and the transmission response includes a sensing transmission.

In some embodiments, the transmission request includes a sensing polling trigger frame and the transmission response includes a CTS-to-self frame.

In some embodiments, the timing information is an access point TSF timer of the unassociated access point.

In some embodiments, the local timing information is a timer offset value determined according to a difference between the timing information and a sensing transmitter TSF timer.

In some embodiments, the timestamp is determined by combining the sensing transmitter TSF timer value with the timer offset value.

In some embodiments, the timing information update is a Partial TSF of the unassociated access point.

In some embodiments, the local timing information is maintained and incremented at the sensing transmitter.

In some embodiments, the local timing information is incremented at the sensing transmitter according to a local clock.

In some embodiments, prior to receiving the transmission request, the sensing transmitter engages in a PASN procedure with the unassociated access point.

In some embodiments, resynchronizing the local timing information is performed after expiration of a resynchronization timer.

In some embodiments, a time interval of the resynchronization timer is determined according to a measurement of timing drift between the unassociated access point and the sensing transmitter.

In some embodiments, the unassociated access point is a first unassociated access point.

In some embodiments, the method further includes obtaining, by the sensing transmitter, additional timing information from a plurality of additional unassociated access points, and generating, by the sensing transmitter, additional local timing information according to the additional timing information.

In some embodiments, the timing information is received in a beacon frame broadcast by the unassociated access point.

In some embodiments, the timing information is received in a probe response transmitted responsive to a probe request of the sensing transmitter.

In some embodiments, receiving the transmission request further includes tuning a receiver of the sensing transmitter to a channel of the unassociated access point, and engaging the receiver to receive the transmission request according to the local timing information.

Other aspects and advantages of the disclosure will become apparent from the following detailed description, taken in conjunction with the accompanying drawings, which illustrate by way of example, the principles of the disclosure.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a diagram showing an example wireless communication system;

FIG. 2A and FIG. 2B are diagrams showing example wireless signals communicated between wireless communication devices;

FIG. 3A and FIG. 3B are plots showing examples of channel responses computed from the wireless signals communicated between wireless communication devices in FIG. 2A and FIG. 2B;

FIG. 4A and FIG. 4B are diagrams showing example channel responses associated with motion of an object in distinct regions of a space;

FIG. 4C and FIG. 4D are plots showing the example channel responses of FIG. 4A and FIG. 4B overlaid on an example channel response associated with no motion occurring in the space;

FIG. 5 depicts an implementation of some of an architecture of a system for Wi-Fi sensing, according to some embodiments;

FIG. 6 depicts an example of a WLAN sensing procedure, according to some embodiments;

FIG. 7A depicts an example of a Sensing Measurement Setup Request frame format, according to some embodiments;

FIG. 7B illustrates an example of a Sensing Measurement Parameters element, according to some embodiments;

FIG. 7C illustrates an example of a format of a Sensing Measurement Parameters field, according to some embodiments;

FIG. 7D depicts an example of a Sensing Measurement Setup Response frame, according to some embodiments;

FIG. 8A depicts one-to-many and many-to-one aspects of an example of a WLAN sensing procedure, according to some embodiments;

FIG. 8B depicts pairwise aspects of an example of a WLAN sensing procedure, according to some embodiments;

FIG. 9 depicts a message flow of a trigger-based (TB) sensing measurement instance of a WLAN sensing procedure that consists of either NDPA sounding or TF sounding, according to some embodiments;

FIG. 10A and FIG. 10B depict examples of trigger-based (TB) sensing measurement instances, according to some embodiments;

FIG. 11A and FIG. 11B depict an example of a single TB sensing measurement instance including a polling phase, a trigger frame sounding phase, and an NDPA sounding phase, according to some embodiments;

FIG. 12 depicts a message flow of a non-TB sensing measurement instance of a WLAN sensing procedure with both uplink and downlink sounding, according to some embodiments;

FIG. 13 depicts an example of a single non-TB sensing measurement instance, according to some embodiments;

FIG. 14 depicts an example of a Public Action frame format of a Sensing Measurement Report frame and a Sensing Measurement Report field format, according to some embodiments;

FIG. 15A to FIG. 15H depict a hierarchy of fields within a sensing trigger, according to some embodiments;

FIG. 16 depicts an example representation of a typical Wi-Fi sensing system, according to some embodiments;

FIG. 17 depicts a process for pre-association security negotiation (PASN) authentication, according to some embodiments;

FIG. 18 depicts an example of a timing synchronization function (TSF) timer unsynchronized situation, according to some embodiments;

FIG. 19 depicts an example of communications between a station, an associated access point, and unassociated access point, according to some embodiments;

FIG. 20 depicts a format of a Wireless Network Management (WNM) sleep mode element, according to some embodiments;

FIG. 21 depicts a format of a Frame Control field with Power Management bit, according to some embodiments;

FIG. 22 depicts a format of sensing measurement parameters fields with Partial TSF fields, according to some embodiments;

FIG. 23 depicts a format of sensing measurement setup termination frame action field, according to some embodiments;

FIG. 24 depicts a format of Trigger Dependent Common Info subfield of Common Info field within a sensing polling trigger frame, according to some embodiments;

FIG. 25 depicts an example of User Info field format for a sensing polling trigger frame, according to some embodiments;

FIG. 26 depicts a format of Trigger Dependent Common Info subfield of Common Info field within a sensing sounding trigger frame, according to some embodiments;

FIG. 27 depicts an example of User Info field format for a sensing sounding trigger frame, according to some embodiments;

FIG. 28 depicts an example of Sensing Trigger Dependent Common Info subfield, according to some embodiments;

FIG. 29 depicts a flowchart for transmitting, by a sensing transmitter, a transmission response responsive to a transmission request received from a sensing receiver, according to some embodiments;

FIG. 30A and FIG. 30B depict another flowchart for transmitting, by a sensing transmitter, a transmission response responsive to a transmission request received from a sensing receiver, according to some embodiments; and

FIG. 31A and FIG. 31B depict a flowchart for resynchronizing local timing information, according to some embodiments.

### DETAILED DESCRIPTION

Wireless sensing enables a device to obtain sensing measurements of transmission channel(s) between two or more devices. With the execution of a wireless sensing procedure, it is possible for a device to obtain sensing measurements useful for detecting and tracking changes in the environment. In some aspects of what is described herein, a wireless sensing system may be used for a variety of wireless sensing applications by processing wireless signals (e.g., radio frequency (RF) signals) transmitted through a space between wireless communication devices. Example wireless sensing applications include motion detection, which can include the following: detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications. Other examples of wireless sensing applications include object recognition, speaking recognition, keystroke detection and recognition, tamper detection, touch detection, attack detection, user authentication, driver fatigue detection, traffic monitoring, smoking detection, school violence detection, human counting, human recognition, bike localization, human queue estimation, Wi-Fi imaging, and other types of wireless sensing applications. For instance, the wireless sensing system may operate as a motion detection system to detect the existence and location of motion based on Wi-Fi signals or other types of wireless signals. As described in more detail below, a wireless sensing system may be configured to control measurement rates, wireless connections, and device participation, for example, to improve system operation or to achieve other technical advantages. The system improvements and technical advantages achieved when the wireless sensing system is used for motion detection are also achieved in examples where the wireless sensing system is used for another type of wireless sensing application.

In some example wireless sensing systems, a wireless signal includes a component (e.g., a synchronization preamble in a Wi-Fi PHY frame, or another type of component) that wireless devices can use to estimate a channel response or other channel information, and the wireless sensing system can detect motion (or another characteristic depending on the wireless sensing application) by analyzing changes in the channel information collected over time. In some examples, a wireless sensing system can operate similar to a bistatic radar system, where a Wi-Fi access point (AP) assumes the receiver role, and each Wi-Fi device (station (STA), node, or peer) connected to the AP assumes the transmitter role. The wireless sensing system may trigger a connected device to generate a transmission and produce a channel response measurement at a receiver device. This triggering process can be repeated periodically to obtain a sequence of time variant measurements. A wireless sensing algorithm may then receive the generated time-series of channel response measurements (e.g., computed by Wi-Fi receivers) as input, and through a correlation or filtering process, may then make a determination (e.g., determine if there is motion or no motion within the environment represented by the channel response, for example, based on changes or patterns in the channel estimations). In examples where the wireless sensing system detects motion, it may also be possible to identify a location of the motion within the environment based on motion detection results among a number of wireless devices.

Accordingly, wireless signals received at each of the wireless communication devices in a wireless communication network may be analyzed to determine channel information for the various communication links (between respective pairs of wireless communication devices) in the network. The channel information may be representative of a physical medium that applies a transfer function to wireless signals that traverse a space. In some instances, the channel information includes a channel response. Channel responses can characterize a physical communication path, representing the combined effect of, for example, scattering, fading, and power decay within the space between the transmitter and receiver. In some instances, the channel information includes beamforming state information (e.g., a feedback matrix, a steering matrix, channel state information, etc.) provided by a beamforming system. Beamforming is a signal processing technique often used in multi-antenna (multiple-input/multiple-output (MIMO)) radio systems for directional signal transmission or reception. Beamforming can be achieved by operating elements in an antenna array in such a way that signals at some angles experience constructive interference while others experience destructive interference.

The channel information for each of the communication links may be analyzed (e.g., by a hub device or other device in a wireless communication network, or a sensing transmitter, sensing receiver, or sensing initiator communicably coupled to the network) to, for example, detect whether motion has occurred in the space, to determine a relative location of the detected motion, or both. In some aspects, the channel information for each of the communication links may be analyzed to detect whether an object is present or absent, e.g., when no motion is detected in the space.

In some cases, a wireless sensing system can control a node measurement rate. For instance, a Wi-Fi motion system may configure variable measurement rates (e.g., channel estimation/environment measurement/sampling rates) based on criteria given by a current wireless sensing application (e.g., motion detection). In some implementations, when no motion is present or detected for a period of time, for example, the wireless sensing system can reduce the rate that the environment is measured, such that the connected device will be triggered or caused to make sensing transmissions or sensing measurements less frequently. In some implementations, when motion is present, for example, the wireless sensing system can increase the triggering rate or sensing transmissions rate or sensing measurement rate to produce a time-series of measurements with finer time resolution. Controlling a variable sensing measurement rate can allow energy conservation (through the device triggering), reduce processing (less data to correlate or filter), and improve resolution during specified times.

In some cases, a wireless sensing system can perform band steering or client steering of nodes throughout a wireless network, for example, in a Wi-Fi multi-AP or extended service set (ESS) topology, multiple coordinating wireless APs each provide a basic service set (BSS) which may occupy different frequency bands and allow devices to transparently move between from one participating AP to another (e.g., mesh). For instance, within a home mesh network, Wi-Fi devices can connect to any of the APs, but typically select one with good signal strength. The coverage footprint of the mesh APs typically overlap, often putting each device within communication range or more than one AP. If the AP supports multi-bands (e.g., 2.4 GHz and 5 GHz), the wireless sensing system may keep a device connected to the same physical AP but instruct it to use a different frequency band to obtain more diverse information to help improve the accuracy or results of the wireless sensing algorithm (e.g., motion detection algorithm). In some implementations, the wireless sensing system can change a device from being connected to one mesh AP to being connected to another mesh AP. Such device steering can be performed, for example, during wireless sensing (e.g., motion detection), based on criteria detected in a specific area to improve detection coverage, or to better localize motion within an area.

In some cases, beamforming may be performed between wireless communication devices based on some knowledge of the communication channel (e.g., through feedback properties generated by a receiver), which can be used to generate one or more steering properties (e.g., a steering matrix) that are applied by a transmitter device to shape the transmitted beam/signal in a particular direction or directions. Thus, changes to the steering or feedback properties used in the beamforming process indicate changes, which may be caused by moving objects, in the space accessed by the wireless communication system. For example, motion may be detected by substantial changes in the communication channel, e.g., as indicated by a channel response, or steering or feedback properties, or any combination thereof, over a period of time.

In some implementations, for example, a steering matrix may be generated at a transmitter device (beamformer) based on a feedback matrix provided by a receiver device (beamformee) based on channel sounding. Because the steering and feedback matrices are related to propagation characteristics of the channel, these matrices change as objects move within the channel. Changes in the channel characteristics are accordingly reflected in these matrices, and by analyzing the matrices, motion can be detected, and different characteristics of the detected motion can be determined. In some implementations, a spatial map may be generated based on one or more beamforming matrices. The spatial map may indicate a general direction of an object in a space relative to a wireless communication device. In some cases, many beamforming matrices (e.g., feedback matrices or steering matrices) may be generated to represent a multitude of directions that an object may be located relative to a wireless communication device. These many beamforming matrices may be used to generate the spatial map. The spatial map may be used to detect the presence of motion in the space or to detect a location of the detected motion.

In some instances, a motion detection system can control a variable device measurement rate in a motion detection process. For example, a feedback control system for a multi-node wireless motion detection system may adaptively change the sample rate based on environmental conditions. In some cases, such controls can improve operation of the motion detection system or provide other technical advantages. For example, the measurement rate may be controlled in a manner that optimizes or otherwise improves air-time usage versus detection ability suitable for a wide range of different environments and different motion detection applications. The measurement rate may be controlled in a manner that reduces redundant measurement data to be processed, thereby reducing processor load/power requirements. In some cases, the measurement rate is controlled in a manner that is adaptive, for instance, an adaptive sample can be controlled individually for each participating device. An adaptive sample rate can be used with a tuning control loop for different use cases, or device characteristics.

In some cases, a wireless sensing system can allow devices to dynamically indicate and communicate their wireless sensing capability or wireless sensing willingness to the wireless sensing system. For example, there may be times when a device does not want to be periodically interrupted or triggered to transmit a wireless signal that would allow the AP to produce a channel measurement. For instance, if a device is sleeping, frequently waking the device up to transmit or receive wireless sensing signals could consume resources (e.g., causing a cell phone battery to discharge faster). These and other events could make a device willing or not willing to participate in wireless sensing system operations. In some cases, a cell phone running on its battery may not want to participate, but when the cell phone is plugged into the charger, it may be willing to participate. Accordingly, if the cell phone is unplugged, it may indicate to the wireless sensing system to exclude the cell phone from participating; whereas if the cell phone is plugged in, it may indicate to the wireless sensing system to include the cell phone in wireless sensing system operations. In some cases, if a device is under load (e.g., a device streaming audio or video) or busy performing a primary function, the device may not want to participate; whereas when the same device's load is reduced and participating will not interfere with a primary function, the device may indicate to the wireless sensing system that it is willing to participate.

Example wireless sensing systems are described below in the context of motion detection (detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications). However, the operation, system improvements, and technical advantages achieved when the wireless sensing system is operating as a motion detection system are also applicable in examples where the wireless sensing system is used for another type of wireless sensing application.

In various embodiments of the disclosure, non-limiting definitions of one or more terms that will be used in the description are provided below.

A term “measurement campaign” may refer to a bi-directional series of one or more sensing transmissions between a sensing receiver and a sensing transmitter that allows a series of one or more sensing measurements to be computed.

A wireless access point (WAP) or simply an access point (AP) is a networking device in a WLAN network that allows other networking devices in a WLAN network to connect to a wired network. In examples, an AP creates a wireless local area network.

A station (STA) is any device that is connected to a WLAN network and which contains 802.11 compliant MAC and PHY interface to the wireless medium. A STA may be a laptop, desktop, smartphone, or a smart appliance. A STA may be fixed, mobile or portable. A STA that does not take on the roles of an AP may be referred to as a non-AP STA.

A term “transmission opportunity (TXOP)” may refer to a negotiated interval of time during which a particular quality of service (QoS) station (e.g., a STA, an AP, or either a STA or an AP, for example in the role of a sensing initiator, a sensing responder, a sensing transmitter or a sensing receiver) may have the right to initiate a frame exchange onto a wireless medium. A QoS access category (AC) of the transmission opportunity may be requested as part of a service or session negotiation. In examples, TXOP may be a period of time for the transmission (e.g., data transmission or sensing transmission).

A term “Quality of Service (QoS) access category (AC)” may refer to an identifier for a frame which classifies a priority of transmission that the frame requires. In an example, four QoS access categories are defined namely AC_VI: Video, AC_VO: Voice, AC_BE: Best-Effort, and AC_BK: Background. Further, each QoS access category may have different TXOP parameters defined for it.

A term “short interframe space (SIFS)” may refer to a period within which a processing element (for example, a microprocessor, dedicated hardware, or any such element) within a device of a Wi-Fi sensing system is able to process data presented to it in a frame. In an example, a short interframe space may be 10 ms.

A term “PHY-layer Protocol Data Unit (PPDU)” may refer to a data unit that includes preamble and data fields. The preamble field may include transmission vector format information and the data field may include payload and higher layer headers.

A term “null data PPDU (NDP)” may refer to a PPDU that does not include a data field. In an example, a null data PPDU may be used for a sensing transmission, where a MAC header of the NDP includes information required for a sensing receiver to make a sensing measurement on the sensing transmission.

A term “transmission parameters” may refer to a set of IEEE 802.11 PHY transmitter configuration parameters which are defined as a part of transmission vector (TXVECTOR) corresponding to a specific PHY and which may be configurable for each PHY-layer PPDU transmission or each null data PPDU (NDP) transmission.

A term “resource unit (RU)” may refer to an allocation of orthogonal frequency division multiplexing (OFDM) channels which may be used to carry a modulated signal. An RU may include a variable number of carriers depending on the mode of the modem.

A term “sensing goal” may refer to a goal of a sensing activity at a time. A sensing goal is not static and may change at any time. In an example, a sensing goal may require sensing measurements of a specific type, a specific format, or a specific precision, resolution, or accuracy to be available to a sensing algorithm.

A term “sensing space” may refer to any physical space in which a Wi-Fi sensing system may operate.

A term “sensing measurement” may refer to a measurement of a state of a wireless channel between a transmitter device (for example, a sensing transmitter) and a receiver device (for example, a sensing receiver) derived from a sensing transmission. In an example, sensing measurement may also be referred to as channel response measurement.

A term “sensing algorithm” may refer to a computational algorithm that achieves a sensing goal. A sensing algorithm may be executed on any device in a Wi-Fi sensing system.

A sensing receiver is a station (STA) that receives sensing transmissions (for example, PPDUs or any other transmission including a data transmission which may be opportunistically used as a sensing transmission) sent by a sensing transmitter and performs sensing measurements as part of a WLAN sensing procedure. An AP is an example of a sensing receiver. In some examples, a STA may also be a sensing receiver.

A sensing transmitter is a station (STA) that transmits a sensing transmission (for example, PPDUs or any other transmission) used for sensing measurements (for example, channel state information) in a WLAN sensing procedure. In an example, a STA is an example of a sensing transmitter. In some examples, an AP may be a sensing transmitter for Wi-Fi sensing purposes, for example where a STA acts as a sensing receiver.

A sensing initiator is a station (STA) that initiates a WLAN sensing procedure. The role of sensing initiator may be taken on by a sensing receiver, a sensing transmitter, or a separate device which includes a sensing algorithm (for example, a remote processing device).

A sensing responder is a station (STA) that participates in a WLAN sensing procedure initiated by a sensing initiator. The role of sensing responder may be taken on by a sensing receiver or a sensing transmitter. In examples, multiple sensing responders may take part in a Wi-Fi sensing session.

A term “sensing transmission” may refer to any transmission made from a sensing transmitter to a sensing receiver that may be used to make a sensing measurement. In an example, sensing transmission may also be referred to as wireless sensing signal or wireless signal.

A term “sensing trigger message” may refer to a message sent from a sensing initiator to a sensing transmitter to initiate or trigger one or more sensing transmissions.

A term “sensing response message” may refer to a message which is included within a sensing transmission from a sensing transmitter to a sensing receiver. A sensing transmission that includes a sensing response message may be used by a sensing receiver to perform a sensing measurement.

A term “sensing response announcement” may refer to a message that is included within a sensing transmission from a sensing transmitter to a sensing receiver that announces that a sensing response NDP will follow within a short interframe space (SIFS). An example of a sensing response announcement is an NDP announcement, or NDPA. In examples, a sensing response NDP may be transmitted using a requested transmission configuration.

A term “sensing announcement” may refer to a message that is included within a sensing transmission from a sensing transmitter to a sensing receiver that announces that a sensing NDP will follow within a short interframe space (SIFS). An example of a sensing announcement is an NDP announcement, or NDPA. In examples, a sensing NDP may be transmitted using a requested transmission configuration.

A term “sensing response NDP” or “sensing NDP” may refer to a response transmitted by a sensing transmitter and used for a sensing measurement at a sensing receiver. In examples, a sensing response NDP may be used when a requested transmission configuration is incompatible with transmission parameters required for successful non-sensing message reception. A sensing response NDP may be announced by a sensing response announcement. In an example, a sensing response NDP may be implemented with a null data PPDU. In some examples, a sensing response NDP may be implemented with a frame that does not contain any data.

A “transmission channel” may refer to a tunable channel on which the sensing receiver performs a sensing measurement and/or on which the sensing transmitter performs a sensing transmission.

A term “clear to send (CTS)” may refer to a function that may be used to let an access point know that a station is ready (or is clear without channel conflicts) to send or receive data.

A term “timing synchronization function (TSF) timer” may refer to a timer that may be used as a local timer in a Wi-Fi sensing system. A TSF timer may be based on a 1-MHz clock and may tick in microseconds. In examples, the TSF timer is represented by a 64 bit register [63:0] which is incremented every microsecond.

A term “OBSS STA” may refer to a STA which is in an unassociated state with an AP.

A term “OBSS AP” may refer to an AP which is in an unassociated state with a STA.

A term “timestamp” may refer to a value associated with a sensing measurement which indicates a time reference for the sensing measurement. In an example, a sensing algorithm may use timestamp for calculating a sensing result.

A term “OBSS STA TSF timer” may refer to a local TSF timer (according to IEEE 802.11 standards) that the STA maintains, which is incremented in time units (TU) based on the STA voltage controlled oscillator (VCO).

A term “OBSS AP TSF timer” may refer to a local TSF timer (according to IEEE 802.11 standards) that the AP maintains, which is incremented in TU based on the AP VCO.

A term “OBSS STA-AP TSF timer” may refer to a local version of a TSF timer maintained and incremented at a STA, which is periodically resynchronized to an OBSS AP TSF timer.

A term “timer offset” may refer to a difference in TU between an OBSS AP TSF timer and an OBSS STA TSF timer at a point in time.

A term “adjusted OBSS STA TSF timer” may refer to a timer that has a value equal to the OBSS STA TSF timer combined with a timer offset.

A term “resynchronization timer” may refer to a timer associated with an OBSS STA and OBSS AP which represents the amount of time before the OBSS STA-AP TSF timer should be considered to be unsynchronized with the OBSS AP TSF timer.

A term “synchronization flag” may refer to a bit flag indication of whether or not the OBSS STA-AP TSF timer is synchronized with the OBSS AP TSF timer.

A term “wireless local area network (WLAN) sensing session” or “Wi-Fi sensing session” may refer to a period during which objects in a physical space may be probed, detected and/or characterized. In an example, during a WLAN sensing session, several devices participate in, and thereby contribute to the generation of sensing measurements. In an example, a measurement campaign may be carried out within a WLAN sensing session.

For purposes of reading the description of the various embodiments below, the following descriptions of the sections of the specifications and their respective contents may be helpful:

Section A describes a wireless communications system, wireless transmissions and sensing measurements which may be useful for practicing embodiments described herein.

Section B describes systems and methods that are useful for a wireless sensing system configurated to send sensing transmissions and make sensing measurements.

Section C describes embodiments of systems and methods for time synchronization of sensing transmissions made by unassociated stations.

### A. Wireless Communications System, Wireless Transmissions, and Sensing Measurements

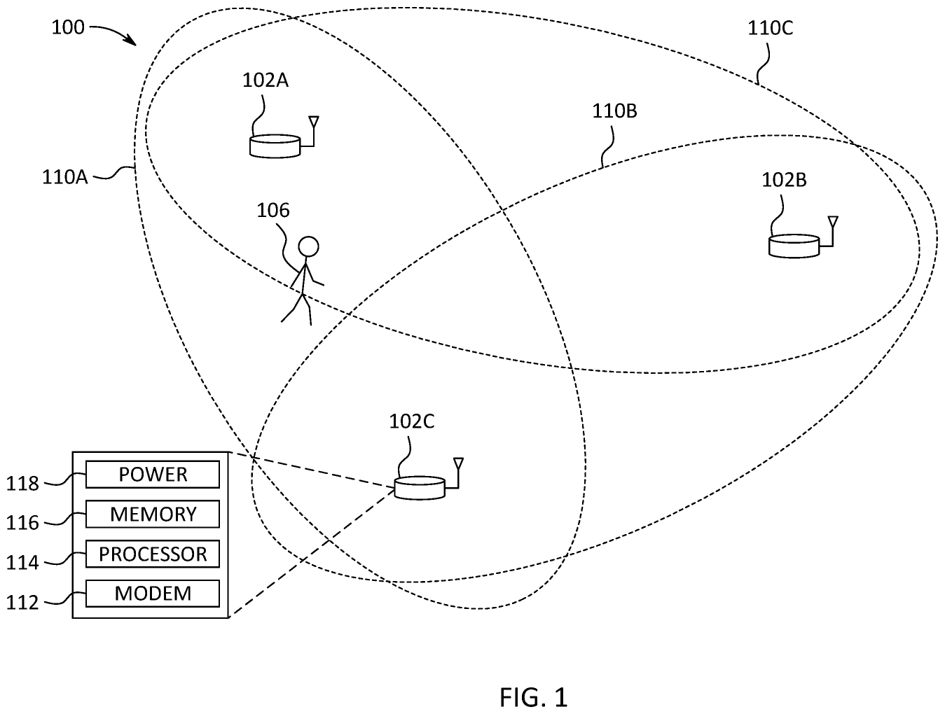

FIG. 1 illustrates wireless communication system 100. Wireless communication system 100 includes three wireless communication devices: first wireless communication device 102A, second wireless communication device 102B, and third wireless communication device 102C. Wireless communication system 100 may include additional wireless communication devices and other components (e.g., additional wireless communication devices, one or more network servers, network routers, network switches, cables, or other communication links, etc.).

Wireless communication devices 102A, 102B, 102C can operate in a wireless network, for example, according to a wireless network standard or another type of wireless communication protocol. For example, the wireless network may be configured to operate as a wireless local area network (WLAN), a personal area network (PAN), a metropolitan area network (MAN), or another type of wireless network. Examples of WLANs include networks configured to operate according to one or more of the 802.11 family of standards developed by IEEE (e.g., Wi-Fi networks), and others. Examples of PANs include networks that operate according to short-range communication standards (e.g., Bluetooth®, Near Field Communication (NFC), ZigBee), millimeter wave communications, and others.

In some implementations, wireless communication devices 102A, 102B, 102C may be configured to communicate in a cellular network, for example, according to a cellular network standard. Examples of cellular networks include networks configured according to 2G standards such as Global System for Mobile (GSM) and Enhanced Data rates for GSM Evolution (EDGE) or EGPRS; 3G standards such as code division multiple access (CDMA), wideband code division multiple access (WCDMA), Universal Mobile Telecommunications System (UMTS), and time division synchronous code division multiple access (TD-SCDMA); 4G standards such as Long-Term Evolution (LTE) and LTE-Advanced (LTE-A); 5G standards, and others.

In the example shown in FIG. 1, wireless communication devices 102A, 102B, 102C can be, or they may include standard wireless network components. For example, wireless communication devices 102A, 102B, 102C may be commercially-available Wi-Fi APs or another type of wireless access point (WAP) performing one or more operations as described herein that are embedded as instructions (e.g., software or firmware) on the modem of the WAP. In some cases, wireless communication devices 102A, 102B, 102C may be nodes of a wireless mesh network, such as, for example, a commercially-available mesh network system (e.g., Plume Wi-Fi, Google Wi-Fi, Qualcomm Wi-Fi SoN, etc.). In some cases, another type of standard or conventional Wi-Fi transmitter device may be used. In some instances, one or more of wireless communication devices 102A, 102B, 102C may be implemented as WAPs in a mesh network, while other wireless communication device(s) 102A, 102B, 102C are implemented as leaf devices (e.g., mobile devices, smart devices, etc.) that access the mesh network through one of the WAPs. In some cases, one or more of wireless communication devices 102A, 102B, 102C is a mobile device (e.g., a smartphone, a smart watch, a tablet, a laptop computer, etc.), a wireless-enabled device (e.g., a smart thermostat, a Wi-Fi enabled camera, a smart TV), or another type of device that communicates in a wireless network.

Wireless communication devices 102A, 102B, 102C may be implemented without Wi-Fi components; for example, other types of standard or non-standard wireless communication may be used for motion detection. In some cases, wireless communication devices 102A, 102B, 102C can be, or they may be part of, a dedicated motion detection system. For example, the dedicated motion detection system can include a hub device and one or more beacon devices (as remote sensor devices), and wireless communication devices 102A, 102B, 102C can be either a hub device or a beacon device in the motion detection system.

As shown in FIG. 1, wireless communication device 102C includes modem 112, processor 114, memory 116, and power unit 118; any of wireless communication devices 102A, 102B, 102C in wireless communication system 100 may include the same, additional, or different components, and the components may be configured to operate as shown in FIG. 1 or in another manner. In some implementations, modem 112, processor 114, memory 116, and power unit 118 of a wireless communication device are housed together in a common housing or other assembly. In some implementations, one or more of the components of a wireless communication device can be housed separately, for example, in a separate housing or other assembly.

Modem 112 can communicate (receive, transmit, or both) wireless signals. For example, modem 112 may be configured to communicate RF signals formatted according to a wireless communication standard (e.g., Wi-Fi or Bluetooth). Modem 112 may be implemented as the example wireless network modem 112 shown in FIG. 1, or may be implemented in another manner, for example, with other types of components or subsystems. In some implementations, modem 112 includes a radio subsystem and a baseband subsystem. In some cases, the baseband subsystem and radio subsystem can be implemented on a common chip or chipset, or they may be implemented in a card or another type of assembled device. The baseband subsystem can be coupled to the radio subsystem, for example, by leads, pins, wires, or other types of connections.

In some cases, a radio subsystem in modem 112 can include one or more antennas and RF circuitry. The RF circuitry can include, for example, circuitry that filters, amplifies, or otherwise conditions analog signals, circuitry that up-converts baseband signals to RF signals, circuitry that down-converts RF signals to baseband signals, etc. Such circuitry may include, for example, filters, amplifiers, mixers, a local oscillator, etc. The radio subsystem can be configured to communicate radio frequency wireless signals on the wireless communication channels. As an example, the radio subsystem may include a radio chip, an RF front end, and one or more antennas. A radio subsystem may include additional or different components. In some implementations, the radio subsystem can be or may include the radio electronics (e.g., RF front end, radio chip, or analogous components) from a conventional modem, for example, from a Wi-Fi modem, pico base station modem, etc. In some implementations, the antenna includes multiple antennas.

In some cases, a baseband subsystem in modem 112 can include, for example, digital electronics configured to process digital baseband data. As an example, the baseband subsystem may include a baseband chip. A baseband subsystem may include additional or different components. In some cases, the baseband subsystem may include a digital signal processor (DSP) device or another type of processor device. In some cases, the baseband system includes digital processing logic to operate the radio subsystem, to communicate wireless network traffic through the radio subsystem, to detect motion based on motion detection signals received through the radio subsystem or to perform other types of processes. For instance, the baseband subsystem may include one or more chips, chipsets, or other types of devices that are configured to encode signals and deliver the encoded signals to the radio subsystem for transmission, or to identify and analyze data encoded in signals from the radio subsystem (e.g., by decoding the signals according to a wireless communication standard, by processing the signals according to a motion detection process, or otherwise).

In some instances, the radio subsystem in modem 112 receives baseband signals from the baseband subsystem, up-converts the baseband signals to RF signals, and wirelessly transmits the RF signals (e.g., through an antenna). In some instances, the radio subsystem in modem 112 wirelessly receives RF signals (e.g., through an antenna), down-converts the RF to baseband signals, and sends the baseband signals to the baseband subsystem. The signals exchanged between the radio subsystem and the baseband subsystem may be digital or analog signals. In some examples, the baseband subsystem includes conversion circuitry (e.g., a digital-to-analog converter, an analog-to-digital converter) and exchanges analog signals with the radio subsystem. In some examples, the radio subsystem includes conversion circuitry (e.g., a digital-to-analog converter, an analog-to-digital converter) and exchanges digital signals with the baseband subsystem.

In some cases, the baseband subsystem of modem 112 can communicate wireless network traffic (e.g., data packets) in the wireless communication network through the radio subsystem on one or more network traffic channels. The baseband subsystem of modem 112 may also transmit or receive (or both) signals (e.g., motion probe signals or motion detection signals) through the radio subsystem on a dedicated wireless communication channel. In some instances, the baseband subsystem generates motion probe signals for transmission, for example, to probe a space for motion. In some instances, the baseband subsystem processes received motion detection signals (signals based on motion probe signals transmitted through the space), for example, to detect motion of an object in a space.

Processor 114 can execute instructions, for example, to generate output data based on data inputs. The instructions can include programs, codes, scripts, or other types of data stored in memory. Additionally, or alternatively, the instructions can be encoded as pre-programmed or re-programmable logic circuits, logic gates, or other types of hardware or firmware components. Processor 114 may be or include a general-purpose microprocessor, as a specialized co-processor or another type of data processing apparatus. In some cases, processor 114 performs high level operation of the wireless communication device 102C. For example, processor 114 may be configured to execute or interpret software, scripts, programs, functions, executables, or other instructions stored in memory 116. In some implementations, processor 114 may be included in modem 112.

Memory 116 can include computer-readable storage media, for example, a volatile memory device, a non-volatile memory device, or both. Memory 116 can include one or more read-only memory devices, random-access memory devices, buffer memory devices, or a combination of these and other types of memory devices. In some instances, one or more components of the memory can be integrated or otherwise associated with another component of wireless communication device 102C. Memory 116 may store instructions that are executable by processor 114. For example, the instructions may include instructions for time-aligning signals using an interference buffer and a motion detection buffer, such as through one or more of the operations of the example processes herein disclosed.

Power unit 118 provides power to the other components of wireless communication device 102C. For example, the other components may operate based on electrical power provided by power unit 118 through a voltage bus or other connection. In some implementations, power unit 118 includes a battery or a battery system, for example, a rechargeable battery. In some implementations, power unit 118 includes an adapter (e.g., an alternating current (AC) adapter) that receives an external power signal (from an external source) and coverts the external power signal to an internal power signal conditioned for a component of wireless communication device 102C. Power unit 118 may include other components or operate in another manner.

In the example shown in FIG. 1, wireless communication devices 102A, 102B transmit wireless signals (e.g., according to a wireless network standard, a motion detection protocol, or otherwise). For instance, wireless communication devices 102A, 102B may broadcast wireless motion probe signals (e.g., reference signals, beacon signals, status signals, etc.), or they may send wireless signals addressed to other devices (e.g., a user equipment, a client device, a server, etc.), and the other devices (not shown) as well as wireless communication device 102C may receive the wireless signals transmitted by wireless communication devices 102A, 102B. In some cases, the wireless signals transmitted by wireless communication devices 102A, 102B are repeated periodically, for example, according to a wireless communication standard or otherwise.

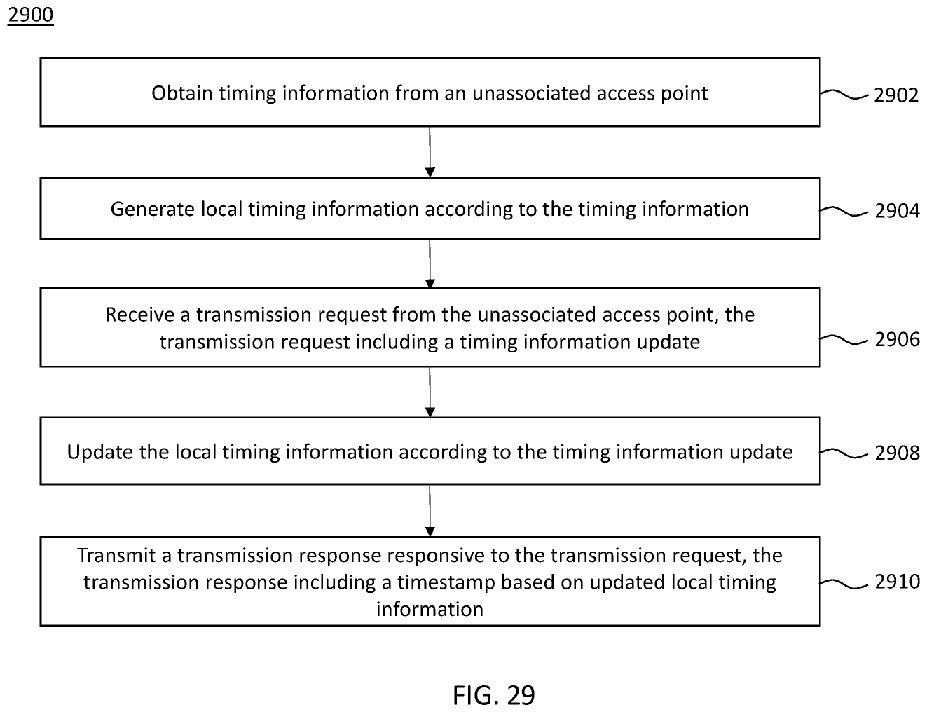

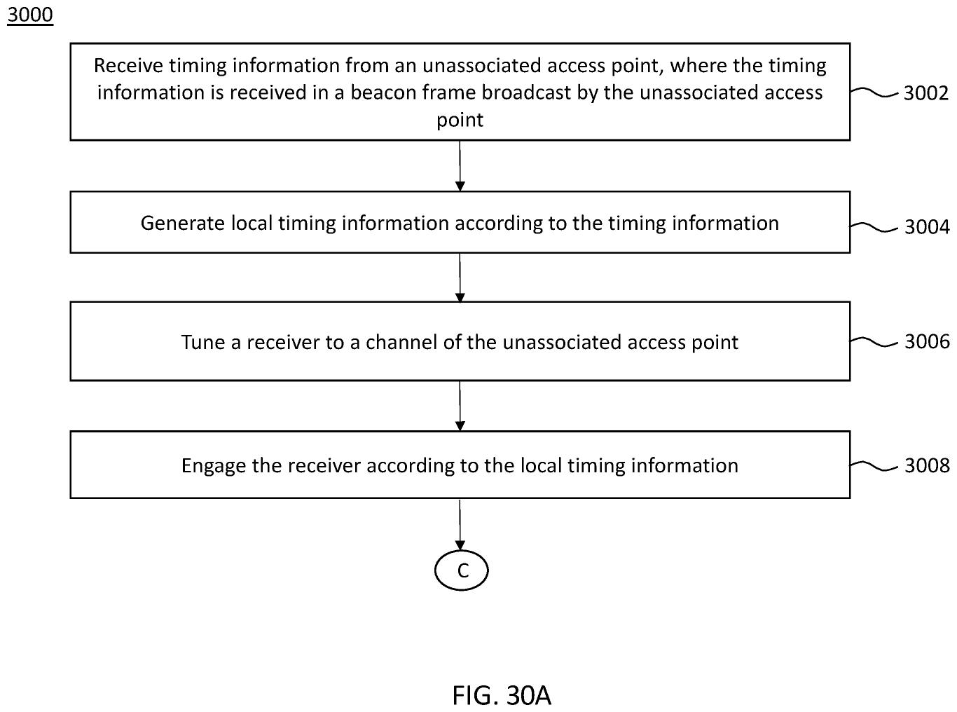

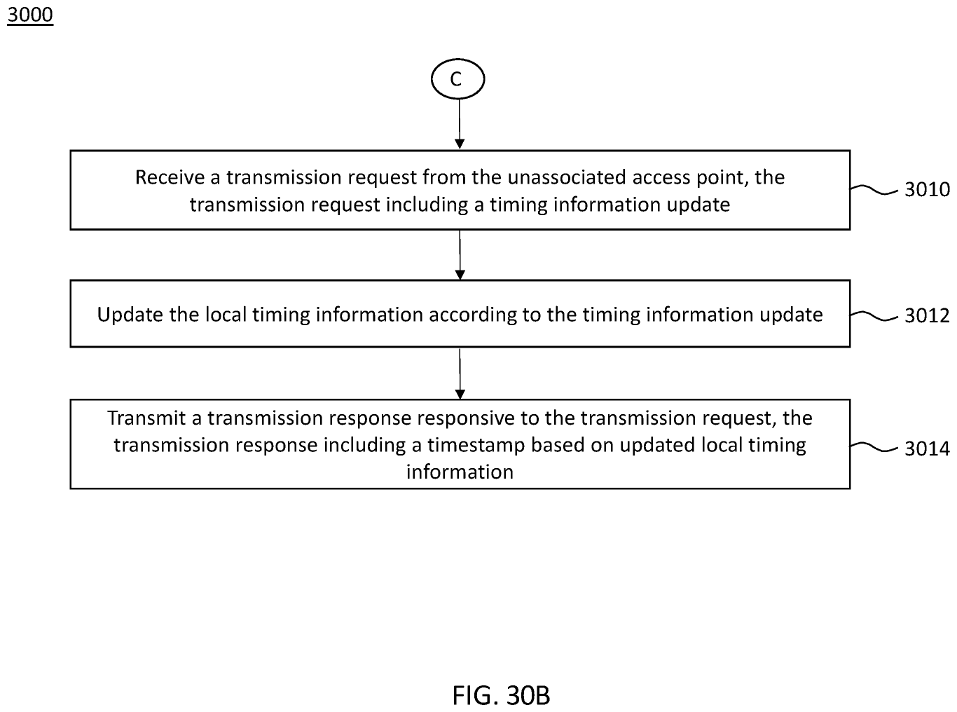

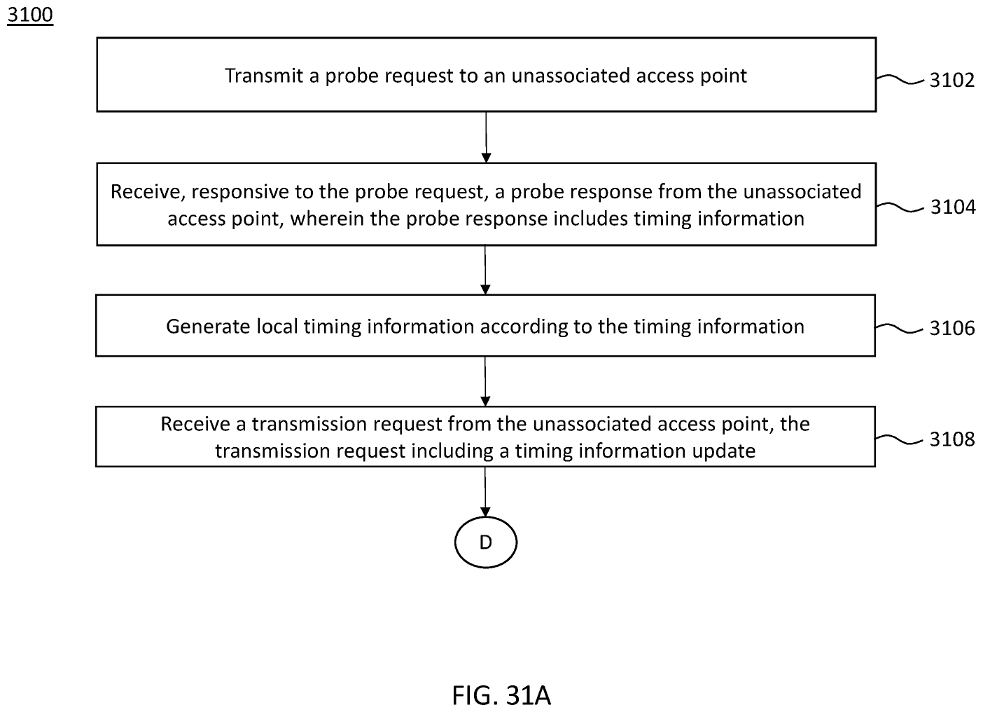

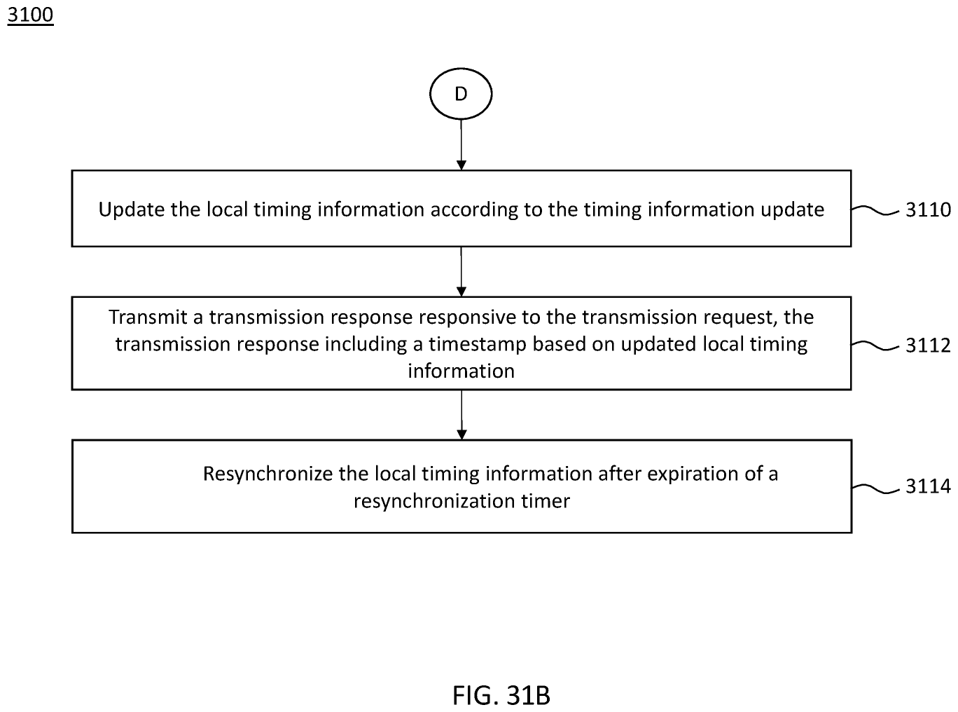

In the example shown, wireless communication device 102C processes the wireless signals from wireless communication devices 102A, 102B to detect motion of an object in a space accessed by the wireless signals, to determine a location of the detected motion, or both. For example, wireless communication device 102C may perform one or more operations of the example processes described below with respect to FIG. 29, FIG. 30A, FIG. 30B, FIG. 31A, and FIG. 31B or another type of process for detecting motion or determining a location of detected motion. The space accessed by the wireless signals can be an indoor or outdoor space, which may include, for example, one or more fully or partially enclosed areas, an open area without enclosure, etc. The space can be or can include an interior of a room, multiple rooms, a building, or the like. In some cases, the wireless communication system 100 can be modified, for instance, such that wireless communication device 102C can transmit wireless signals and wireless communication devices 102A, 102B can processes the wireless signals from wireless communication device 102C to detect motion or determine a location of detected motion.

The wireless signals used for motion detection can include, for example, a beacon signal (e.g., Bluetooth Beacons, Wi-Fi Beacons, other wireless beacon signals), another standard signal generated for other purposes according to a wireless network standard, or non-standard signals (e.g., random signals, reference signals, etc.) generated for motion detection or other purposes. In examples, motion detection may be carried out by analyzing one or more training fields carried by the wireless signals or by analyzing other data carried by the signal. In some examples data will be added for the express purpose of motion detection or the data used will nominally be for another purpose and reused or repurposed for motion detection. In some examples, the wireless signals propagate through an object (e.g., a wall) before or after interacting with a moving object, which may allow the moving object's movement to be detected without an optical line-of-sight between the moving object and the transmission or receiving hardware. Based on the received signals, wireless communication device 102C may generate motion detection data. In some instances, wireless communication device 102C may communicate the motion detection data to another device or system, such as a security system, which may include a control center for monitoring movement within a space, such as a room, building, outdoor area, etc.

In some implementations, wireless communication devices 102A, 102B can be modified to transmit motion probe signals (which may include, e.g., a reference signal, beacon signal, or another signal used to probe a space for motion) on a separate wireless communication channel (e.g., a frequency channel or coded channel) from wireless network traffic signals. For example, the modulation applied to the payload of a motion probe signal and the type of data or data structure in the payload may be known by wireless communication device 102C, which may reduce the amount of processing that wireless communication device 102C performs for motion sensing. The header may include additional information such as, for example, an indication of whether motion was detected by another device in communication system 100, an indication of the modulation type, an identification of the device transmitting the signal, etc.

In the example shown in FIG. 1, wireless communication system 100 is a wireless mesh network, with wireless communication links between each of wireless communication devices 102. In the example shown, the wireless communication link between wireless communication device 102C and wireless communication device 102A can be used to probe motion detection field 110A, the wireless communication link between wireless communication device 102C and wireless communication device 102B can be used to probe motion detection field 110B, and the wireless communication link between wireless communication device 102A and wireless communication device 102B can be used to probe motion detection field 110C. In some instances, each wireless communication device 102 detects motion in motion detection fields 110 accessed by that device by processing received signals that are based on wireless signals transmitted by wireless communication devices 102 through motion detection fields 110. For example, when person 106 shown in FIG. 1 moves in motion detection field 110A and motion detection field 110C, wireless communication devices 102 may detect the motion based on signals they received that are based on wireless signals transmitted through respective motion detection fields 110. For instance, wireless communication device 102A can detect motion of person 106 in motion detection fields 110A, 110C, wireless communication device 102B can detect motion of person 106 in motion detection field 110C, and wireless communication device 102C can detect motion of person 106 in motion detection field 110A.

In some instances, motion detection fields 110 can include, for example, air, solid materials, liquids, or another medium through which wireless electromagnetic signals may propagate. In the example shown in FIG. 1, motion detection field 110A provides a wireless communication channel between wireless communication device 102A and wireless communication device 102C, motion detection field 110B provides a wireless communication channel between wireless communication device 102B and wireless communication device 102C, and motion detection field 110C provides a wireless communication channel between wireless communication device 102A and wireless communication device 102B. In some aspects of operation, wireless signals transmitted on a wireless communication channel (separate from or shared with the wireless communication channel for network traffic) are used to detect movement of an object in a space. The objects can be any type of static or moveable object and can be living or inanimate. For example, the object can be a human (e.g., person 106 shown in FIG. 1), an animal, an inorganic object, or another device, apparatus, or assembly, an object that defines all or part of the boundary of a space (e.g., a wall, door, window, etc.), or another type of object. In some implementations, motion information from the wireless communication devices may be analyzed to determine a location of the detected motion. For example, as described further below, one of wireless communication devices 102 (or another device communicably coupled to wireless communications devices 102) may determine that the detected motion is nearby a particular wireless communication device.

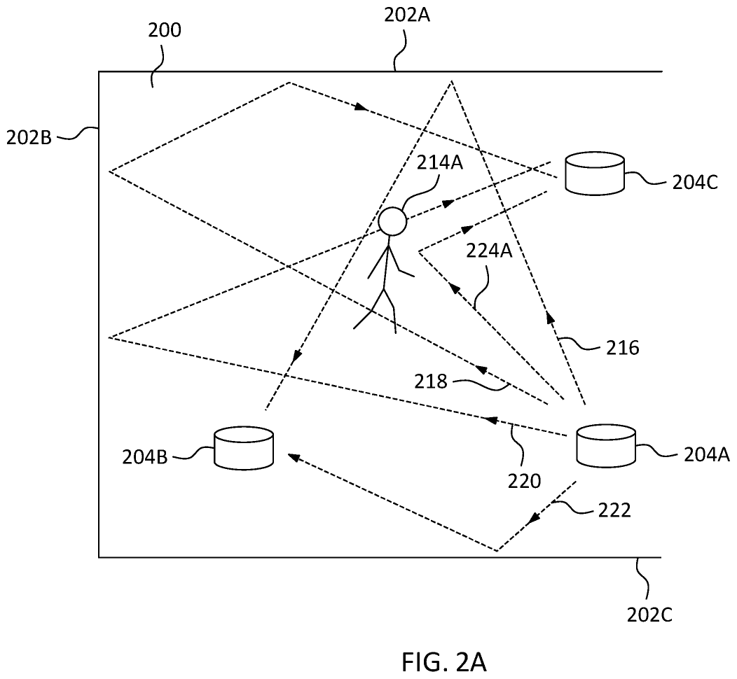

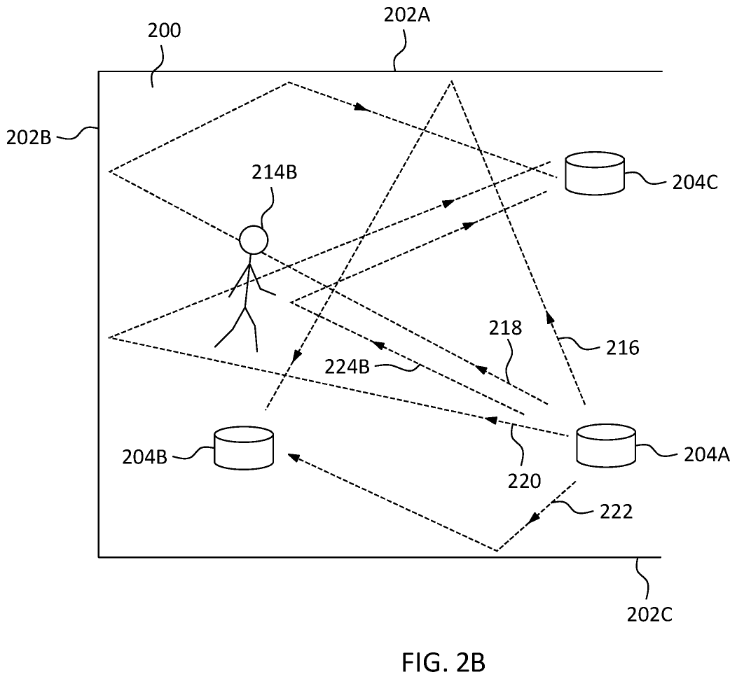

FIG. 2A and FIG. 2B are diagrams showing example wireless signals communicated between wireless communication devices 204A, 204B, 204C. Wireless communication devices 204A, 204B, 204C can be, for example, wireless communication devices 102A, 102B, 102C shown in FIG. 1, or other types of wireless communication devices. Wireless communication devices 204A, 204B, 204C transmit wireless signals through space 200. Space 200 can be completely or partially enclosed or open at one or more boundaries. In an example, space 200 may be a sensing space. Space 200 can be or can include an interior of a room, multiple rooms, a building, an indoor area, outdoor area, or the like. First wall 202A, second wall 202B, and third wall 202C at least partially enclose space 200 in the example shown.

In the example shown in FIG. 2A and FIG. 2B, wireless communication device 204A is operable to transmit wireless signals repeatedly (e.g., periodically, intermittently, at scheduled, unscheduled, or random intervals, etc.). Wireless communication devices 204B, 204C are operable to receive signals based on those transmitted by wireless communication device 204A. Wireless communication devices 204B, 204C each have a modem (e.g., modem 112 shown in FIG. 1) that is configured to process received signals to detect motion of an object in space 200.

As shown, an object is in first position 214A in FIG. 2A, and the object has moved to second position 214B in FIG. 2B. In FIG. 2A and FIG. 2B, the moving object in space 200 is represented as a human, but the moving object can be another type of object. For example, the moving object can be an animal, an inorganic object (e.g., a system, device, apparatus, or assembly), an object that defines all or part of the boundary of space 200 (e.g., a wall, door, window, etc.), or another type of object.

As shown in FIG. 2A and FIG. 2B, multiple example paths of the wireless signals transmitted from wireless communication device 204A are illustrated by dashed lines. Along first signal path 216, the wireless signal is transmitted from wireless communication device 204A and reflected off first wall 202A toward the wireless communication device 204B. Along second signal path 218, the wireless signal is transmitted from the wireless communication device 204A and reflected off second wall 202B and first wall 202A toward wireless communication device 204C. Along third signal path 220, the wireless signal is transmitted from the wireless communication device 204A and reflected off second wall 202B toward wireless communication device 204C. Along fourth signal path 222, the wireless signal is transmitted from the wireless communication device 204A and reflected off third wall 202C toward the wireless communication device 204B.

In FIG. 2A, along fifth signal path 224A, the wireless signal is transmitted from wireless communication device 204A and reflected off the object at first position 214A toward wireless communication device 204C. Between FIG. 2A and FIG. 2B, a surface of the object moves from first position 214A to second position 214B in space 200 (e.g., some distance away from first position 214A). In FIG. 2B, along sixth signal path 224B, the wireless signal is transmitted from wireless communication device 204A and reflected off the object at second position 214B toward wireless communication device 204C. Sixth signal path 224B depicted in FIG. 2B is longer than fifth signal path 224A depicted in FIG. 2A due to the movement of the object from first position 214A to second position 214B. In some examples, a signal path can be added, removed, or otherwise modified due to movement of an object in a space.

The example wireless signals shown in FIG. 2A and FIG. 2B may experience attenuation, frequency shifts, phase shifts, or other effects through their respective paths and may have portions that propagate in another direction, for example, through the first, second and third walls 202A, 202B, and 202C. In some examples, the wireless signals are radio frequency (RF) signals. The wireless signals may include other types of signals.

In the example shown in FIG. 2A and FIG. 2B, wireless communication device 204A can repeatedly transmit a wireless signal. In particular, FIG. 2A shows the wireless signal being transmitted from wireless communication device 204A at a first time, and FIG. 2B shows the same wireless signal being transmitted from wireless communication device 204A at a second, later time. The transmitted signal can be transmitted continuously, periodically, at random or intermittent times or the like, or a combination thereof. The transmitted signal can have a number of frequency components in a frequency bandwidth. The transmitted signal can be transmitted from wireless communication device 204A in an omnidirectional manner, in a directional manner or otherwise. In the example shown, the wireless signals traverse multiple respective paths in space 200, and the signal along each path may become attenuated due to path losses, scattering, reflection, or the like and may have a phase or frequency offset.

As shown in FIG. 2A and FIG. 2B, the signals from first to sixth paths 216, 218, 220, 222, 224A, and 224B combine at wireless communication device 204C and wireless communication device 204B to form received signals. Because of the effects of the multiple paths in space 200 on the transmitted signal, space 200 may be represented as a transfer function (e.g., a filter) in which the transmitted signal is input and the received signal is output. When an object moves in space 200, the attenuation or phase offset affected upon a signal in a signal path can change, and hence, the transfer function of space 200 can change. Assuming the same wireless signal is transmitted from wireless communication device 204A, if the transfer function of space 200 changes, the output of that transfer function—the received signal—will also change. A change in the received signal can be used to detect movement of an object.

Mathematically, a transmitted signal f(t) transmitted from the first wireless communication device 204A may be described according to Equation (1):

$$f ( t ) = {\sum }_{n = - ∞}^{∞} {c}_{n} {e}^{j {ω}_{n} t} \qquad ( 1 )$$

Where ωₙ represents the frequency of nth frequency component of the transmitted signal, cₙ represents the complex coefficient of the nth frequency component, and t represents time. With the f(t) being transmitted from the first wireless communication device 204A, an output signal rₖ(t) from a path, k, may be described according to Equation (2):

$${r}_{k} ( t ) = {\sum }_{n = - ∞}^{∞} {α}_{n , k} {c}_{n} {e}^{j ( {ω}_{n} t + {ϕ}_{n , k} )} \qquad ( 2 )$$

Where α_{n,k} represents an attenuation factor (or channel response; e.g., due to scattering, reflection, and path losses) for the nth frequency component along k, and ϕ_{n,k} represents the phase of the signal for nth frequency component along k. Then, the received signal, R, at a wireless communication device can be described as the summation of all output signals rₖ(t) from all paths to the wireless communication device, which is shown in Equation (3):

$$R = {\sum }_{k} {r}_{k} ( t ) \qquad ( 3 )$$

Substituting Equation (2) into Equation (3) renders the following Equation (4):

$$R = {\sum }_{k} {\sum }_{n = - ∞}^{∞} ( {α}_{n , k} {e}^{j {ϕ}_{n , k}} ) {c}_{n} {e}^{j {ω}_{n} t} \qquad ( 4 )$$

R at a wireless communication device can then be analyzed. R at a wireless communication device can be transformed to the frequency domain, for example, using a fast Fourier transform (FFT) or another type of algorithm. The transformed signal can represent R as a series of n complex values, one for each of the respective frequency components (at the n frequencies ωₙ). For a frequency component at frequency ωₙ, a complex value, Hₙ, may be represented as follows in Equation (5):

$${H}_{n} = {\sum }_{k} {c}_{n} {α}_{n , k} {e}^{j {ϕ}_{n , k}} \qquad ( 5 )$$

Hₙ for a given ωₙ indicates a relative magnitude and phase offset of the received signal at ωₙ. When an object moves in the space, Hₙ changes due to α_{n,k} of the space changing. Accordingly, a change detected in the channel response can be indicative of movement of an object within the communication channel. In some instances, noise, interference, or other phenomena can influence the channel response detected by the receiver, and the motion detection system can reduce or isolate such influences to improve the accuracy and quality of motion detection capabilities. In some implementations, the overall channel response can be represented as follows in Equation (6):

$${h}_{ch} = {\sum }_{k} {\sum }_{n = - ∞}^{∞} {α}_{n , k} \qquad ( 6 )$$

In some instances, the channel response, h_{ch}, for a space can be determined, for example, based on the mathematical theory of estimation. For instance, a reference signal, R_{ef}, can be modified with candidate h_{ch}, and then a maximum likelihood approach can be used to select the candidate channel which gives best match to the received signal (R_{cvd}). In some cases, an estimated received signal (\hat{R}_{cvd}) is obtained from the convolution of R_{ef} with the candidate h_{ch}, and then the channel coefficients of h_{ch} are varied to minimize the squared error of \hat{R}_{cvd}. This can be mathematically illustrated as follows in Equation (7):

$${R}_{cvd} = {R}_{ef} ⊗ {h}_{ch} = {\sum }_{k = - m}^{m} {R}_{ef} ( n - k ) {h}_{ch} ( k ) \qquad ( 7 )$$

with the optimization criterion as in Equation (8):

$${min}_{{h}_{ch}} \{ \sum {( {\hat{R}}_{cvd} - {R}_{cvd} )}^{2} \} \qquad ( 8 )$$

The minimizing, or optimizing, process can utilize an adaptive filtering technique, such as least mean squares (LMS), recursive least squares (RLS), batch least squares (BLS), etc. The channel response can be a finite impulse response (FIR) filter, infinite impulse response (IIR) filter, or the like. As shown in the equation above, the received signal can be considered as a convolution of the reference signal and the channel response. The convolution operation means that the channel coefficients possess a degree of correlation with each of the delayed replicas of the reference signal. The convolution operation as shown in the equation above, therefore shows that the received signal appears at different delay points, each delayed replica being weighted by the channel coefficient.

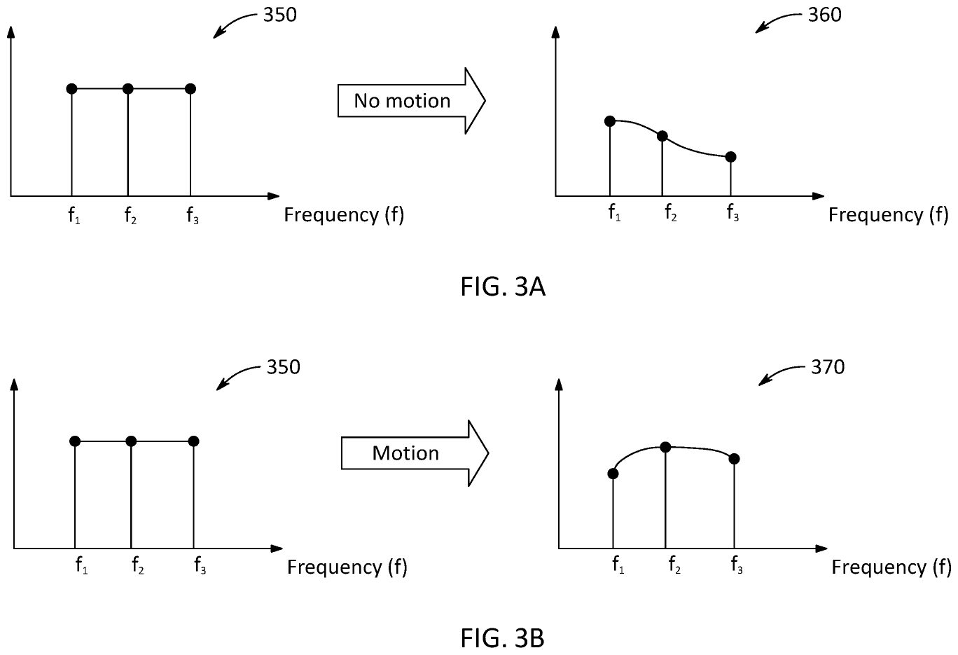

FIG. 3A and FIG. 3B are plots showing examples of channel responses 360, 370 computed from the wireless signals communicated between wireless communication devices 204A, 204B, 204C in FIG. 2A and FIG. 2B. FIG. 3A and FIG. 3B also show frequency domain representation 350 of an initial wireless signal transmitted by wireless communication device 204A. In the examples shown, channel response 360 in FIG. 3A represents the signals received by wireless communication device 204B when there is no motion in space 200, and channel response 370 in FIG. 3B represents the signals received by wireless communication device 204B in FIG. 2B after the object has moved in space 200.

In the example shown in FIG. 3A and FIG. 3B, for illustration purposes, wireless communication device 204A transmits a signal that has a flat frequency profile (the magnitude of each frequency component, f₁, f₂ and f₃ is the same), as shown in frequency domain representation 350. Because of the interaction of the signal with space 200 (and the objects therein), the signals received at wireless communication device 204B that are based on the signal sent from wireless communication device 204A are different from the transmitted signal. In this example, where the transmitted signal has a flat frequency profile, the received signal represents the channel response of space 200. As shown in FIG. 3A and FIG. 3B, channel responses 360, 370 are different from frequency domain representation 350 of the transmitted signal. When motion occurs in space 200, a variation in the channel response will also occur. For example, as shown in FIG. 3B, channel response 370 that is associated with motion of object in space 200 varies from channel response 360 that is associated with no motion in space 200.

Furthermore, as an object moves within space 200, the channel response may vary from channel response 370. In some cases, space 200 can be divided into distinct regions and the channel responses associated with each region may share one or more characteristics (e.g., shape), as described below. Thus, motion of an object within different distinct regions can be distinguished, and the location of detected motion can be determined based on an analysis of channel responses.

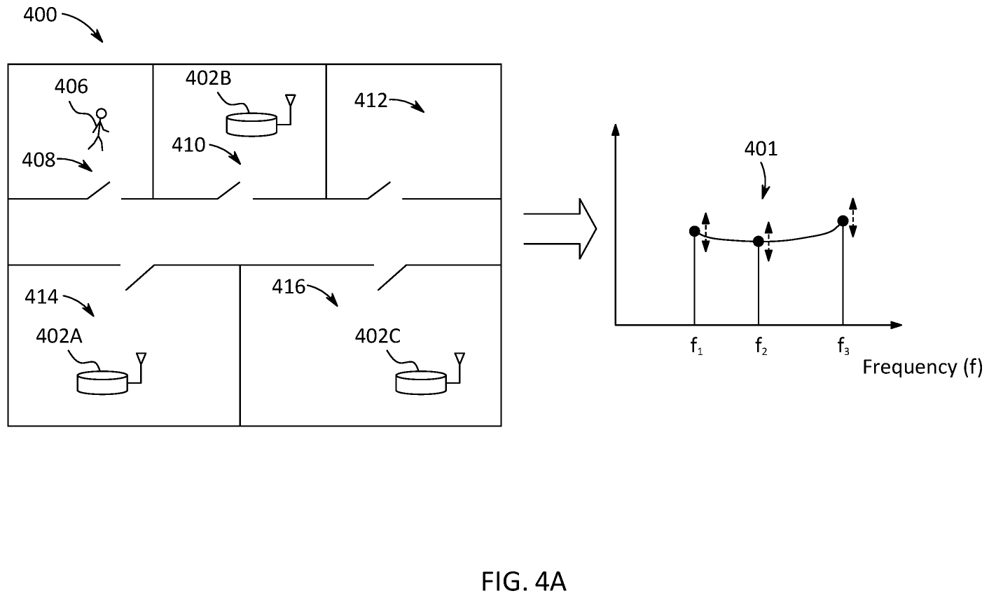

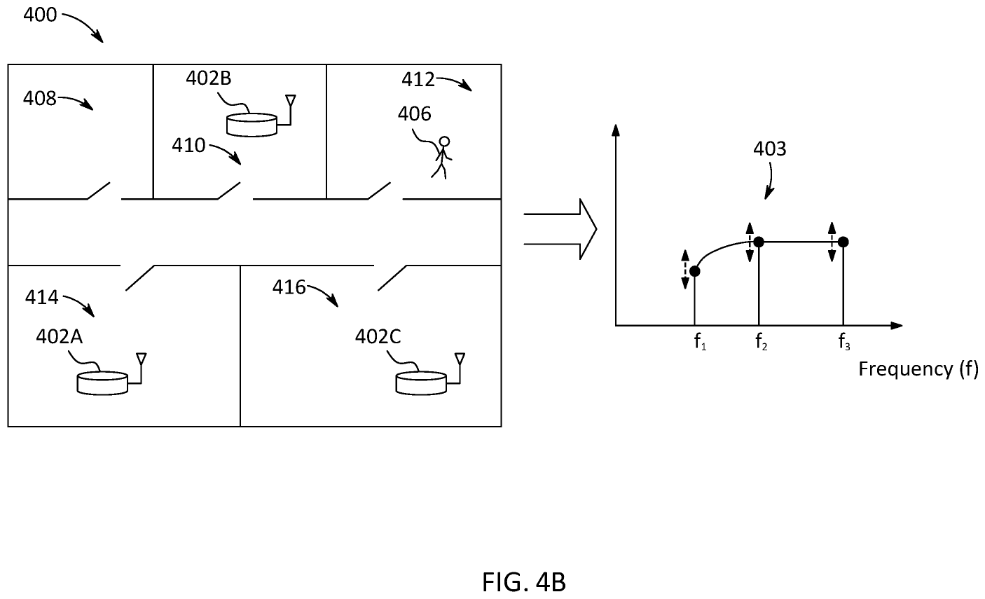

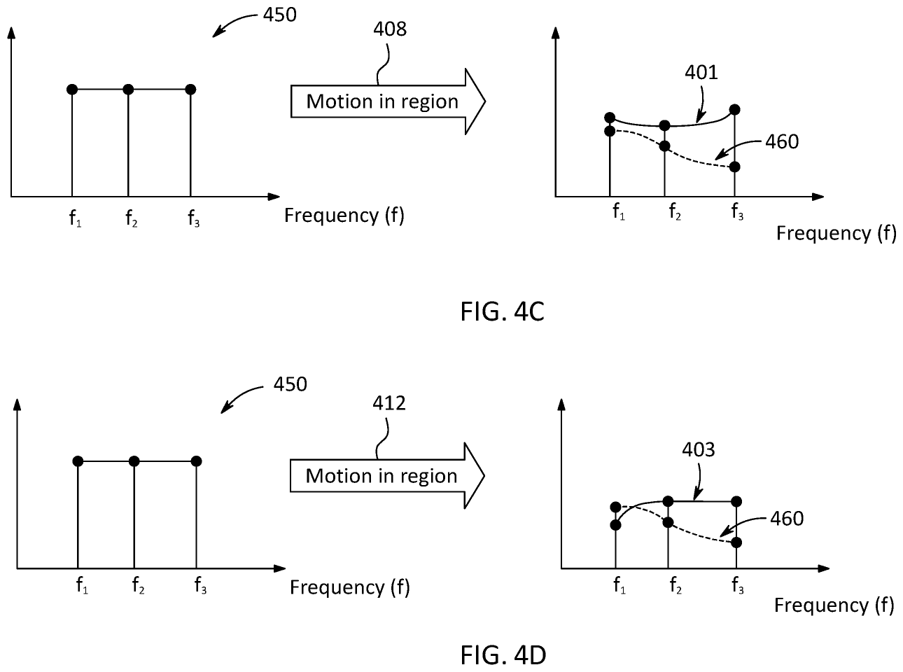

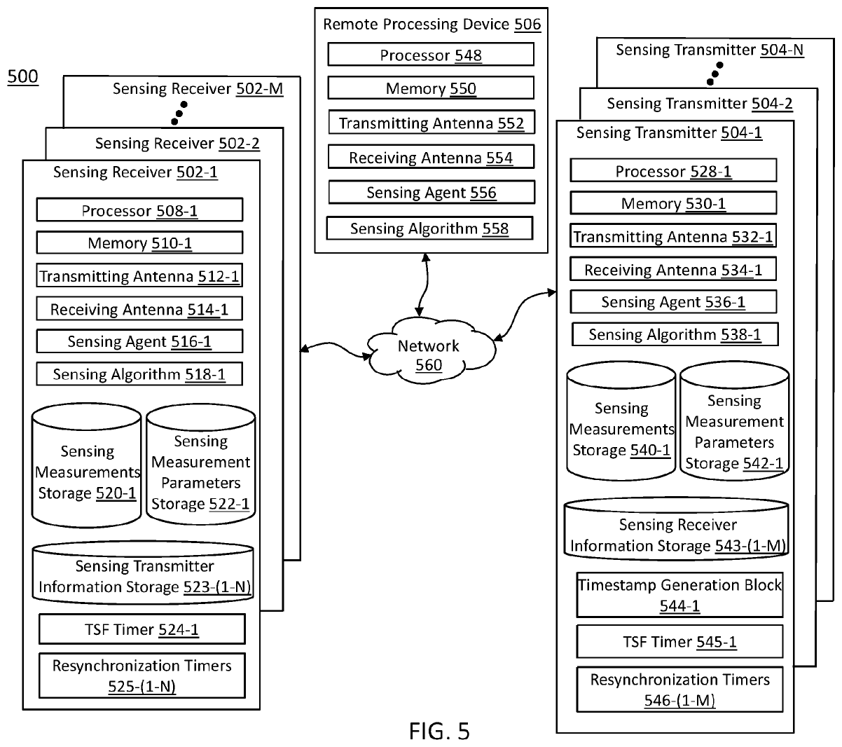

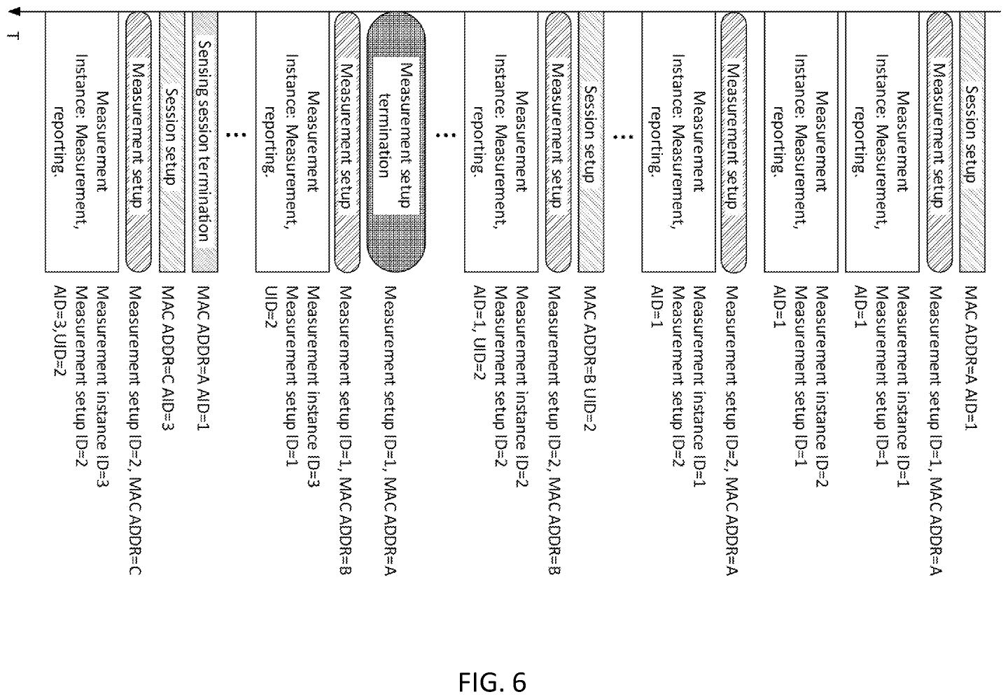

FIG. 4A and FIG. 4B are diagrams showing example channel responses 401, 403 associated with motion of object 406 in distinct regions 408, 412 of space 400. In the examples shown, space 400 is a building, and space 400 is divided into a plurality of distinct regions-first region 408, second region 410, third region 412, fourth region 414, and fifth region 416. Space 400 may include additional or fewer regions, in some instances. As shown in FIG. 4A and FIG. 4B, the regions within space 400 may be defined by walls between rooms. In addition, the regions may be defined by ceilings between floors of a building. For example, space 400 may include additional floors with additional rooms. In addition, in some instances, the plurality of regions of a space can be or include a number of floors in a multistory building, a number of rooms in the building, or a number of rooms on a particular floor of the building. In the example shown in FIG. 4A, an object located in first region 408 is represented as person 406, but the moving object can be another type of object, such as an animal or an inorganic object.

In the example shown, wireless communication device 402A is located in fourth region 414 of space 400, wireless communication device 402B is located in second region 410 of space 400, and wireless communication device 402C is located in fifth region 416 of space 400. Wireless communication devices 402 can operate in the same or similar manner as wireless communication devices 102 of FIG. 1. For instance, wireless communication devices 402 may be configured to transmit and receive wireless signals and detect whether motion has occurred in space 400 based on the received signals. As an example, wireless communication devices 402 may periodically or repeatedly transmit motion probe signals through space 400, and receive signals based on the motion probe signals. Wireless communication devices 402 can analyze the received signals to detect whether an object has moved in space 400, such as, for example, by analyzing channel responses associated with space 400 based on the received signals. In addition, in some implementations, wireless communication devices 402 can analyze the received signals to identify a location of detected motion within space 400. For example, wireless communication devices 402 can analyze characteristics of the channel response to determine whether the channel responses share the same or similar characteristics to channel responses known to be associated with first to fifth regions 408, 410, 412, 414, 416 of space 400.

In the examples shown, one (or more) of wireless communication devices 402 repeatedly transmits a motion probe signal (e.g., a reference signal) through space 400. The motion probe signals may have a flat frequency profile in some instances, wherein the magnitude of f₁, f₂ and f₃ is the same or nearly the same. For example, the motion probe signals may have a frequency response similar to frequency domain representation 350 shown in FIG. 3A and FIG. 3B. The motion probe signals may have a different frequency profile in some instances. Because of the interaction of the reference signal with space 400 (and the objects therein), the signals received at another wireless communication device 402 that are based on the motion probe signal transmitted from the other wireless communication device 402 are different from the transmitted reference signal.

Based on the received signals, wireless communication devices 402 can determine a channel response for space 400. When motion occurs in distinct regions within the space, distinct characteristics may be seen in the channel responses. For example, while the channel responses may differ slightly for motion within the same region of space 400, the channel responses associated with motion in distinct regions may generally share the same shape or other characteristics. For instance, channel response 401 of FIG. 4A represents an example channel response associated with motion of object 406 in first region 408 of space 400, while channel response 403 of FIG. 4B represents an example channel response associated with motion of object 406 in third region 412 of space 400. Channel responses 401, 403 are associated with signals received by the same wireless communication device 402 in space 400.

FIG. 4C and FIG. 4D are plots showing channel responses 401, 403 of FIG. 4A and FIG. 4B overlaid on channel response 460 associated with no motion occurring in space 400. In the example shown, wireless communication device 402 transmits a motion probe signal that has a flat frequency profile as shown in frequency domain representation 450. When motion occurs in space 400, a variation in the channel response will occur relative to channel response 460 associated with no motion, and thus, motion of an object in space 400 can be detected by analyzing variations in the channel responses. In addition, a relative location of the detected motion within space 400 can be identified. For example, the shape of channel responses associated with motion can be compared with reference information (e.g., using a trained artificial intelligence (AI) model) to categorize the motion as having occurred within a distinct region of space 400.

When there is no motion in space 400 (e.g., when object 406 is not present), wireless communication device 402 may compute channel response 460 associated with no motion. Slight variations may occur in the channel response due to a number of factors; however, multiple channel responses 460 associated with different periods of time may share one or more characteristics. In the example shown, channel response 460 associated with no motion has a decreasing frequency profile (the magnitude of each of f₁, f₂ and f₃ is less than the previous). The profile of channel response 460 may differ in some instances (e.g., based on different room layouts or placement of wireless communication devices 402).

When motion occurs in space 400, a variation in the channel response will occur. For instance, in the examples shown in FIG. 4C and FIG. 4D, channel response 401 associated with motion of object 406 in first region 408 differs from channel response 460 associated with no motion and channel response 403 associated with motion of object 406 in third region 412 differs from channel response 460 associated with no motion. Channel response 401 has a concave-parabolic frequency profile (the magnitude of the middle frequency component, f₂, is less than the outer frequency components f1 and f3), while channel response 403 has a convex-asymptotic frequency profile (the magnitude of the middle frequency component f2 is greater than the outer frequency components, f₁ and f₃). The profiles of channel responses 401, 403 may differ in some instances (e.g., based on different room layouts or placement of the wireless communication devices 402).

Analyzing channel responses may be considered similar to analyzing a digital filter. A channel response may be formed through the reflections of objects in a space as well as reflections created by a moving or static human. When a reflector (e.g., a human) moves, it changes the channel response. This may translate to a change in equivalent taps of a digital filter, which can be thought of as having poles and zeros (poles amplify the frequency components of a channel response and appear as peaks or high points in the response, while zeros attenuate the frequency components of a channel response and appear as troughs, low points, or nulls in the response). A changing digital filter can be characterized by the locations of its peaks and troughs, and a channel response may be characterized similarly by its peaks and troughs. For example, in some implementations, analyzing nulls and peaks in the frequency components of a channel response (e.g., by marking their location on the frequency axis and their magnitude), motion can be detected.

In some implementations, a time series aggregation can be used to detect motion. A time series aggregation may be performed by observing the features of a channel response over a moving window and aggregating the windowed result by using statistical measures (e.g., mean, variance, principal components, etc.). During instances of motion, the characteristic digital-filter features would be displaced in location and flip-flop between some values due to the continuous change in the scattering scene. That is, an equivalent digital filter exhibits a range of values for its peaks and nulls (due to the motion). By looking this range of values, unique profiles (in examples profiles may also be referred to as signatures) may be identified for distinct regions within a space.

In some implementations, an AI model may be used to process data. AI models may be of a variety of types, for example linear regression models, logistic regression models, linear discriminant analysis models, decision tree models, naïve bayes models, K-nearest neighbors models, learning vector quantization models, support vector machines, bagging and random forest models, and deep neural networks. In general, all AI models aim to learn a function which provides the most precise correlation between input values and output values and are trained using historic sets of inputs and outputs that are known to be correlated. In examples, artificial intelligence may also be referred to as machine learning.

In some implementations, the profiles of the channel responses associated with motion in distinct regions of space 400 can be learned. For example, machine learning may be used to categorize channel response characteristics with motion of an object within distinct regions of a space. In some cases, a user associated with wireless communication devices 402 (e.g., an owner or other occupier of space 400) can assist with the learning process. For instance, referring to the examples shown in FIG. 4A and FIG. 4B, the user can move in each of first to fifth regions 408, 410, 412, 414, 416 during a learning phase and may indicate (e.g., through a user interface on a mobile computing device) that he/she is moving in one of the particular regions in space 400. For example, while the user is moving through first region 408 (e.g., as shown in FIG. 4A) the user may indicate on a mobile computing device that he/she is in first region 408 (and may name the region as “bedroom”, “living room”, “kitchen”, or another type of room of a building, as appropriate). Channel responses may be obtained as the user moves through the region, and the channel responses may be “tagged” with the user's indicated location (region). The user may repeat the same process for the other regions of space 400. The term “tagged” as used herein may refer to marking and identifying channel responses with the user's indicated location or any other information.

The tagged channel responses can then be processed (e.g., by machine learning software) to identify unique characteristics of the channel responses associated with motion in the distinct regions. Once identified, the identified unique characteristics may be used to determine a location of detected motion for newly computed channel responses. For example, an AI model may be trained using the tagged channel responses, and once trained, newly computed channel responses can be input to the AI model, and the AI model can output a location of the detected motion. For example, in some cases, mean, range, and absolute values are input to an AI model. In some instances, magnitude and phase of the complex channel response itself may be input as well. These values allow the AI model to design arbitrary front-end filters to pick up the features that are most relevant to making accurate predictions with respect to motion in distinct regions of a space. In some implementations, the AI model is trained by performing a stochastic gradient descent. For instance, channel response variations that are most active during a certain zone may be monitored during the training, and the specific channel variations may be weighted heavily (by training and adapting the weights in the first layer to correlate with those shapes, trends, etc.). The weighted channel variations may be used to create a metric that activates when a user is present in a certain region.

For extracted features like channel response nulls and peaks, a time-series (of the nulls/peaks) may be created using an aggregation within a moving window, taking a snapshot of few features in the past and present, and using that aggregated value as input to the network. Thus, the network, while adapting its weights, will be trying to aggregate values in a certain region to cluster them, which can be done by creating a logistic classifier based decision surfaces. The decision surfaces divide different clusters and subsequent layers can form categories based on a single cluster or a combination of clusters.

In some implementations, an AI model includes two or more layers of inference. The first layer acts as a logistic classifier which can divide different concentrations of values into separate clusters, while the second layer combines some of these clusters together to create a category for a distinct region. Additionally, subsequent layers can help in extending the distinct regions over more than two categories of clusters. For example, a fully-connected AI model may include an input layer corresponding to the number of features tracked, a middle layer corresponding to the number of effective clusters (through iterating between choices), and a final layer corresponding to different regions. Where complete channel response information is input to the AI model, the first layer may act as a shape filter that can correlate certain shapes. Thus, the first layer may lock to a certain shape, the second layer may generate a measure of variation happening in those shapes, and third and subsequent layers may create a combination of those variations and map them to different regions within the space. The output of different layers may then be combined through a fusing layer.

### B. Wi-Fi Sensing System Example Methods and Apparatus

Section B describes systems and methods that are useful for a wireless sensing system configured to send sensing transmissions and make sensing measurements.

FIG. 5 depicts an implementation of some of an architecture of an implementation of system 500 for Wi-Fi sensing, according to some embodiments.

System 500 may include a plurality of networking devices. In an implementation, the plurality of networking devices may include plurality of sensing receivers 502-(1-M), plurality of sensing transmitters 504-(1-N), and remote processing device 506. In examples, plurality of sensing receivers 502-(1-M) and plurality of sensing transmitters 504-(1-N) may belong to more than one basic service set (BSS). Further, system 500 may include network 560 enabling communication between the system components for information exchange. In an example, any of sensing receiver 502-(1-M) or any of sensing transmitter 504-(1-N) may be a sensing capable device. System 500 may be an example or instance of wireless communication system 100 and network 560 may be an example or instance of wireless network or cellular network, details of which are provided with reference to FIG. 1 and its accompanying description. In some embodiments, one or more of plurality of sensing receivers 502-(1-M) may not be associated (i.e., may be unassociated) with one or more of plurality of sensing transmitters 504-(1-N). In examples, plurality of sensing receivers 502-(1-M) may include at least first sensing receiver 502-1 and second sensing receiver 502-2. Similarly, plurality of sensing transmitters 504-(1-N) may include at least first sensing transmitter 504-1 and second sensing transmitter 504-2. In some embodiments, one or more of plurality of sensing transmitters 504-(1-N) may not be associated (i.e., may be unassociated) with one or more of plurality of sensing receivers 502-(1-M).

According to an embodiment, plurality of sensing receivers 502-(1-M) may be configured to receive one or more sensing transmissions (for example, from one or more of plurality of sensing transmitters 504-(1-N)) and perform one or more measurements (for example, channel representation information (CRI) measurements such as channel state information (CSI) or time domain channel representation information (TD-CRI)) useful for Wi-Fi sensing. In examples, these measurements may be known as sensing measurements. Sensing measurements may be processed to achieve a sensing goal of system 500. In an embodiment, one or more of plurality of sensing receivers 502-(1-M) may be an AP. In some embodiments, one or more of plurality of sensing receivers 502-(1-M) may be a non-AP STA. In some embodiments, one or more of plurality of sensing receivers 502-(1-M) may take a role of sensing initiator and/or sensing responder.

According to an implementation, one or more of plurality of sensing receivers 502-(1-M) may be implemented by a device, such as wireless communication device 102 shown in FIG. 1. In some implementations, one or more of plurality of sensing receivers 502-(1-M) may be implemented by a device, such as wireless communication device 204 shown in FIG. 2A and FIG. 2B. Further, one or more of plurality of sensing receivers 502-(1-M) may be implemented by a device, such as wireless communication device 402 shown in FIG. 4A and FIG. 4B. In an implementation, one or more of plurality of sensing receivers 502-(1-M) may coordinate and control communication among plurality of sensing transmitters 504-(1-N). According to an implementation, one or more of plurality of sensing receivers 502-(1-M) may be enabled to control a sensing measurement session comprising one or more sensing measurement instance to ensure that required sensing transmissions are made at a required time and to ensure an accurate determination of one or more sensing measurements. In some embodiments, one or more of plurality of sensing receivers 502-(1-M) may process sensing measurements to achieve the sensing goal of system 500. In an embodiment, one or more of plurality of sensing receivers 502-(1-M) may be a STA. In an embodiment, one or more of plurality of sensing receivers 502-(1-M) may be an AP. In some embodiments, one or more of plurality of sensing receivers 502-(1-M) may be configured to transmit sensing measurements to remote processing device 506, and remote processing device 506 may be configured to process sensing measurements to achieve the sensing goal of system 500.

Referring again to FIG. 5, in some embodiments, one or more of plurality of sensing transmitters 504-(1-N) may be configured to send one or more sensing transmissions to one or more of plurality of sensing receivers 502-(1-M) based on which one or more sensing measurements may be performed for Wi-Fi sensing. In an embodiment, one or more of plurality of sensing transmitters 504-(1-N) may be a STA. In an embodiment, one or more of plurality of sensing transmitters 504-(1-N) may be an AP. In some embodiments, one or more of plurality of sensing transmitters 504-(1-N) may take a role of sensing initiator and/or sensing responder.

According to an implementation, one or more of plurality of sensing transmitters 504-(1-N) may be implemented by a device, such as wireless communication device 102 shown in FIG. 1. In some implementations, one or more of plurality of sensing transmitters 504-(1-M) may be implemented by a device, such as wireless communication device 204 shown in FIG. 2A and FIG. 2B. Further, one or more of plurality of sensing transmitters 504-(1-M) may be implemented by a device, such as wireless communication device 402 shown in FIG. 4A and FIG. 4B. In some implementations, communication between one or more of plurality of sensing receivers 502-(1-M) and one or more of plurality of sensing transmitters 504-(1-N) may happen via station management entity (SME) and MAC layer management entity (MLME) protocols.

In some embodiments, remote processing device 506 may be configured to receive sensing measurements from one or more of plurality of sensing receivers 502-(1-M) and process the sensing measurements. In an example, remote processing device 506 may process and analyze sensing measurements to identify one or more features of interest. According to some implementations, remote processing device 506 may include/execute a sensing algorithm. In an embodiment, remote processing device 506 may be a STA. In some embodiments, remote processing device 506 may be an AP. According to an implementation, remote processing device 506 may be implemented by a device, such as wireless communication device 102 shown in FIG. 1. In some implementations, remote processing device 506 may be implemented by a device, such as wireless communication device 204 shown in FIG. 2A and FIG. 2B. Further, remote processing device 506 may be implemented by a device, such as wireless communication device 402 shown in FIG. 4A and FIG. 4B. In some embodiments, remote processing device 506 may be any computing device, such as a desktop computer, a laptop, a tablet computer, a mobile device, a personal digital assistant (PDA) or any other computing device. In embodiments, remote processing device 506 may take a role of sensing initiator where a sensing algorithm determines a Wi-Fi sensing session and the sensing measurements required to fulfill the measurement campaign. In an example, remote processing device 506 may communicate sensing measurement parameters and/or transmission parameters required to initiate a Wi-Fi sensing session to one or more of plurality of sensing receivers 502-(1-M) and/or to one or more of plurality of sensing transmitters 504-(1-N) to coordinate and control sensing transmissions for performing sensing measurements.

Referring to FIG. 5 in more detail, sensing receiver 502-1 (which is an example of one or more of plurality of sensing receivers 502-(1-M)) may include processor 508-1 and memory 510-1. For example, processor 508-1 and memory 510-1 of sensing receiver 502-1 may be processor 114 and memory 116, respectively, as shown in FIG. 1. In an embodiment, sensing receiver 502-1 may further include transmitting antenna(s) 512-1, receiving antenna(s) 514-1, and sensing agent 516-1. In some embodiments, an antenna may be used to both transmit and receive signals in a half-duplex format. When the antenna is transmitting, it may be referred to as transmitting antenna 512-1, and when the antenna is receiving, it may be referred to as receiving antenna 514-1. It is understood by a person of normal skill in the art that the same antenna may be transmitting antenna 512-1 in some instances and receiving antenna 514-1 in other instances. In the case of an antenna array, one or more antenna elements may be used to transmit or receive a signal, for example, in a beamforming environment. In some examples, a group of antenna elements used to transmit a composite signal may be referred to as transmitting antenna 512-1, and a group of antenna elements used to receive a composite signal may be referred to as receiving antenna 514-1. In some examples, each antenna is equipped with its own transmission and receive paths, which may be alternately switched to connect to the antenna depending on whether the antenna is operating as transmitting antenna 512-1 or receiving antenna 514-1.

In an implementation, sensing agent 516-1 may be responsible for causing sensing receiver 502-1 to receive sensing transmissions and associated sensing measurement parameters and/or transmission parameters, to calculate sensing measurements. In examples, sensing agent 516-1 may be responsible for processing sensing measurements to fulfill a sensing goal. In some implementations, receiving sensing transmissions and optionally associated sensing measurement parameters and/or transmission parameters, and calculating sensing measurements may be carried out by sensing agent 516-1 running in the medium access control (MAC) layer of sensing receiver 502-1 and processing sensing measurements to fulfill a sensing goal may be carried out by an algorithm running in the application layer of sensing receiver 502-1, for example sensing algorithm 518-1. In examples, a sensing algorithm 518-1 running in the application layer of sensing receiver 502-1 may be known as a Wi-Fi sensing agent, a sensing application, or sensing algorithm. In examples, sensing algorithm 518-1 may include and/or execute sensing agent 516-1. According to some implementations, sensing agent 516-1 may include and/or execute sensing algorithm 518-1. In some implementations, sensing agent 516-1 running in the MAC layer of sensing receiver 502-1 and sensing algorithm 518-1 running in the application layer of sensing receiver 502-1 may run separately on processor 508-1. In an implementation, sensing agent 516-1 may pass one or more of sensing measurement parameters, transmission parameters, or physical layer parameters (e.g., such as channel representation information, examples of which are CSI and TD-CRI) between the MAC layer of sensing receiver 502-1 and the application layer of sensing receiver 502-1. In an example, sensing agent 516-1 in the MAC layer or sensing algorithm 518-1 in the application layer may operate on physical layer parameters, for example, to detect one or more features of interest. In examples, sensing algorithm 518-1 may form services or features, which may be presented to an end-user. According to an implementation, communication between the MAC layer of sensing receiver 502-1 and other layers or components of sensing receiver 502-1 (including the application layer) may take place based on communication interfaces, such as an MLME interface and a data interface. In examples, sensing agent 516-1 may be configured to determine a number and timing of sensing transmissions and sensing measurements for the purpose of Wi-Fi sensing. In some implementations, sensing agent 516-1 may be configured to transmit sensing measurements to plurality of sensing transmitters 504-(1-N) and/or remote processing device 506 for further processing. In an implementation, sensing agent 516-1 may be configured to cause at least one transmitting antenna of transmitting antenna(s) 512-1 to transmit messages to one or more of plurality of sensing transmitters 504-(1-N) or to remote processing device 506. Further, sensing agent 516-1 may be configured to receive, via at least one receiving antenna of receiving antennas(s) 514-1, messages from one or more of plurality of sensing transmitters 504-(1-N) or from remote processing device 506. In an example, sensing agent 516-1 may be configured to make sensing measurements based on sensing transmissions received from one or more of plurality of sensing transmitters 504-(1-N).

In some embodiments, sensing receiver 502-1 may include sensing measurements storage 520-1. In an implementation, sensing measurements storage 520-1 may store sensing measurements computed by sensing receiver 502-1 based on received sensing transmissions. In an example, sensing measurements stored in sensing measurements storage 520-1 may be periodically or dynamically updated as required. In some embodiments, sensing receiver 502-1 may include sensing measurement parameters storage 522-1. In an implementation, sensing measurement parameters storage 522-1 may store sensing measurement parameters and/or transmission parameters applicable to one or more sensing measurement setups. In an implementation, sensing measurement parameters storage 522-1 may store sensing measurement parameters and/or transmission parameters applicable to one or more sensing measurement sessions. In an implementation, sensing measurement parameters storage 522-1 may store sensing measurement parameters and/or transmission parameters applicable to one or more sensing measurement instances. In an example, sensing measurement parameters and/or transmission parameters stored in sensing measurement parameters storage 522-1 may be periodically or dynamically updated as required. In an implementation, sensing measurements storage 520-1 and sensing measurement parameters storage 522-1 may include any type or form of storage, such as a database or a file system or coupled to memory 510-1.

In an implementation, sensing receiver 502-1 may include sensing transmitter information storage 523-(1-N). In examples, sensing transmitter information storage 523-(1-N) may store information for one or more of plurality of sensing transmitters 504-(1-N) from which sensing receiver 502-1 is receiving sensing transmissions from. In examples, sensing transmitter information storage 523-(1-N) may store information related to TSF timers associated with one or more of plurality of sensing transmitters 504-(1-N). In an example, sensing transmitter information storage 523-(1-N) may store local timing information. In some examples, sensing transmitter information storage 523-(1-N) may store timer offset value. Information stored in sensing transmitter information storage 523-(1-N) may be periodically or dynamically updated as required. In an implementation, sensing transmitter information storage 523-(1-N) may include any type or form of storage, such as a database or a file system coupled to memory 510-1.

Referring again to FIG. 5, sensing receiver 502-1 may include TSF timer 524-1 (also referred to as an OBSS AP TSF timer). In an implementation, TSF timer 524-1 may be a local timer/clock in sensing receiver 502-1. In an example, TSF timer 524-1 may be based on a 1 MHz clock and may tick in time units (TU), where 1 TU is equal to 1.024 microseconds. In examples, TSF timer 524-1 may be represented by an 8-octet (64 bit) register [63:0] that is incremented every microseconds. In an embodiment, sensing receiver 502-1 may include plurality of resynchronization timers 525-(1-N). In examples, plurality of resynchronization timers 525-(1-N) may be associated with one or more of plurality of sensing transmitters 504-(1-N). In an example, resynchronization timer 525-1 may correspond to sensing transmitter 504-1, resynchronization timer 525-2 may correspond to sensing transmitter 504-1, and so on.

Referring again to FIG. 5, sensing transmitter 504-1 (which is an example of one or more of plurality of sensing transmitters 504-(1-N)) may include processor 528-1 and memory 530-1. For example, processor 528-1 and memory 530-1 of sensing transmitter 504-1 may be processor 114 and memory 116, respectively, as shown in FIG. 1. In an embodiment, sensing transmitter 504-1 may further include transmitting antenna(s) 532-1, receiving antenna(s) 534-1, and sensing agent 536-1.

Sensing agent 536-1 may be configured to cause at least one transmitting antenna of transmitting antenna(s) 532-1 and at least one receiving antenna of receiving antennas(s) 534-1 to exchange messages with one or more of plurality of sensing receivers 502-(1-M)) or with remote processing device 506. In some embodiments, an antenna may be used to both transmit and receive in a half-duplex format. When the antenna is transmitting, it may be referred to as transmitting antenna 532-1, and when the antenna is receiving, it may be referred to as receiving antenna 534-1. It is understood by a person of normal skill in the art that the same antenna may be transmitting antenna 532-1 in some instances and receiving antenna 534-1 in other instances. In the case of an antenna array, one or more antenna elements may be used to transmit or receive a signal, for example, in a beamforming environment. In some examples, a group of antenna elements used to transmit a composite signal may be referred to as transmitting antenna 532-1, and a group of antenna elements used to receive a composite signal may be referred to as receiving antenna 534-1. In some examples, each antenna is equipped with its own transmission and receive paths, which may be alternately switched to connect to the antenna depending on whether the antenna is operating as transmitting antenna 532-1 or receiving antenna 534-1.

In an implementation, sensing agent 536-1 may be responsible for causing sensing transmitter 504-1 to send sensing transmissions and, in examples, receive associated sensing measurements from one or more of plurality of sensing receivers 502-(1-M). In examples, sensing agent 536-1 may be responsible for processing sensing measurements to fulfill a sensing goal. In some implementations, sensing agent 536-1 may run in the medium access control (MAC) layer of sensing transmitter 504-1 and processing sensing measurements to fulfill a sensing goal may be carried out by sensing algorithm 538-1, which in examples may run in the application layer of sensing transmitter 504-1. In examples, sensing algorithm 538-1 running in the application layer of sensing transmitter 504-1 may be known as a Wi-Fi sensing agent, a sensing application, or a sensing algorithm. In examples, sensing algorithm 538-1 may include and/or execute sensing agent 536-1. According to some implementations, sensing agent 536-1 may include and/or execute sensing algorithm 538-1. In some implementations, sensing agent 536-1 may run in the MAC layer of sensing transmitter 504-1 and sensing algorithm 538-1 may run in the application layer of sensing transmitter 504-1. In some implementations, sensing agent 536-1 of sensing transmitter 504-1 and sensing algorithm 538-1 may run separately on processor 528-1. In an implementation, sensing agent 536-1 may pass sensing measurement parameters, transmission parameters, or physical layer parameters between the MAC layer of sensing transmitter 504-1 and the application layer of sensing transmitter 504-1. In an example, sensing agent 536-1 in the MAC layer or sensing algorithm 538-1 in the application layer may control physical layer parameters, for example physical layer parameters used to generate one or more sensing transmissions. In examples, sensing algorithm 538-1 may form services or features, which may be presented to an end-user. According to an implementation, communication between the MAC layer of sensing transmitter 504-1 and other layers or components of sensing transmitter 504-1 (including the application layer) may take place based on communication interfaces, such as an MLME interface and a data interface. In examples, sensing agent 536-1 may be configured to determine a number and timing of sensing transmissions for the purpose of Wi-Fi sensing. In some implementations, sensing agent 536-1 may be configured to cause sensing transmitter 504-1 to transmit sensing transmissions to one or more of plurality of sensing receivers 502-(1-M). In an implementation, sensing agent 536-1 may be configured to cause at least one transmitting antenna of transmitting antenna(s) 532-1 to transmit messages to one or more of plurality of sensing receivers 502-(1-M) or to remote processing device 506. Further, sensing agent 536-1 may be configured to receive, via at least one receiving antenna of receiving antennas(s) 534-1, messages from one or more of plurality of sensing receivers 502-(1-M) or from remote processing device 506.

In some embodiments, sensing transmitter 504-1 may include sensing measurements storage 540-1. In an implementation, sensing measurements storage 540-1 may store sensing measurements computed by one or more of plurality of sensing receivers 502-(1-M) based on sensing transmissions sent by sensing transmitter 504-1 and sent by one or more of plurality of sensing receivers 502-(1-M) to sensing transmitter 504-1. In an example, sensing measurements stored in sensing measurements storage 540-1 may be periodically or dynamically updated as required. In an implementation, sensing measurements storage 540-1 may include any type or form of storage, such as a database or a file system or coupled to memory 530-1.

In some embodiments, sensing transmitter 504-1 may include sensing measurement parameters storage 542-1. In an implementation, sensing measurement parameters storage 542-1 may store sensing measurement parameters and/or transmission parameters applicable to one or more sensing measurement sessions. In an implementation, sensing measurement parameters storage 542-1 may store sensing measurement parameters and/or transmission parameters applicable to one or more sensing measurement setups. In an implementation, sensing measurement parameters storage 542-1 may store sensing measurement parameters and/or transmission parameters applicable to one or more sensing measurement instances. In an example, sensing measurement parameters and/or transmission parameters stored in sensing measurement parameters storage 542-1 may be periodically or dynamically updated as required. In an implementation, sensing measurements storage 540-1 and sensing measurement parameters storage 542-1 may include any type or form of storage, such as a database or a file system or coupled to memory 530-1.

In an implementation, sensing transmitter 504-1 may include sensing receiver information storage 543-(1-M). In examples, sensing receiver information storage 543-(1-M) may store information for one or more of plurality of sensing receivers 502-(1-M) that it is sending sensing transmissions to. In examples, sensing receiver information storage 543-(1-M) may store information related to TSF timers associated with one or more of plurality of sensing transmitters 504-(1-N). In an example, sensing receiver information storage 543-(1-M) may store local timing information. In some examples, sensing receiver information storage 543-(1-M) may store timer offset value. Information stored in sensing receiver information storage 543-(1-M) may be periodically or dynamically updated as required. In an implementation, sensing receiver information storage 543-(1-M) may include any type or form of storage, such as a database or a file system coupled to memory 530-1.

According to an implementation, sensing transmitter 504-1 may include timestamp generation block 544-1. In an implementation, timestamp generation block 544-1 may be coupled to processor 528-1 and memory 530-1. In some embodiments, timestamp generation block 544-1 amongst other units, may include routines, programs, objects, components, data structures, etc., which may perform particular tasks or implement particular abstract data types. Timestamp generation block 544-1 may also be implemented as, signal processor(s), state machine(s), logic circuitries, and/or any other device or component that manipulate signals based on operational instructions. In some embodiments, timestamp generation block 544-1 may be implemented in hardware, instructions executed by a processing unit, or by a combination thereof. The processing unit may comprise a computer, a processor, a state machine, a logic array or any other suitable devices capable of processing instructions. The processing unit may be a general-purpose processor that executes instructions to cause the general-purpose processor to perform the required tasks or, the processing unit may be dedicated to performing the required functions. In some embodiments, timestamp generation block 544-1 may be machine-readable instructions that, when executed by a processor/processing unit, perform any of desired functionalities. The machine-readable instructions may be stored on an electronic memory device, hard disk, optical disk or other machine-readable storage medium or non-transitory medium. In an implementation, the machine-readable instructions may also be downloaded to the storage medium via a network connection. In an example, machine-readable instructions may be stored in memory 530-1.

Referring again to FIG. 5, sensing transmitter 504-1 may include TSF timer 545-1 (also referred to as an OBSS STA TSF timer). In an implementation, TSF timer 545-1 may be a local timer/clock in sensing transmitter 504-1. In an example, TSF timer 545-1 may be based on a 1 MHz clock and may tick in TU, where 1 TU is equal to 1.024 microseconds. In examples, TSF timer 545-1 may be represented by an 8-octet (64 bit) register [63:0] that is incremented every microseconds. In an embodiment, sensing transmitter 504-1 may include plurality of resynchronization timers 546-(1-M). In examples, plurality of resynchronization timers 546-(1-M) may be associated with one or more of plurality of sensing receivers 502-(1-M). In an example, resynchronization timer 546-1 may correspond to sensing receiver 502-1, resynchronization timer 546-2 may correspond to sensing receiver 502-2, and so on.

Referring to FIG. 5 in more detail, remote processing device 506 may include processor 548 and memory 550. For example, processor 548 and memory 550 of remote processing device 506 may be processor 114 and memory 116, respectively, as shown in FIG. 1. In an embodiment, remote processing device 506 may further include transmitting antenna(s) 552, receiving antenna(s) 554, sensing agent 556, and sensing algorithm, 558. In some embodiments, an antenna may be used to both transmit and receive signals in a half-duplex format. When the antenna is transmitting, it may be referred to as transmitting antenna 552, and when the antenna is receiving, it may be referred to as receiving antenna 554. It is understood by a person of normal skill in the art that the same antenna may be transmitting antenna 552 in some instances and receiving antenna 554 in other instances. In the case of an antenna array, one or more antenna elements may be used to transmit or receive a signal, for example, in a beamforming environment. In some examples, a group of antenna elements used to transmit a composite signal may be referred to as transmitting antenna 552, and a group of antenna elements used to receive a composite signal may be referred to as receiving antenna 554. In some examples, each antenna is equipped with its own transmission and receive paths, which may be alternately switched to connect to the antenna depending on whether the antenna is operating as transmitting antenna 552 or receiving antenna 554.

In an implementation, sensing agent 556 may be responsible for determining sensing measurement parameters and/or transmission parameters for one or more sensing measurement setups. In examples, sensing agent 556 may receive sensing measurement parameters and/or transmission parameters for one or more sensing measurement setups from sensing algorithm 558. In an example, sensing agent 556 may receive sensing measurements from one or more of plurality of sensing receivers 502-(1-M) and may process the sensing measurements to fulfill a sensing goal. In an example, sensing agent 556 may receive channel representation information (such as CSI or TD-CRI) from one or more of plurality of sensing receivers 502-(1-M) and may process the channel representation information to fulfill a sensing goal. In implementations, sensing agent 556 may receive sensing measurements or channel representation information and may provide the received sensing measurements or channel representation information to sensing algorithm 558, and sensing algorithm 558 may receive the sensing measurements or channel representation information from sensing agent 556 and may process the information to fulfill a sensing goal.

In some implementations, receiving sensing measurements may be carried out by an algorithm running in the medium access control (MAC) layer of remote processing device 506 and processing sensing measurements to fulfill a sensing goal may be carried out by an algorithm running in the application layer of remote processing device 506. In examples, the algorithm running in the application layer of remote processing device 506 may be known as a Wi-Fi sensing agent, a sensing application, or sensing algorithm. In some implementations, the algorithm running in the MAC layer of remote processing device 506 and the algorithm running in the application layer of remote processing device 506 may run separately on processor 548. In an implementation, sensing agent 556 may pass physical layer parameters (e.g., such as channel representation information, examples of which are CSI and TD-CRI) from the MAC layer of remote processing device 506 to the application layer of remote processing device 506 and may use the physical layer parameters to detect one or more features of interest. In an example, the application layer may operate on the physical layer parameters and form services or features, which may be presented to an end-user. According to an implementation, communication between the MAC layer of remote processing device 506 and other layers or components of remote processing device 506 may take place based on communication interfaces, such as an MLME interface and a data interface. According to some implementations, sensing agent 556 may include/execute a sensing algorithm 558. In an implementation, sensing agent 556 may process and analyze sensing measurements using sensing algorithm 558 and identify one or more features of interest. Further, sensing agent 556 may be configured to determine a number and timing of sensing transmissions and sensing measurements for the purpose of Wi-Fi sensing. In some implementations, sensing agent 556 may be configured to cause one or more of plurality of sensing transmitters 504-(1-N) to transmit sensing measurements to one or more of plurality of sensing receivers 502-(1-M).

For ease of explanation and understanding, descriptions provided above may be with reference to sensing receiver 502-1 and/or sensing transmitter 504-1, however, the description is equally applicable to one or more of plurality of sensing receivers 502-(1-M) and/or one or more of plurality of sensing transmitters 504-(1-N).

According to one or more implementations, communications in network 560 may be governed by one or more of the 802.11 family of standards developed by IEEE. Some example IEEE standards may include IEEE 802.11-2020, IEEE 802.11ax-2021, IEEE 802.11me, IEEE 802.11az and IEEE 802.11be. IEEE 802.11-2020 and IEEE 802.11ax-2021 are fully-ratified standards whilst IEEE 802.11me reflects an ongoing maintenance update to the IEEE 802.11-2020 standard and IEEE 802.11be defines the next generation of standard. IEEE 802.11az is an extension of the IEEE 802.11-2020 and IEEE 802.11ax-2021 standards which adds new functionality. In some implementations, communications may be governed by other standards (other or additional IEEE standards or other types of standards). In some embodiments, parts of network 560 which are not required by system 500 to be governed by one or more of the 802.11 family of standards may be implemented by an instance of any type of network, including wireless network or cellular network. Further, IEEE 802.11ax included OFDMA, which allows sensing receiver 502 to simultaneously transmit data to all participating devices, such as plurality of sensing transmitters 504-(1-N), and vice versa using a single transmission opportunity (TXOP). The efficiency of OFDMA depends on how sensing receiver 502-1 schedules channel resources (interchangeably referred to as RUs) among plurality of sensing transmitters 504-(1-N) and configures transmission parameters. According to an implementation, system 500 may be an OFDMA enabled system.

Referring back to FIG. 5, according to one or more implementations, system 500 may participate in a sensing session. In examples, a sensing session may be an agreement between a sensing initiator and a sensing responder to participate in a WLAN sensing procedure (also known as a Wi-Fi sensing procedure). In examples, sensing measurement parameters associated with a sensing session may be determined by the sensing initiator and may be exchanged between the sensing initiator and the sensing responder. In examples, sensing initiator may be sensing transmitter 504-1 and sensing responder may be sensing receiver 502-1. In examples, sensing initiator may be sensing receiver 502-1 and sensing responder may be sensing transmitter 504-1. In examples, sensing initiator may be remote processing device 506, and both sensing transmitter 504-1 and sensing receiver 502-1 may be sensing responders. In examples, sensing transmitter 504-1 may participate in multiple sensing sessions either as a sensing initiator or as a sensing responder. In examples, sensing receiver 502-1 may participate in multiple sensing sessions either as a sensing initiator or as a sensing responder. In examples, remote processing device 506 may participate in multiple sensing sessions as a sensing initiator.

FIG. 6 illustrates an example of a WLAN sensing procedure (also known as a Wi-Fi sensing procedure) according to some embodiments. In examples, a WLAN sensing procedure allows a STA to perform WLAN sensing. In an example, a WLAN sensing procedure enables a STA to obtain one or more sensing measurements of the wireless transmission channel between two or more STAs and/or the wireless transmission channel between a receive antenna and a transmit antenna of a STA. In examples, a WLAN sensing procedure is composed of one or more of a sensing session setup, a sensing measurement setup, one or more sensing measurement instances, sensing measurement setup termination, and sensing session termination.

FIG. 6 illustrates a sensing session setup with a STA with MAC ADDR=A and AID=1. In examples, a sensing session setup establishes a sensing session. In examples, the sensing session may be identified by the AID of the STA involved in the sensing session. FIG. 6 illustrates a sensing measurement setup procedure for the STA with MAC ADDR=A, where the sensing measurement setup ID=1.

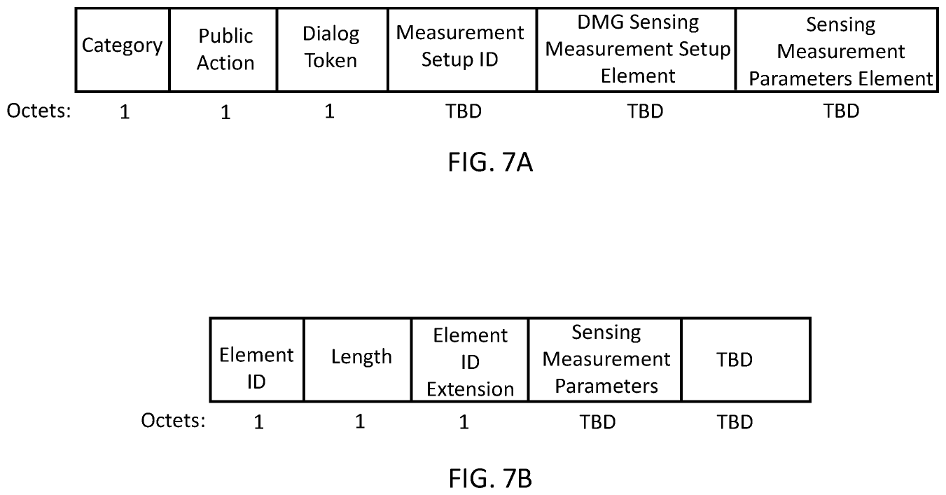

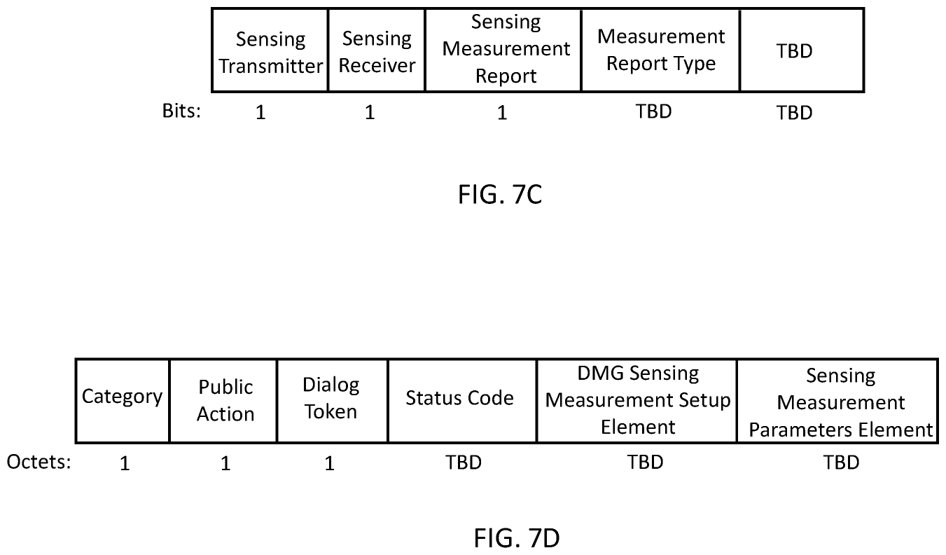

In examples, a sensing measurement setup allows for a sensing initiator and a sensing responder to exchange and agree on operational attributes associated with a sensing measurement instance. A sensing initiator may transmit a Sensing Measurement Setup Request frame to a sensing responder with which it intends to perform a sensing measurement setup. An example of a Sensing Measurement Setup Request frame is provided in FIG. 7A. In examples, the Sensing Measurement Setup Request frame is a Public Action frame, and in examples is identified by a Public Action field value. As shown in the example illustrated in FIG. 7A, in embodiments, a Sensing Measurement Set Request frame format may include one or more of a Category field, a Public Action field, a Dialog Token field, a Measurement Setup ID field, a DMG Sensing Measurement Setup Element field, and a Sensing Measurement Parameters element. In examples, a Category value code is defined for a “Protected Sensing Frame”. In an embodiment, a Protected Sensing Action field is defined in the octet immediately after the Category field in order to differentiate Protected Sensing Frame formats from Public Sensing Frame formats.

FIG. 7B illustrates an example, according to some embodiments, of a Sensing Measurement Parameters element. In examples, a Sensing Measurement Parameters element indicates operational attributes of a corresponding sensing measurement instance. In examples, the Sensing Measurement Parameters element comprises a Sensing Measurement Parameters field. FIG. 7C illustrates an example of a format of a Sensing Measurement Parameters field, according to some embodiments. In an example, a Sensing Measurement Parameters field comprises a Sensing Transmitter subfield. The Sensing Transmitter subfield may be set to 1 to indicate a sensing responder assumes a sensing transmitter role, such as sensing transmitter 504-1. In an example, the sensing responder assumes a sensing transmitter role according to the Sensing Transmitter subfield for the Sensing Measurement Setup ID associated with the Sensing Measurement Parameters field. In an example, the Sensing Measurement Parameters field comprises a Sensing Receiver subfield. The Sensing Receiver subfield may be set to 1 to indicate a sensing responder assumes a sensing receiver role, such as sensing receiver 502-1. In an example, the sensing responder assumes a sensing receiver role according to the Sensing Receiver subfield for the Sensing Measurement Setup ID associated with the Sensing Measurement Parameters field.

Referring again to FIG. 7C, in examples, a Sensing Measurement Parameters field format includes a Sensing Measurement Report subfield if the Sensing Receiver subfield indicates that the sensing responder should assume a sensing receiver role. In an example, the Sensing Measurement Report subfield may indicate that whether or not a sensing responder sends Sensing Measurement Report frames in sensing measurement instances that result from the sensing measurement setup.

Referring again to FIG. 7C, in examples a Sensing Measurement Parameters field format includes a Measurement Report Type subfield. In examples, the Measurement Report Type subfield indicates the type of measurement result reported in sensing measurement instance(s) corresponding to the sensing measurement setup ID, for example, when the sensing initiator is a sensing transmitter, such as sensing transmitter 504-1.

In examples, after the sensing responder receiver the Sensing Measurement Setup Request frame, the sensing responder may transmit a Sensing Measurement Setup Response frame. An example of a Sensing Measurement Setup Response frame is provided in FIG. 7D. In examples, the sensing responder may use a Status Code field in the Sensing Measurement Setup Response frame to indicate whether the sensing responder accepts the requested sensing measurement setup parameters in the received Sensing Measurement Setup Request frame. In an embodiment, the Status Code field may be set to 0 indicating a successful sensing measurement setup, where the sensing responder accepts the operational attributes included in the Sensing Measurement Setup Request frame. In examples, the sensing responder may indicate in the Sensing Measurement Setup Response frame that the operational attributes included in the Sensing Measurement Setup Request frame sent by the sensing initiator are not accepted, for example by setting a Status Code field to a non-zero value. In examples, the sensing responder may indicate in the Sensing Measurement Setup Response frame preferred sensing measurement parameters, for example to indicate to the sensing initiator one or more operational attributes preferred by the sensing responder. In examples, the sensing responder may indicate to the sensing initiator that preferred sensing measurement parameters are included in the Sensing Measurement Setup Response frame by setting a Status Code field to a non-zero value.

In examples, the sensing initiator may assign a role to the sensing responder as part of the sensing measurement setup sent in the Sensing Measurement Setup Request frame. For example, the sensing initiator may indicate to a sensing responder that the sensing responder is to assume the role of a sensing receiver, such as sensing receiver 502-1, or the role of a sensing transmitter, such as sensing transmitter 504-1, or the role of sensing receiver 502-1 and sensing transmitter 504-1. In examples, sensing initiator may indicate to sensing responder whether the sensing responder sends sensing measurement report frames in sensing measurement instances. In an embodiment, the role assigned to the sensing responder and/or whether the sensing responder sends sensing measurement report frames persists until the sensing measurement setup is terminated.

Referring again to FIG. 6 and the sensing session with the STA with MAC ADDR=A identified by the STA AID, AID=1, the sensing measurement setup is followed by one or more sensing measurement instances and measurement reporting instances which may be performed based on the defined operational attribute set. In the example shown in FIG. 6, the one or more sensing measurement instances for the STA with MAC ADDR=A may be assigned sensing measurement instance IDs, for example, a first sensing measurement instance may be assigned sensing measurement instance ID=1, and a second measurement instance may be assigned sensing measurement instance ID=2. In examples, a sensing measurement instance may be uniquely associated with a sensing measurement setup.

Referring again to FIG. 6, a second sensing measurement setup may be initiated for the STA with MAC ADDR=A, which may be identified as sensing measurement setup ID=2. As with sensing measurement setup ID=1, sensing measurement setup ID=2 may be associated with a second operational attribute set. In examples, after the second sensing measurement setup, any subsequent one or more sensing measurement instances may be performed based on either the first operational attribute set (sensing measurement setup ID=1) or the second operational attribute set (sensing setup measurement ID=2.)

Referring again to FIG. 6, FIG. 6 illustrates a sensing session setup with a STA with MAC ADDR=B and UID=2. In examples, the sensing session may be identified by the UID of the STA with MAC ADDR=B. FIG. 6 further illustrates a sensing measurement setup for the STA with MAC ADDR=B. In the example, the operational attribute set for the sensing measurement setup for the STA with MAC ADDR=B is the same as the second operational attribute set established with the STA with MAC ADDR=A, and the sensing measurement setup ID is used for both the STA with MAC ADDR=A and the STA with MAC ADDR=B. That is, a sensing measurement setup ID (which may also be referred to as a sensing measurement setup label) may apply to one or more STA. In examples according to FIG. 6, subsequent sensing measurement instances associated with sensing measurement setup ID=2 may be associated with the STA with MAC ADDR=A, the STA with MAC ADDR=B, or with both the STA with MAC ADDR=A and the STA with MAC ADDR=B. An example of one-to-many triggering is shown in FIG. 6 where AID=1 and UID=2 are both associated with a single measurement instance and measurement reporting (measurement instance ID=2 and measurement setup ID=2).

In examples, an operational attribute set of a sensing session may be terminated by performing a sensing measurement setup termination procedure, for example as is shown in FIG. 6 for sensing measurement setup ID=1 and the STA with MAC ADDR=A. In examples, the sensing measurement setup ID of a terminated sensing measurement setup may be used for a subsequent sensing measurement setup. This is shown in FIG. 6 where a sensing measurement setup with ID=1 is established for the STA with MAC ADDR=B, after the termination of the sensing measurement setup ID=1 with the STA with MAC ADDR=A. In some embodiments, a sensing session may be terminated using a sensing session termination procedure, as shown in FIG. 6.

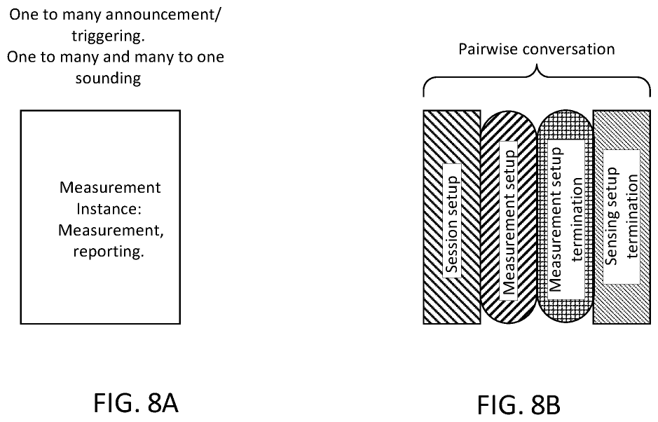

FIG. 8A illustrates exchanges between a sensing initiator and a sensing responder that may be one-to-many or many-to-one. In examples, a measurement instance and/or measurement reporting may have a one-to-one (single device to single device) announcement or triggering or may have a one-to-many (single device to multiple device) announcement or triggering. In examples, a measurement instance may have a one-to-one, one-to-many, or many-to-one (many devices to a single device) sounding.

As previously described, a sensing session is an agreement between a sensing initiator and a sensing responder to participate in a WLAN sensing procedure, that is, a sensing session is pairwise and in examples, may be identified by MAC addresses of the sensing initiator and the sensing responder or by the associated AID/UID. FIG. 8B shows an example of pairwise exchanges or procedures that may take place between a sensing initiator and a sensing responder related to a sensing session, which include a sensing session setup, a sensing measurement setup, a sensing measurement setup termination, and a sensing session termination.

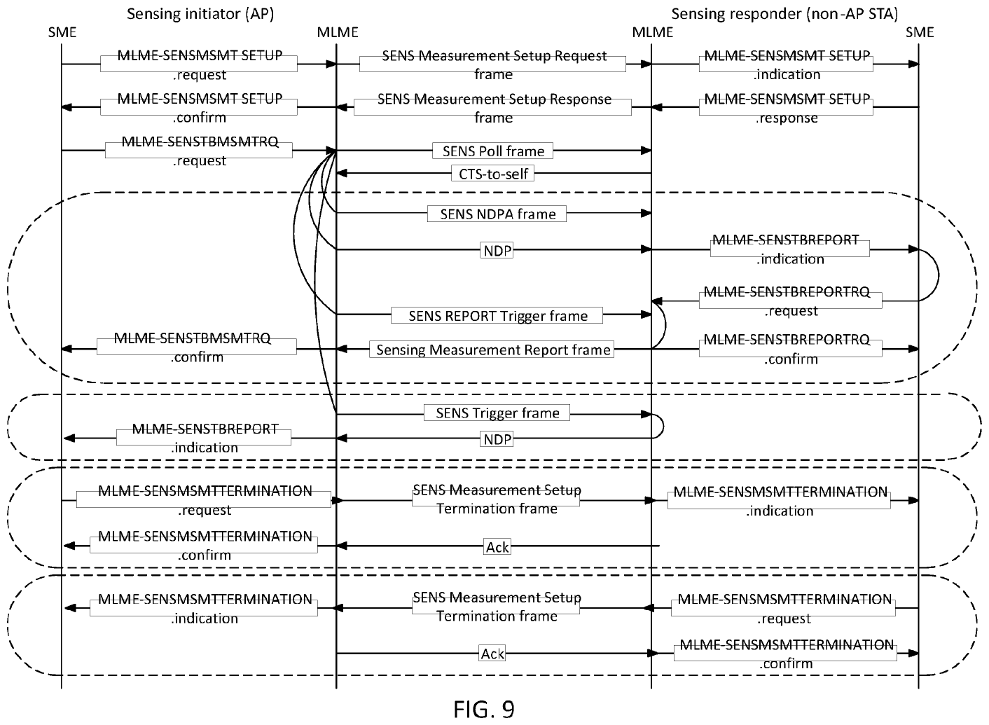

In examples, a sensing measurement instance of a WLAN sensing procedure may be a trigger-based (TB) sensing measurement instance. FIG. 9 depicts a message flow of a sensing session of a WLAN sensing procedure comprising a sensing measurement setup procedure followed by one or more trigger-based (TB) sensing measurement instances that consists of either NDPA sounding or trigger frame (TF) sounding, following by a sensing measurement setup termination procedure, according to some examples. In examples, a TB sensing measurement instance may be used where the sensing initiator is an AP and one or more non-AP STAs are sensing responders. In examples, a TB sensing measurement instance may include a polling phase, an NDPA sounding phase, a trigger frame (TF) sounding phase, and a reporting phase.

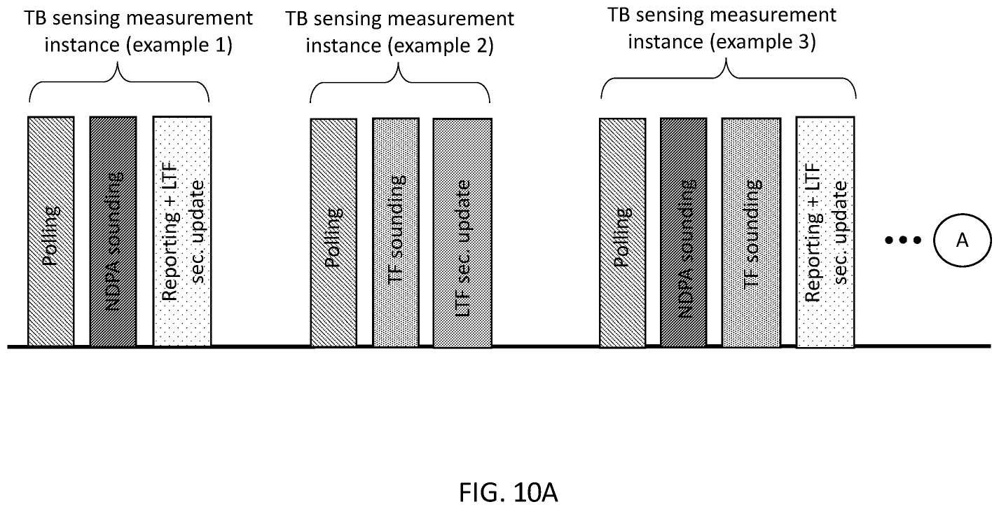

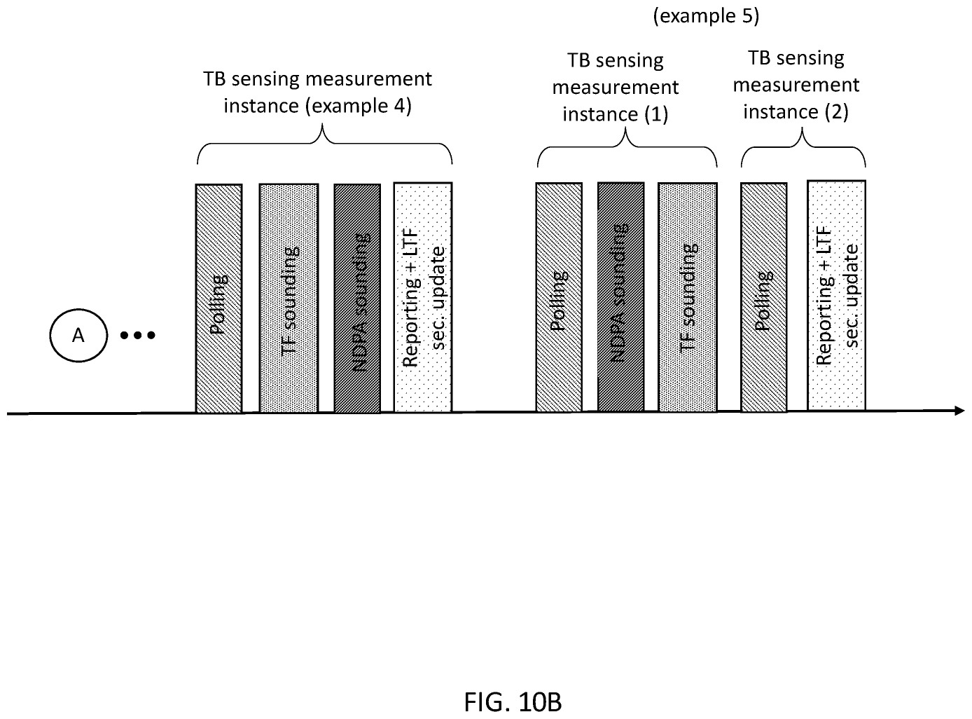

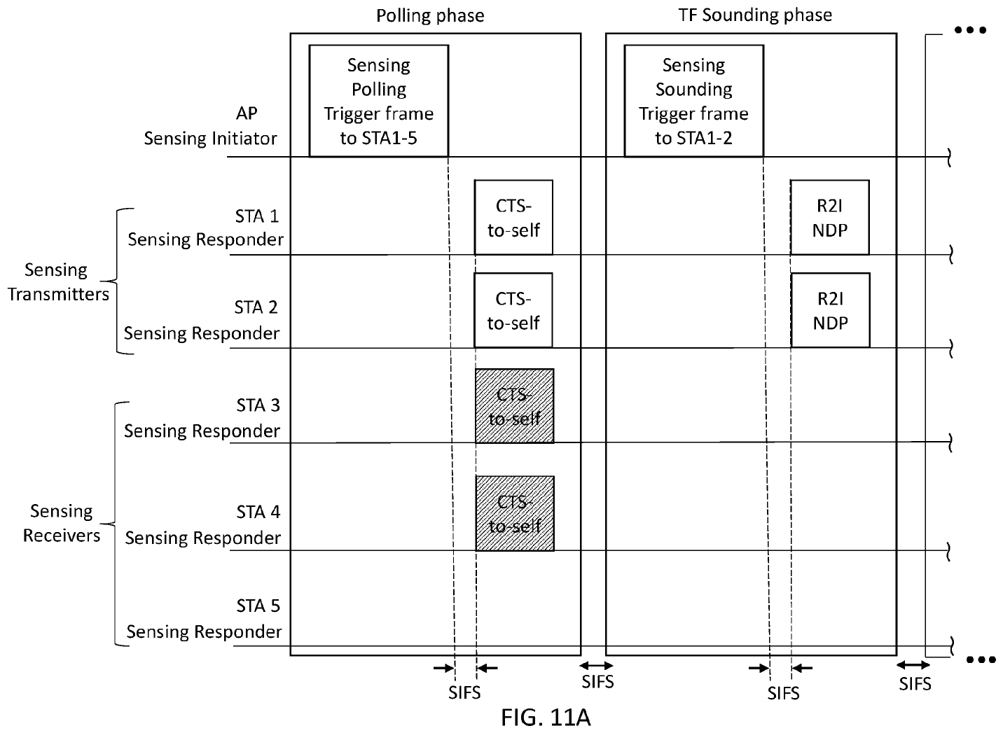

FIG. 10A and FIG. 10B illustrate five examples of TB sensing measurement instances. Example 1 of FIG. 10A illustrates an example of a TB sensing measurement instance comprising a polling phase, an NDPA sounding phase, and a reporting phase. Example 2 of FIG. 10A illustrates an example of a TB sensing measurement instance comprising a polling phase and a TF sounding phase. Example 3 of FIG. 10A and example 4 of FIG. 10B illustrate two examples of a TB sensing measurement instance comprising a polling phase, an NDPA sounding phase, a TF sounding phase, and a reporting phase. Example 5 of FIG. 10B shows two TB sensing measurement instances, where the first TB sensing measurement instance comprises a polling phase, an NDPA sounding phase, and a TF sounding phase, and the second TB sensing measurement instance comprises a polling phase and a reporting phase. In examples, the TF sounding phase of the TB sensing measurement instance may precede the NDPA sounding phase of the TB sensing measurement instance, for example, as in Example 4. In examples, the NDPA sounding phase of the TB sensing measurement instance may precede the NDPA sounding phase of the TB sensing measurement instance, for example as in Example 3. In some embodiments, the reporting phase of the second TB sensing measurement instance in Example 5 may be addressed to sensing responders other than the sensing responders involved in the TF sounding phase or the NDPA sounding phase of the first TB measurement instance.

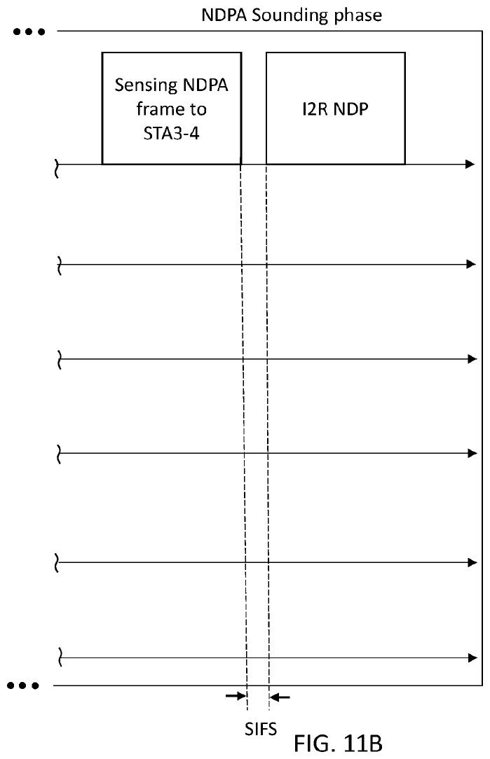

FIG. 11A and FIG. 11B is one example of a TB sensing measurement instance with a single AP in the role of a sensing initiator and five STAs, referred to as STA 1, STA 2, STA 3, STA 4, and STA 5, all of which in the example are sensing responders. In the example, the TB sensing measurement instance comprises a polling phase, a TF sounding phase, and an NDPA sounding phase. In the example, STA 1 and STA 2 are sensing transmitters, such as sensing transmitter 504-1 and sensing transmitter 504-2. In the example of FIG. 11A and FIG. 11B, STA 3, STA 4, and STA 5 are sensing receivers, such as sensing receiver 502-1, sensing receiver 502-2, and sensing receiver 502-3. In examples, in the polling phase, the AP as the sensing initiator transmits a Sensing Polling Trigger frame to STA 1, STA 2, STA 3, STA 4, and STA 5. In an embodiment, sensing transmitter STA 1 (504-1) and sensing transmitter STA 2 (504-2) respond to the Sensing Polling Trigger frame with an indication that the STA is available to participate in a sensing measurement instance. In examples, the indication is a CTS-to-self frame. In an embodiment, sensing receiver STA 3 (502-1) and sensing receiver STA 4 (502-2) respond to the Sensing Polling Trigger frame with an indication that the STA is available to participate in a sensing measurement instance. In examples, the indication is a CTS-to-self frame. In the example, sensing receiver STA 5 (502-3) does not respond to the Sensing Polling Trigger frame sent by the AP as the sensing initiator, indicating that STA 5 (502-3) will not participate in the sensing measurement instance.

The sensing measurement instance of FIG. 11A and FIG. 11B includes a TF Sounding phase. In examples, in the TF Sounding phase, the AP as the sensing initiator sends a Sensing Sounding Trigger frame to sensing transmitter STA 1 (504-1) and to sensing transmitter STA 2 (504-2). In examples, a period of one or more SIFS elapses between the AP receiving the CTS-to-self frames from STA 1, STA 2, STA 3, and STA 4 before sending the Sensing Sounding Trigger frame. In examples, responsive to receiving the Sensing Sounding Trigger frame, sensing transmitter STA 1 (504-1) and sensing transmitter STA 2 (504-2) send sensing transmissions to the AP. In examples, the sensing transmissions may comprise NDP transmissions. In an example, one or more of the NDP transmissions to the AP may be R2I NDP transmissions (as shown in the example of FIG. 11A and FIG. 11B). In examples, a period of one or more SIFS elapses between sensing transmitter STA 1 (504-1) receiving the Sensing Sounding Trigger frame and transmitting a sensing transmission, and in examples a period of one or more SIFS elapses between sensing transmitter STA 2 (504-2) receiving the Sensing Sounding Trigger frame and transmitting a sensing transmission. In examples, the AP may assume the role of sensing receiver 502-4, and the AP may make sensing measurements on the sensing transmissions from sensing transmitter STA 1 (504-1) and sensing transmitter STA 2 (504-2).

Referring again to FIG. 11A and FIG. 11B, in a NDPA sounding phase, the AP acting as sensing initiator assumes the role of sensing transmitter (504-3). In examples, the AP as sensing transmitter 504-3 transmits a sensing transmission. In examples, the sensing transmission may be a broadcast transmission. In examples, the sensing transmission may be a unicast transmission to one or more STAs, for example to sensing receiver STA 3 (502-1) and/or to sensing receiver STA 4 (502-2). In examples, a period of one or more SIFS elapses between the AP as sensing transmitter 504-3 sending the sensing NDPA frame and when the AP as sensing transmitter 504-3 sends the one or more sensing transmissions. In examples, one or more of the sensing transmissions may be a full bandwidth NDP frame. In examples, one or more of the sensing transmissions may be a partial bandwidth NDP frame. In examples, one or more of the NDP frames may be an I2R NDP frame.

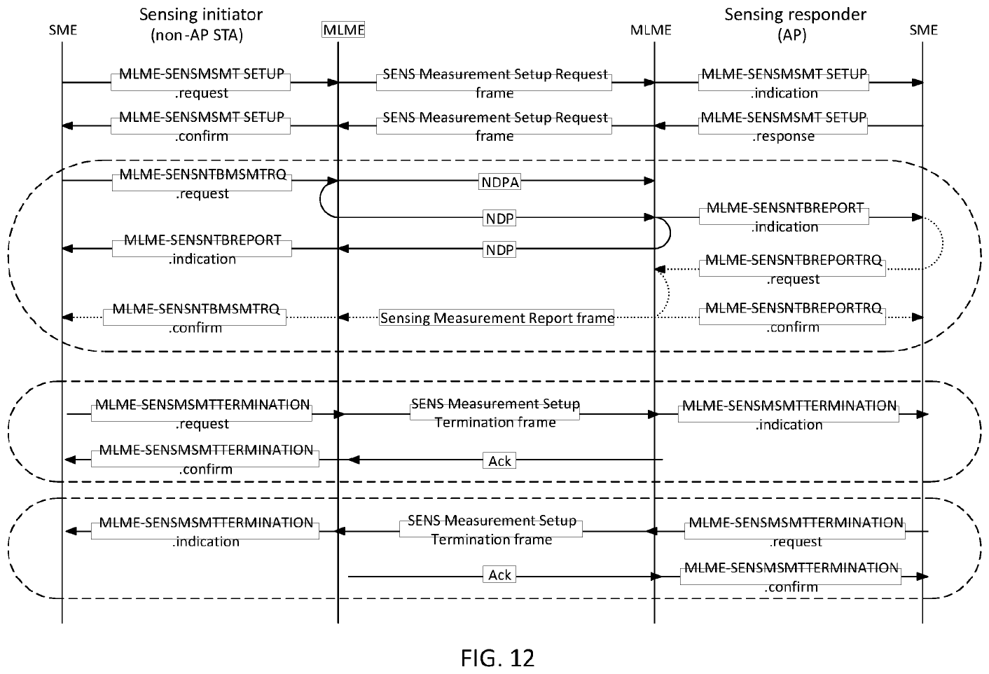

In examples, a sensing measurement instance of a WLAN sensing procedure may be a non-trigger-based (non-TB) sensing measurement instance. FIG. 12 depicts a message flow of a sensing measurement setup procedure followed by one or more non-TB sensing measurement instances of a WLAN sensing procedure that consist of one or more of downlink sounding or uplink sounding, according to some embodiments, followed by a sensing measurement setup termination procedure, according to some examples. In examples, a non-TB sensing measurement instance may be used where the sensing initiator is a non-AP STA and an AP is the sensing responder. In examples of uplink sounding as shown in FIG. 12, the sensing initiator (non-AP STA) acting as a sensing transmitter (for example, sensing transmitter 504-1) transmits a sensing announcement frame followed by a sensing transmission. In examples, the sensing announcement frame may be an NDPA frame. In examples, the sensing transmission may be an NDP frame. In examples, responsive to receiving the sensing transmission, the AP acting as a sensing receiver (for example, sensing receiver 502-1), may transmit to the sensing initiator (non-AP STA in the role of sensing transmitter 504-1) a sensing measurement report, for example one or more Sensing Measurement Report frames. In examples of downlink sounding as shown in FIG. 12, the sensing initiator (non-AP STA) acting as a sensing receiver (for example, sensing receiver 502-1) transmits a sensing announcement frame. In examples, the sensing announcement frame may be an NDPA frame. In examples, responsive to receiving the sensing announcement frame, the AP acting as sensing transmitter (for example, sensing transmitter 504-1) may transmit one or more sensing transmissions. In examples, one or more of the sensing transmissions may be an NDP frame. In examples, the non-AP STA acting as a sensing receiver (502-1), responsive to receiving a sensing transmission, may make a sensing measurement on the sensing transmission. In examples, the sensing measurement setup may be terminated by the sensing initiator or the sensing responder transmitting a SENS Measurement Setup Termination frame. In examples, the sensing responder or sensing initiator (respectively) may respond with an acknowledgment.

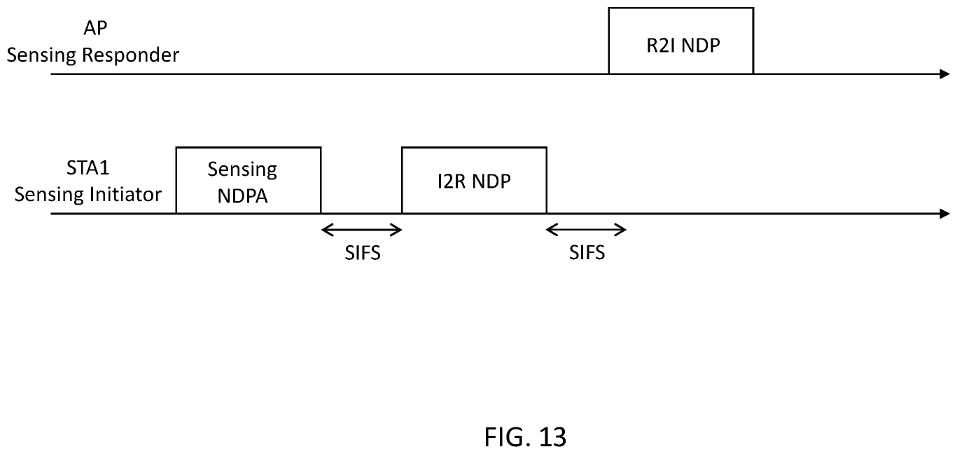

FIG. 13 illustrates a detailed example of a non-TB sensing measurement instance, according to some embodiments. In examples, STA 1 acting as sensing initiator and sensing transmitter, such as sensing transmitter 504-1, transmits a sensing announcement frame. In examples, the sensing announcement frame may be a sensing NDPA frame. In examples, one or more SIFS may elapse followed by STA 1 acting as sensing initiator and sensing transmitter (such as sensing transmitter 504-1) transmitting one or more sensing transmissions. In examples, one or more of the sensing transmissions may be an NDP frame. In an example. STA 1 acting as sensing initiator and sensing receiver, such as sensing receiver 502-1, transmits a sensing announcement frame. In examples, the sensing announcement frame may be a sensing NDPA frame. In examples, one or more SIFS may elapse followed by AP 1 acting as sensing responder and sensing transmitter (such as sensing transmitter 504-1) transmitting one or more sensing transmissions. In examples, one or more of the sensing transmissions may be an NDP frame.

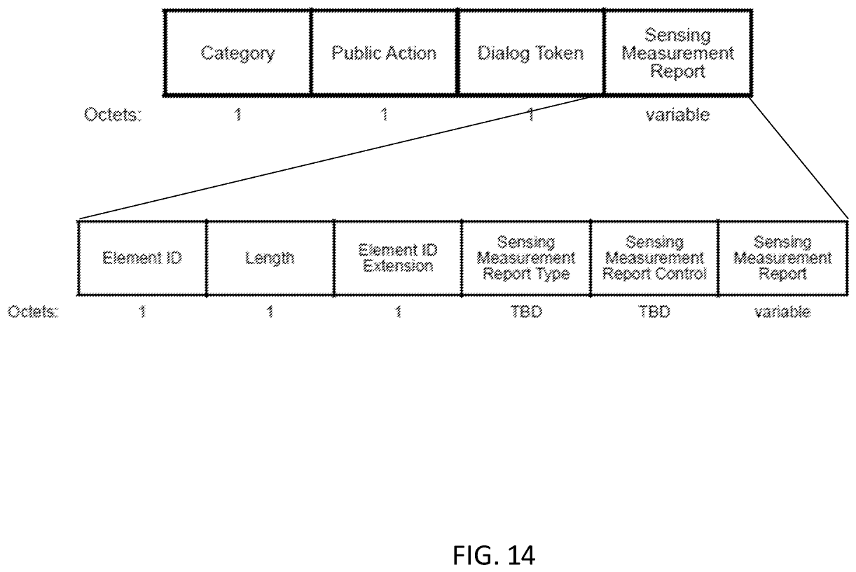

FIG. 14 illustrates an example of a Sensing Measurement Report frame. In some embodiments, a Sensing Measurement Report frame is a Public Action category or a Public Action No Ack category. In some examples, a Sensing Measurement Report frame may be transmitted to provide WLAN sensing measurements, for example to a sensing agent or a sensing algorithm of a sensing initiator. In examples, a Sensing Measurement Report frame may comprise one or more Sensing Measurement Report elements. A Sensing Measurement Report element may comprise a single sensing measurement report, in some embodiments. In examples, a Sensing Measurement Report element may include a Sensing Measurement Report type field, which may contain a number that identifies the type of sensing measurement report. For example, a value of 0 may indicate that the sensing measurement type is a CSI measurement, whereas a non-zero value may indicate that the sensing measurement type is a TD-CRI measurement.

Referring again to FIG. 14, in embodiments a Sensing Measurement Report element may include a Sensing Measurement Report Control field. In examples, the Sensing Measurement Report Control field may contain information necessary to interpret the Sensing Measurement Report field. For example, the Sensing Measurement Report Control field format may comprise one or more subfields. In an embodiment, one or more subfields of the Sensing Measurement Report Control field may include PHY layer parameters used by the sensing receiver when performing the sensing measurement, for example, receiver antenna beamforming or spatial layer information.

In a sensing session, exchanges of transmissions between one or more of plurality of sensing receivers 502-(1-M) and one or more of plurality of sensing transmitters 504-(1-N) may occur. In an example, control of these transmissions may be with the MAC layer of the IEEE 802.11 stack. According to an implementation, one or more of plurality of sensing receivers 502-(1-M) may secure a TXOP which may be allocated to one or more sensing transmissions by one or more of plurality of sensing transmitters 504-(1-N). According to an implementation, one or more of plurality of sensing receivers 502-(1-M) may allocate channel resources (or RUs) within a TXOP to the one or more of plurality of sensing transmitters 504-(1-N). In an example, one or more of plurality of sensing receivers 502-(1-M) may allocate the channel resources to the one or more of plurality of sensing transmitters 504-(1-N) by allocating time and bandwidth within the TXOP to the one or more of plurality of sensing transmitters 504-(1-N).

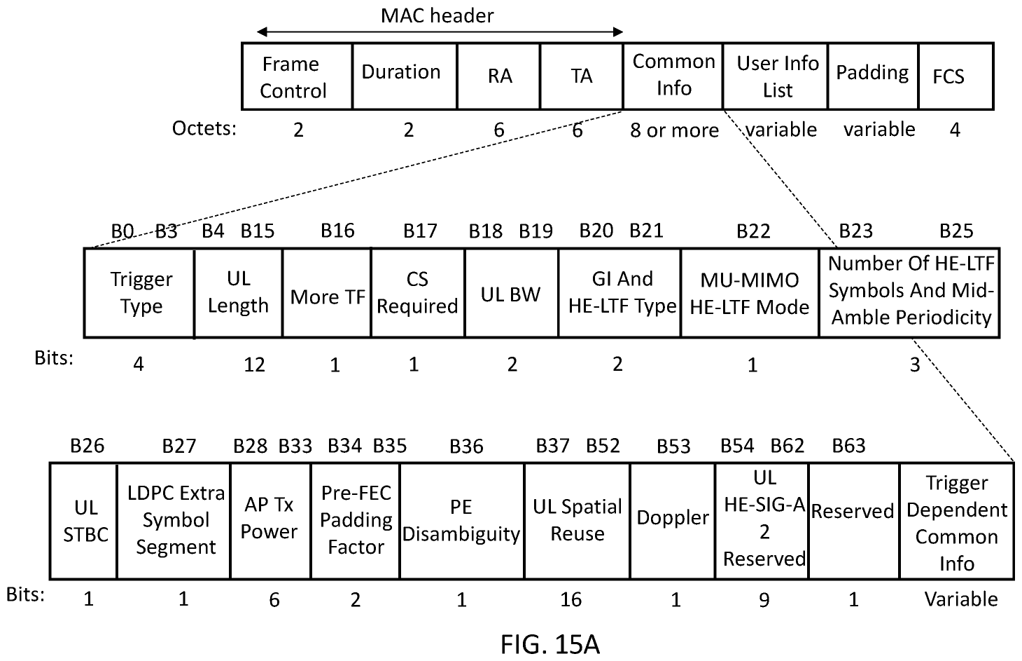

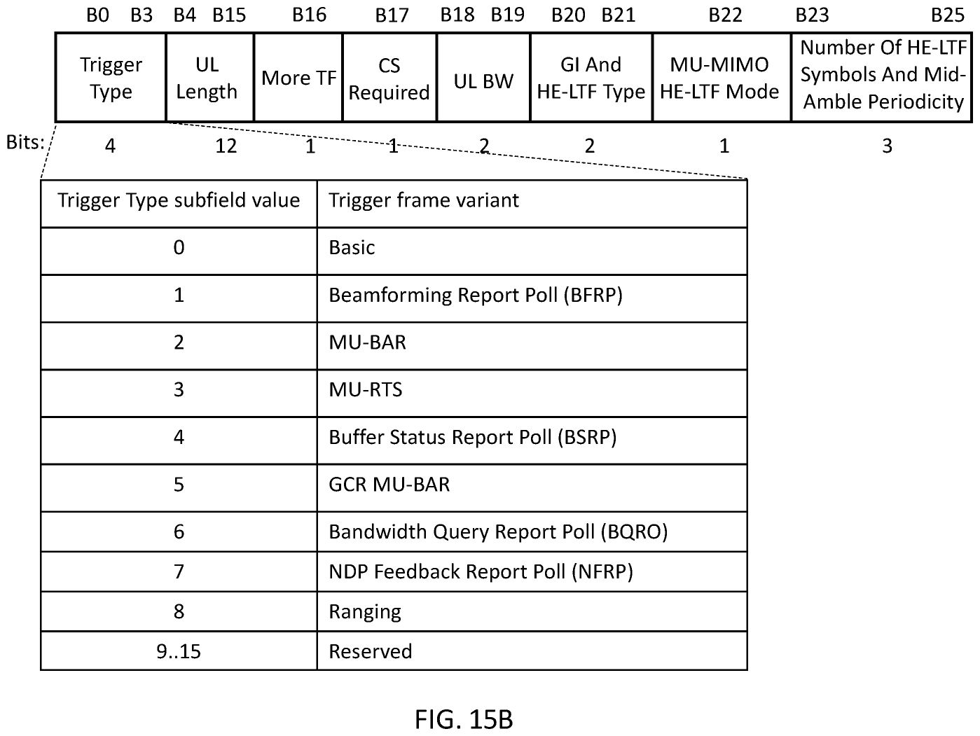

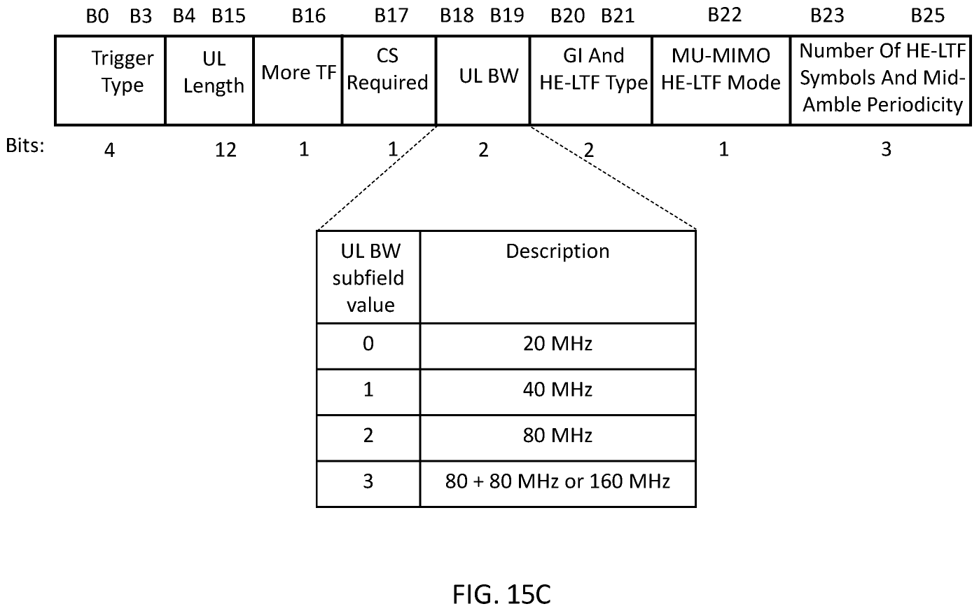

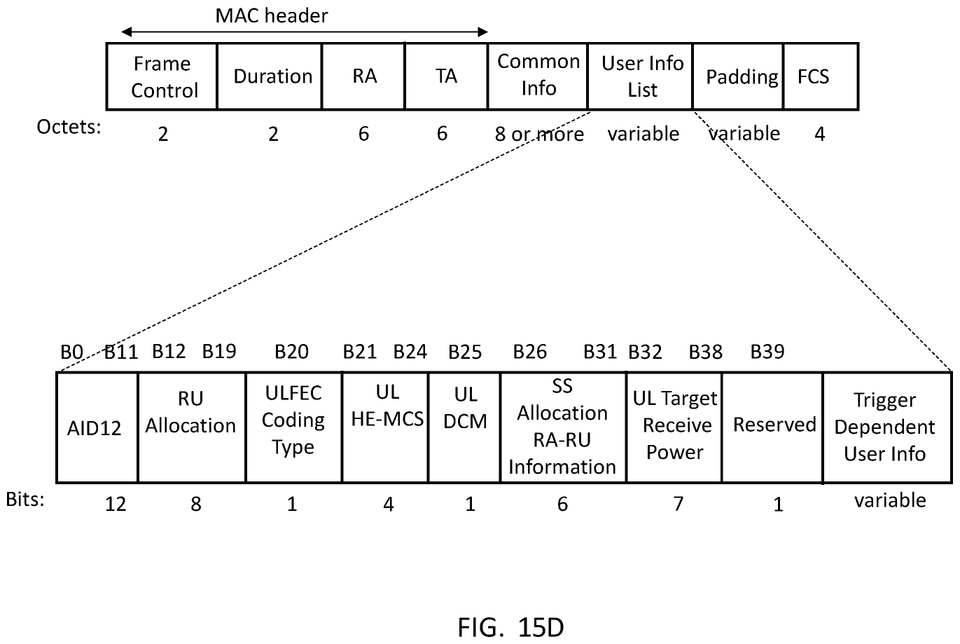

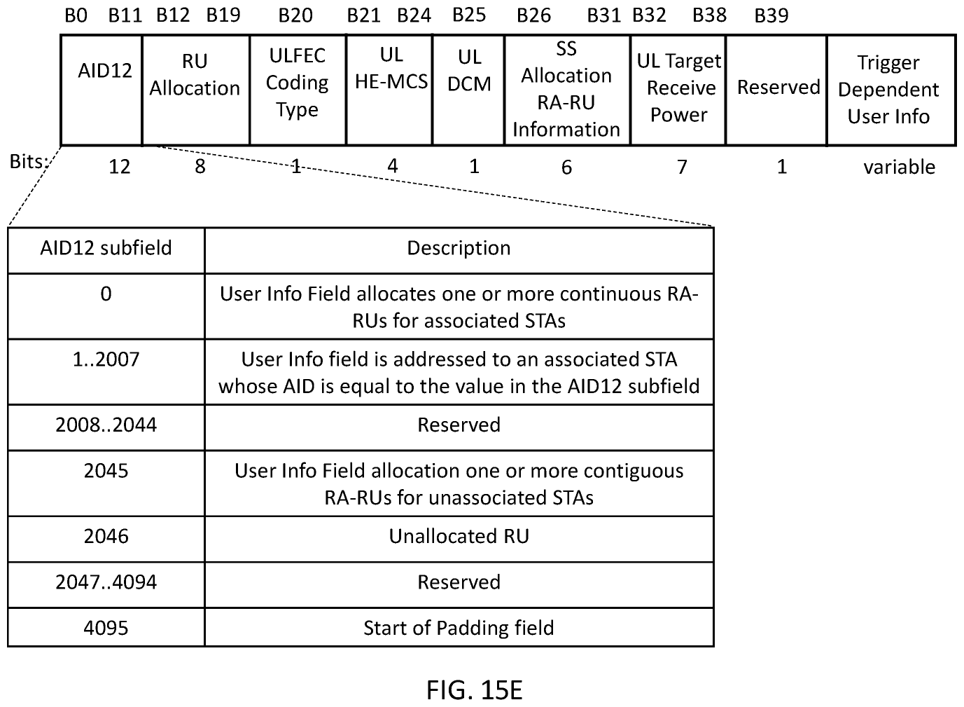

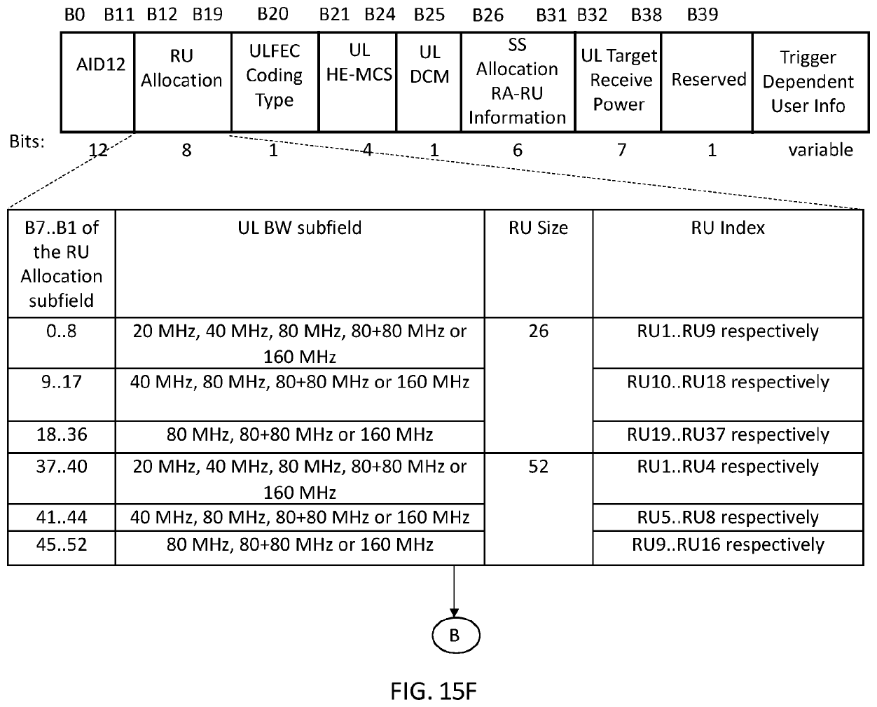

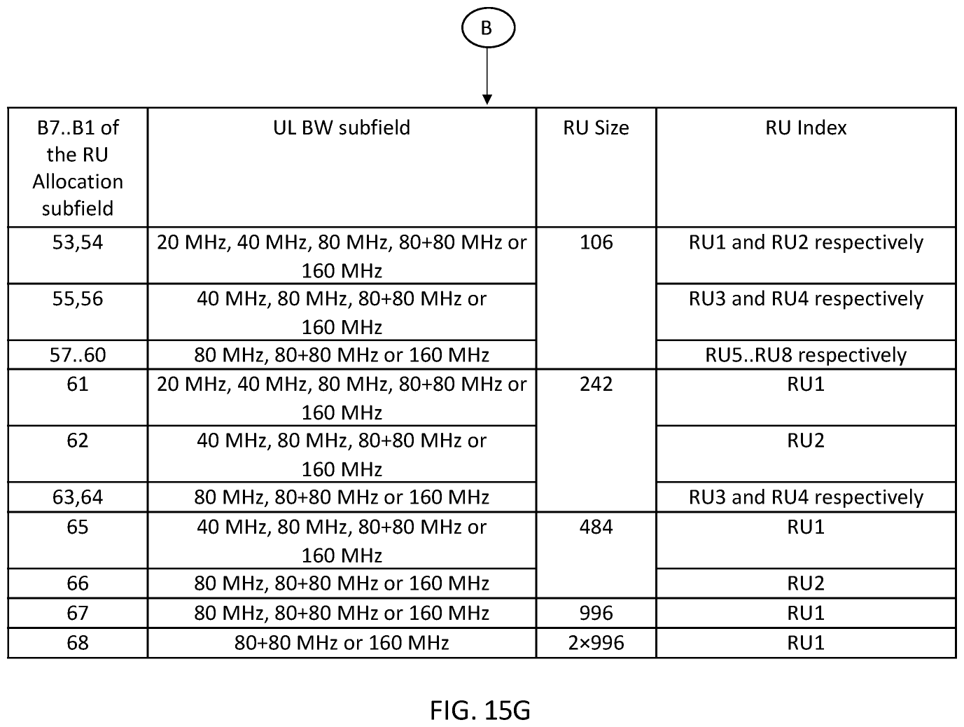

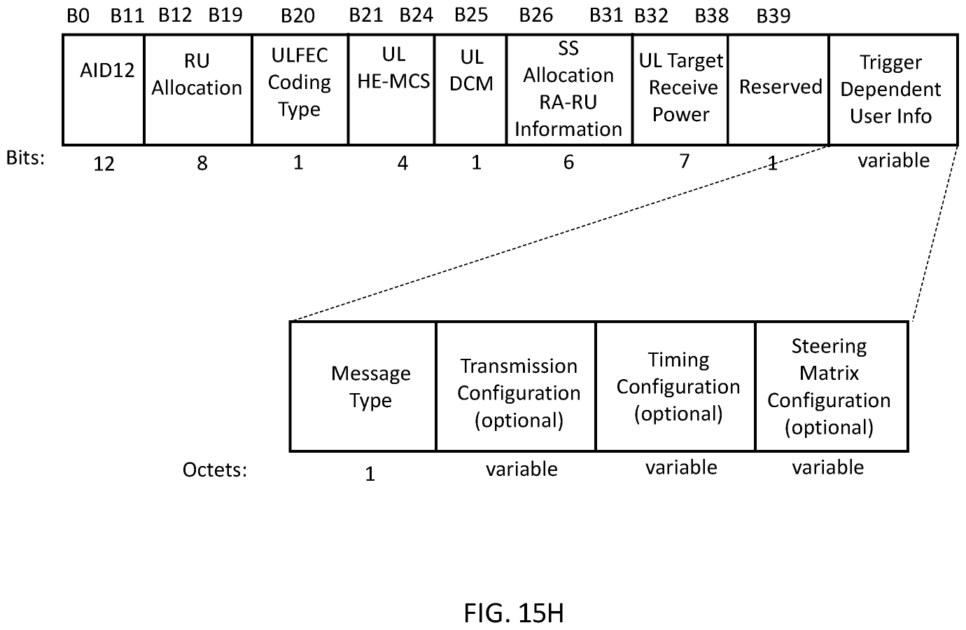

According to an implementation, example 1500 of a hierarchy of fields within sensing trigger message is shown in FIG. 15A to FIG. 15H.

As described in FIG. 15A, the Common Info field may contain information which is common to one or more of plurality of sensing transmitters 504-(1-N). According to some implementations, the requirement of an NDPA preceding an NDP may be optional. This may be indicated to one or more of plurality of sensing transmitters 504-(1-N) and may for example be encoded into a “Trigger Dependent Common Info” field if the requirement is common to plurality of sensing transmitters 504-(1-N), or into a “Trigger Dependent User Info” field if the requirement is specific to one or more of plurality sensing transmitters 504-(1-N). According to an example, the requirement for a sensing announcement (for example, and NDPA) preceding a sensing response NDP may be encoded by a single bit where 0 (bit clear) indicates that a sensing announcement is optional and 1 (bit set) indicates that a sensing announcement is required.

As described in FIG. 15B, a Trigger Type (within B0 . . . 3 of “Common Info” field) may be defined which represents a sensing trigger message. In examples, a sensing Trigger message may have a Trigger Type subfield value of any Reserved value from 9-15, for example a Sensing Trigger message may have a Trigger Type subfield value of 9. In an example of triggering a sensing transmission from a sensing transmitter 504-1, a Trigger Dependent User Info field may include sensing trigger message data. In an implementation, a time-synchronized sensing transmission may be required from plurality of sensing transmitters 504-(1-N) responding to a sensing trigger message. In an example, the requirement for one or more time-synchronized sensing transmissions may be encoded into a Trigger Dependent Common Info field. According to an example, the requirement for one or more time-synchronized sensing transmissions may be encoded by a single bit where 0 (bit clear) represents a request for a normal or non-time-synchronized response and 1 (bit set) represents a request for a time-synchronized response. In some examples, a method of time-synchronization may be requested in the sensing trigger. In examples, the method of time-synchronization to be requested may be encoded into a Trigger Dependent Common Info field. In examples, the encoding may use two bits as shown in the following table.

| Encoding | Method | Description |
|---|---|---|
| 00 | A | Sensing announcement followed by sensing |
| | | NDP. |
| 01 | B | Padding followed by a sensing response |
| | | message. |
| 10 | C | Sensing NDP without an initial sensing |
| | | announcement. |
| 11 | N/A | For future use or extensions. |

As described in FIG. 15C the sensing trigger message may have an uplink bandwidth (UL BW) subfield value of 0, 1, 2 or 3 corresponding to bandwidths of 20 MHz, 40 MHz, 80 MHz, or 80+80 MHz (160 MHz).

As described in FIG. 15D, the User Info List contains information which is specific to each of the plurality of sensing transmitters 504-(1-N). In examples, the User Info List may include the AID of a sensing transmitter, an RU allocation for a sensing transmitter, and other Trigger Dependent User Info.

As described in FIG. 15E, the AID12 subfield of the User Info List illustrated in FIG. 15D may be used to address a specific sensing transmitter of the plurality of sensing transmitters 504-(1-N).

As described in FIG. 15F and FIG. 15G, the RU Allocation subfield is used to allocate resource units (RU) to each of the plurality of sensing transmitters 504-(1-N).

As described in FIG. 15H, the Trigger Dependent User Info subfield may be used to request the transmission configuration and/or steering matrix configuration for one or more of the plurality of sensing transmitters 504-(1-N) that the sensing trigger message is triggering.

In the following description, a sensing algorithm 558 on remote processing device 506 is referred to in the processing of channel representation information. In all examples, the processing of channel representation information may be instead or additionally performed by sensing agent 556 on remote processing device 506, and/or by sensing agent 516-(1-M) and/or sensing algorithm 518-(1-M) on one or more of plurality of sensing receivers 502-(1-M), and/or by sensing agent 536-(1-N) and/or sensing algorithm 538-(1-N) on one or more of plurality of sensing transmitters 504-(1-N).

### C. Systems and Methods for Time Synchronization of Sensing Transmissions Made by Unassociated Stations

The present disclosure generally relates to systems and methods for Wi-Fi sensing. In particular, the present disclosure relates to systems and methods for time synchronization of sensing transmissions made by unassociated stations.

A Wi-Fi sensing system may be configured to detect features of interest in a sensing space. The Wi-Fi sensing system may be a network of Wi-Fi-enabled devices which are part of an IEEE 802.11 network (sometimes referred to as a Basic Service Set (BSS), or Extended Service Set (ESS)). The features of interest may include motion of objects and motion tracking, presence detection, intrusion detection, gesture recognition, fall detection, breathing rate detection, and other applications. The sensing space may refer to any physical space in which a Wi-Fi sensing system may operate and may include a place of abode, a place of work, a shopping mall, a sports hall or sports stadium, a garden, or any other physical space.

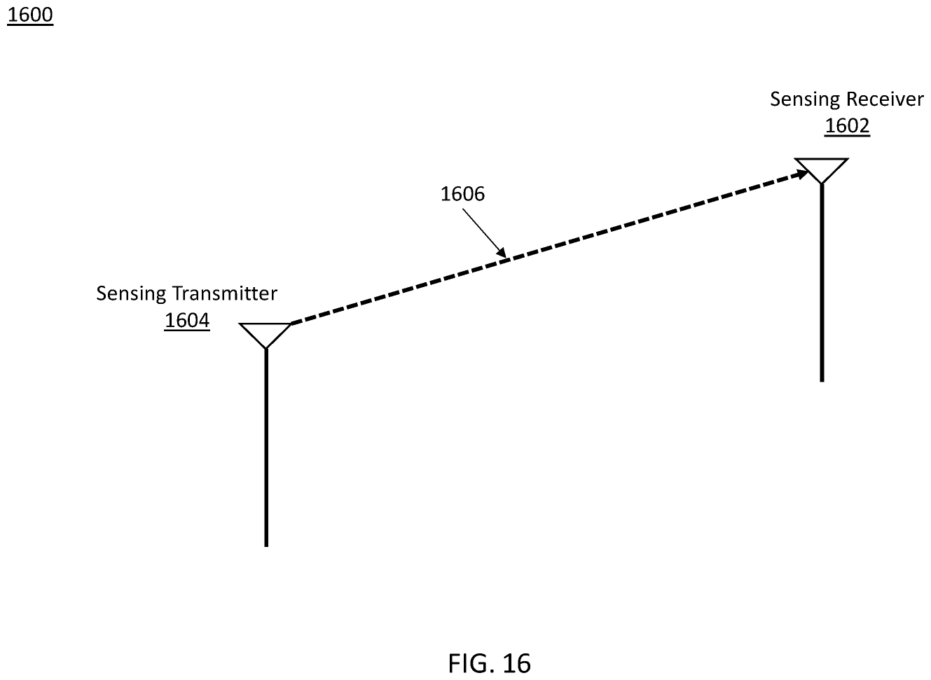

A typical Wi-Fi sensing system includes a sensing transmitter (which may be a non-AP station (STA) or an access point (AP)) and a sensing receiver (which is an AP if the sensing transmitter is a STA, and a STA if the sensing transmitter is an AP). Example representation 1600 of a typical Wi-Fi sensing system is depicted in FIG. 16, according to some embodiments. As described in FIG. 16, the Wi-Fi sensing system includes sensing receiver 1602 and sensing transmitter 1604. Sensing receiver 1602 may be an example of sensing receiver 502-1. Sensing transmitter 1604 may be an example of sensing transmitter 504-1. Further, sensing transmission 1606 is made from sensing transmitter 1604 to sensing receiver 1602 as shown in FIG. 16. Sensing receiver 1602 may perform a sensing measurement on sensing transmission 1606.

A timing synchronization function (TSF) is specified in IEEE 802.11 to fulfill timing synchronization amongst various devices. In examples, a TSF keeps TSF timers for all STAs in the same BSS synchronized. A STA maintains a local TSF timer which is synchronized with an AP TSF timer of the AP with which the STA is associated. Referring to FIG. 5, plurality of sensing transmitters 504-(1-N) maintain corresponding local TSF timers 545-(1-N), which are incremented according to oscillators of plurality of sensing transmitters 504-(1-N), such as local crystal oscillators (LCOs) or voltage controlled oscillators (VCOs).

According to an implementation, pre-association security negotiation (PASN) may be a robust security network (RSN) association authentication protocol in scenarios where it relies on the existence of a pairwise master key security association (PMKSA) for an authentication and key management (AKM). PASN was introduced in IEEE 802.11az and allowed a pre-association encrypted exchange between a STA and an AP.

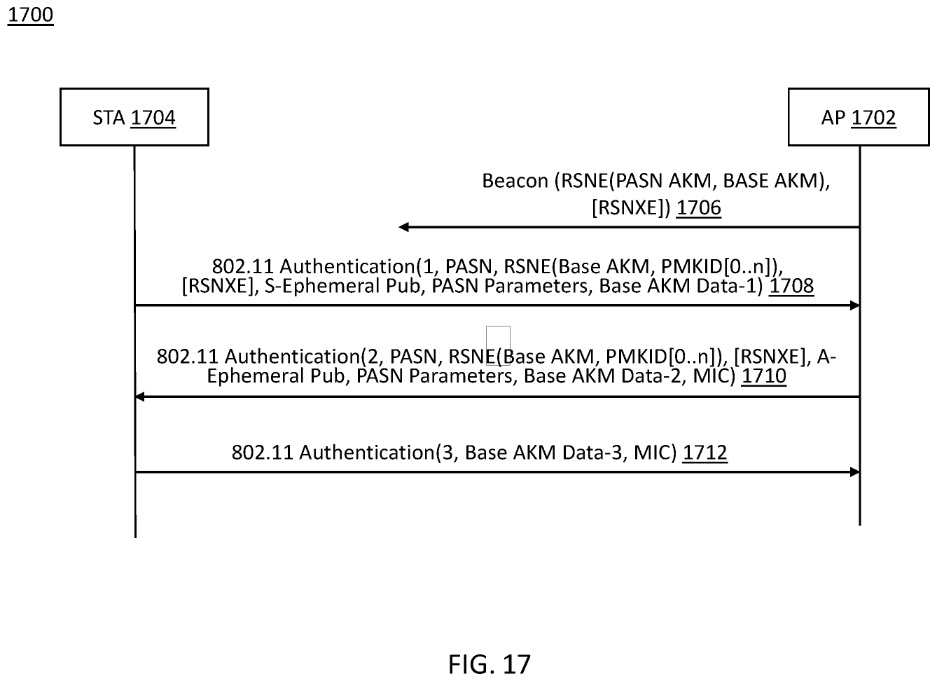

FIG. 17 depicts process 1700 for PASN authentication, according to some embodiments. FIG. 17 is a reproduction of Figure 12-55a from Draft P802.11az_D4.1. In FIG. 17, STA 1704 may be a supplicant and AP 1702 may be an authenticator. In an implementation, AP 1702 may indicate that it is capable of performing PASN authentication by including the PASN AKM as part of the RSN element (RSNE) included in beacon frames and probe response frames.

At step 1706 of process 1700, AP 1702 may send Beacon (RSNE(PASN AKM, Base AKM), [RSNXE]). At step 1708 of process 1700, STA 1704 may send 802.11 Authentication (1, PASN, RSNE(Base AKM, PMKID[0 . . . n]), [RSNXE], S-Ephemeral Pub, PASN Parameters, Base AKM Data-1) to AP 1702. At step 1710 of process 1700, AP 1702 may send 802.11 Authentication (2, PASN, RSNE(Base AKM, PMKID[0 . . . n]), [RSNXE], A-Ephemeral Pub, PASN Parameters, Base AKM Data-2, MIC) to STA 702. At step 1712 of process 1700, STA 1704 may send 802.11 Authentication (3, Base AKM Data-3, MIC) to AP 1702.

In an implementation, three PASN frames may be constructed, namely a first PASN frame, a second PASN frame, and a third PASN frame. The first PASN frame may be sent from a STA to an AP. If the STA initiates PASN authentication, then the STA may first select the authentication parameters and may then compose an RSNE. The STA may send the first PASN frame to the AP. Upon receiving the first PASN frame, the AP may begin the construction of the second PASN frame and when complete, the AP may send the second PASN frame to the STA. Upon receiving the second PASN frame, the STA may begin the construction of the third PASN frame and when complete, the STA may send the third PASN frame to the AP and then install the temporal key derived using the MLME-SETKEYS.request primitive. The AP may install the temporal key derived using the MLME-SETKEYS.request primitive. Currently, PASN procedures may be used for ranging of unassociated STAs (as described in Draft P802.11az_D4.1).

In examples, a sensing initiator which is an AP may establish a sensing measurement session with one or more STAs, including STAs which are not in the same BSS as the AP (i.e., that are not associated with the AP.) The sensing measurement session may indicate to the STAs when to expect to receive a SENS Trigger frame from the AP to trigger a sensing transmission.

For ease of explanation and understanding, the description provided below is with reference to sensing receiver 502-1 and sensing transmitter 504-1, however, the description is equally applicable to remaining sensing receivers 502-(2-M) and remaining sensing transmitters 504-(2-N).

According to an implementation, an out of BSS (OBSS) scenario may refer to a scenario where an AP (also referred to as OBSS AP which is an example of sensing receiver 502-1) and a STA (also referred to as OBSS STA which is an example of sensing transmitter 504-1) are not associated with one another. In examples, in the OBSS scenario, a TSF timer of sensing receiver 502-1 (524-1) and a TSF timer of sensing transmitter 504-1 (545-1) may not be time aligned. As a result, sensing receiver 502-1 and sensing transmitter 504-1 may be time unsynchronized. In examples, an unsynchronized sensing transmitter 504-1 may not know precisely when to expect transmissions from sensing receiver 502-1, such as a SENS Poll frame or a SENS Trigger frame, based on its local TSF timer 545-1. In an example, allowable clock tolerances for sensing receiver 502-1 and sensing transmitter 504-1 may result in a timing error between sensing receiver 502-1 and sensing transmitter 504-1. To compensate for this possible timing error, sensing transmitter 504-1 must allow margin on when it tunes to sensing receiver 502-1 to avoid missing the SENS Poll frame or SENS Trigger frame due to the clock error. In examples, if sensing transmitter 504-1 is in an idle mode, sensing transmitter 504-1 needs to “wake up” and have its receiver in an active receiving mode for a longer period of time, thereby causing increased battery drain. Further, in examples, if sensing transmitter 504-1 is in an active data session with its associated BSS, sensing transmitter 504-1 may need to interrupt this data session for tuning to sensing receiver 502-1 to avoid missing the SENS Poll frame or SENS Trigger frame transmissions. Therefore, a robust time synchronization mechanism between sensing transmitter 504-1 and sensing receiver 502-1 is required.

The present disclosure describes a solution for sensing transmitter 504-1 where sensing transmitter 504-1 is not associated with, and therefore not time synchronized to sensing receiver 502-1 to create and maintain a local version of a clock/timer of sensing receiver 502-1 (for example, TSF timer 524-1). This enables sensing transmitter 504-1 to participate in a sensing session with sensing receiver 502-1. In examples, sensing transmitter 504-1 may use its local version of TSF timer 524-1 of sensing receiver 502-1 to determine when to listen for a trigger frame from sensing receiver 502-1, such that sensing transmitter 504-1 can spend as minimal time as possible with its receiver active, thereby minimizing both battery drain as well as time away from any associated sensing receivers. In some examples, sensing transmitter 504-1 may also time a sensing transmission according to TSF timer 524-1 of sensing receiver 502-1, such that when sensing receiver 502-1 makes a sensing measurement on the sensing transmission, sensing receiver 502-1 may apply a timestamp based on TSF timer 524-1 and may combine the sensing measurement with sensing measurements from other sensing transmitters and/or associated sensing transmitters received in the same measurement time.

In examples, in scenarios where sensing receiver 502-1 is an OBSS AP and sensing transmitter 504-1 is an OBSS STA, a local clock of sensing receiver 502-1 (also referred to as an OBSS AP TSF timer which is an example of TSF timer 524-1) may not be synchronized to a local clock of sensing transmitter 504-1 (also referred to as an OBSS STA TSF timer which is an example of TSF timer 545-1). Furthermore, if there are more than one OBSS AP (such as sensing receivers 502-(1-M)) which are in different BSSs then there may be more than one OBSS AP TSF timer (for example, TSF timers 524-(1-M) that is not synchronized with the OBSS STA TSF timer (for example, TSF timer 545x-1) of sensing transmitter 504-1.

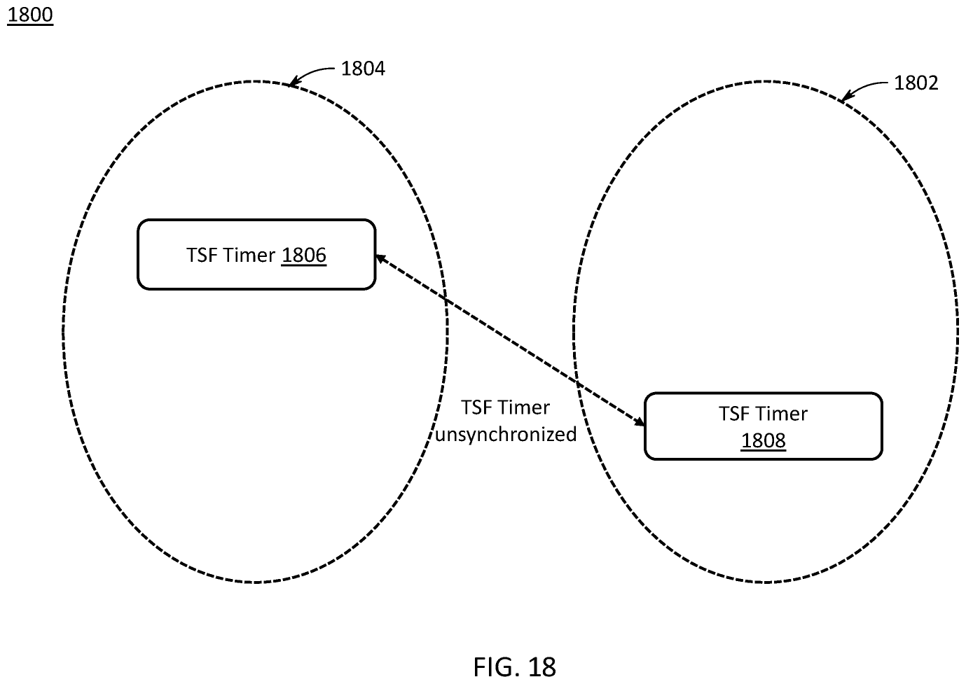

FIG. 18 depicts example 1800 of a TSF timer unsynchronized situation, according to some embodiments. Sensing receiver 502-1 which is an OBSS AP is depicted in FIG. 18 as 1802, and sensing transmitter 504-1 which is an OBSS STA is depicted in FIG. 18 as 1804. As described in FIG. 18, TSF timer 524-1 which is depicted in FIG. 18 as 1806 of unassociated OBSS AP 1802 (sensing receiver 502-1) and TSF timer 545-1 which is depicted in FIG. 18 as 1808 of OBSS STA 1804 (sensing transmitter 504-1) are unsynchronized. Additionally, when OBSS STA 1804 (sensing transmitter 504-1) is required to receive a sensing polling trigger frame or a sensing sounding trigger frame from OBSS AP 1802 (sensing receiver 502-1), then in some scenarios, OBSS STA 1804 (sensing transmitter 504-1) may change channels to receive the sensing polling trigger frame or the sensing sounding trigger frame. As OBSS STA 1804 (sensing transmitter 504-1) and OBSS AP 1802 (sensing receiver 502-1) may not be synchronized, there may be a margin for error in the timing of the channel change or retuning, the sensing trigger reception, and retuning back to the original channel.

According to an implementation, sensing transmitter 504-1 (which is an OBSS STA) may obtain timing information from an unassociated access point (for example sensing receiver 502-1, which is an OBSS AP) (i.e., not associated with sensing transmitter 504-1). In an example, the timing information may be an access point TSF timer of the unassociated access point, that is TSF timer 524-1 of sensing receiver 502-1. In an example implementation, sensing transmitter 504-1 may receive the timing information in a beacon frame broadcast by sensing receiver 502-1.

In some implementations, sensing agent 536-1 or sensing algorithm 538-1 may determine a timer offset value according to a difference between TSF timer 524-1 (timing information) of sensing receiver 502-1 and TSF timer 545-1 of sensing transmitter 504-1. Further, timestamp generation block 544-1 of sensing transmitter 504-1 may be configured to determine a timestamp by combining TSF timer 545-1 of sensing transmitter 504-1 with the timer offset value.

In an implementation, sensing agent 536-1 or sensing algorithm 538-1 may generate local timing information (also referred to as OBSS STA-AP TSF timer) according to the timing information. In an example, the local timing information may be a local version of TSF timer 524-1. In some examples, the local timing information may be a timer offset value determined according to the difference between the timing information and TSF timer 545-1. In examples, the timing information may be stored as the local timing information. In an example, the local timing information associated with TSF timer 524-1 of sensing receiver 502-1 may be stored in sensing receiver information storage 543-1.

According to an implementation, sensing receiver 502-1 may broadcast a beacon frame, for example, every 100 ms. The format of the beacon frame is described in Draft P802.11REVmd_D5.0 section 9.3.3.2—“Beacon frame format”. In an example, first information field of the beacon frame may be a timestamp field. The timestamp field may represent TSF timer 524-1 of sensing receiver 502-1. In an implementation, sensing transmitter 504-1 may receive the beacon frame which announces sensing receiver 502-1.

In some embodiments, sensing transmitter 504-1 may obtain additional timing information (for example, TSF timers 524-(2-M) from a plurality of additional unassociated access points (for example, from one or more of remaining sensing receivers 502-(2-M)) and generate additional local timing information according to the additional timing information. In examples, sensing transmitter 504-1 may store the additional local timing information corresponding to sensing receivers 502-(2-M) in sensing receiver information storage 543-(2-M). According to an implementation, one or more of remaining sensing receivers 502-(2-M) may broadcast beacon frames. In an implementation, sensing transmitter 504-1 may receive one or more beacon frames which announce one or more of remaining sensing receivers 502-(2-M). In an example, the one or more beacon frames of one or more of remaining sensing receivers 502-(2-M) may include a full TSF timers 524-(2-M) (64 bits) that reflects TSF timers of one or more of remaining sensing receivers 502-(2-M). In an implementation, sensing transmitter 504-1 may store local timing information (corresponding to TSF timers 524-(2-M)) of one or more remaining sensing receivers 502-(2-M) received in the one or more beacon frames in sensing receiver information storage 543-(2-M). In some implementations, sensing transmitter 504-1 may calculate and store timer offset values for the one or more remaining sensing receivers 502-(2-M) in sensing receiver information storage 543-(2-M).

In examples, sensing transmitter 504-1 may have stored identifiers of one or more of plurality of sensing receivers 502-(1-M). An example of an identifier of sensing receiver 502-1 is a service set identifier or (SSID). In an implementation, sensing transmitter 504-1 may transmit a probe request. In an example, the probe request may include at least one identifier of the one or more of plurality of sensing receivers 502-(1-M). Further, sensing transmitter 504-1 may receive a probe response. In an example, the probe response may include at least one response from one or more of plurality of sensing receivers 502-(1-M) associated with the at least one identifier. In an example, a probe response from sensing receiver 502-1 may include TSF timer 524-1 of sensing receiver 502-1, where the probe response is transmitted from sensing receiver 502-1 to sensing transmitter 504-1 responsive to receiving the probe request from sensing transmitter 504-1 including identifier of sensing receiver 502-1.

In some examples, the probe request may include an access point identification wildcard (such as service set identifiers (SSID) wildcard), in which case any of plurality of sensing receivers 502-(1-M) may respond with a probe response. In some implementations, sensing transmitter 504-1 may send one or more probe requests including one or more of plurality of sensing receivers 502-(1-M) identification. In an implementation, sensing transmitter 504-1 may transmit one or more probe requests including SSIDs of one or more of plurality of sensing receivers 502-(1-M). Each of the one or more of plurality of sensing receivers 502-(1-M) associated with the SSIDs in the probe requests may respond with a probe response. In an example, the probe responses of the one or more of plurality of sensing receivers 502-(1-M) may include a full TSF timestamp (64 bits) which reflects the TSF timers of the one or more of plurality of sensing receivers 502-(1-M) (such as TSF timers 524-(1-M)). In an implementation, sensing transmitter 504-1 may store local timing information associated with TSF timers 524-(1-M) of one or more plurality of sensing receivers 502-(1-M) received in probe responses, in sensing receiver information storage 543-(1-M). In some implementations, sensing transmitter 504-1 may calculate and store timer offset values for the one or more of plurality of sensing receivers 502-(1-M) in sensing receiver information storage 543-(1-M).

According to an implementation, by generating and storing the local timing information associated with sensing receiver 502-1 (i.e., the local version of TSF timer 524-1 or by calculating the timer offset value for sensing receiver 502-1), sensing transmitter 504-1 completes the process of initial synchronization with sensing receiver 502-1. According to an implementation, sensing transmitter 504-1 may increment the local timing information according to a local clock (for example, a local crystal oscillator or a voltage controlled oscillator (VCO)). In an example, sensing transmitter 504-1 may increment TSF timer 545-1 and the local timing information associated with one or more of plurality of sensing receivers 502-(1-M) according to its VCO.

In an implementation, a synchronization flag associated with sensing receiver 502-1 may be set by sensing transmitter 504-1 to indicate that sensing transmitter 504-1 has valid local timing information or a valid timer offset value associated with sensing receiver 502-1. In examples, sensing receiver 502-1 may set a synchronization flag associated with sensing transmitter 504-1 when sensing transmitter 504-1 sends a first SENS-CTS-to-Self frame, which in examples indicates that sensing transmitter 504-1 has valid local timing information or a valid timer offset value associated with sensing receiver 502-1. In some examples, sensing receiver 502-1 may set a synchronization flag associated with sensing transmitter 504-1 when sensing transmitter 504-1 responds to a sensing polling trigger frame with a CTS-to-self frame, which in examples indicates that sensing transmitter 504-1 has valid local timing information or a valid timer offset value associated with sensing receiver 502-1. In examples, upon setting the synchronization flag, sensing transmitter 504-1 may start resynchronization timer 525-1 associated with sensing receiver 502-1. In examples, resynchronization timer 525-1 associated with sensing receiver 502-1 may indicate to sensing transmitter 504-1 when a resynchronization task for sensing receiver 502-1 is required. A resynchronization task for sensing receiver 502-1 may involve sending a portion or all of TSF timer to sensing receiver 502-1.

According to an implementation, upon completion of the process of initial synchronization with sensing receiver 502-1 and considering a scenario where sensing transmitter 504-1 is not associated with any other sensing receivers 502-(2-M), sensing transmitter 504-1 may tune to a channel on which the beacon frame was received from sensing receiver 502-1 for further communications (for example, pre-association security negotiation (PASN) or sensing measurement exchanges). In example, sensing transmitter 504-1 may using local timing information associated with sensing receiver 502-1 to determine when to power up the receiver circuitry of sensing transmitter 504-1 and receive transmissions from sensing receiver 502-1, for example to minimize unnecessary time spent with receiver circuitry powered on, which may for example consume battery power.

In some scenarios, sensing transmitter 504-1 may be associated with another sensing receiver 502-2 operating on the same channel on which the beacon frame was received from sensing receiver 502-1. Further, in some scenarios, sensing transmitter 504-1 may be associated with one of plurality of sensing receivers 502-(1-M) operating on a different channel than the channel on which the beacon frame was received from sensing receiver 502-1.

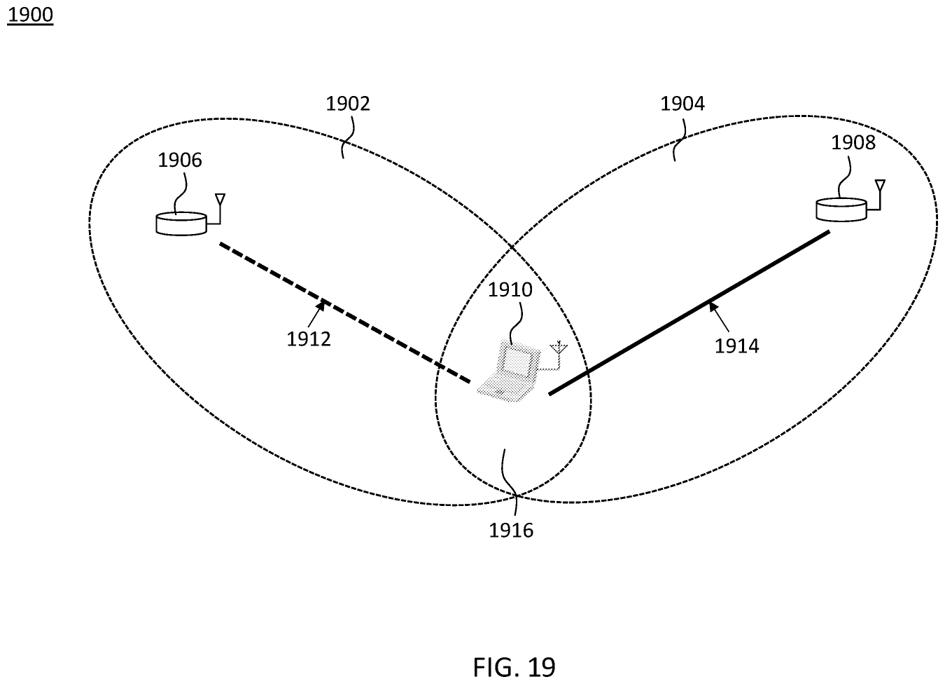

FIG. 19 depicts example 1900 of communications between a STA 1910 (which is an example of sensing transmitter 504-1, and hereinafter referred to as sensing transmitter 1910), an associated access point 1908 (which is an example of sensing receiver 502-2, and hereinafter referred to as sensing receiver 1908) of BSS 1904, and an unassociated access point 1906 (which is an example of sensing receiver 502-1, and hereinafter referred to as sensing receiver 1906) of BSS 1902, according to some embodiments. In an example, sensing transmitter 1910 and sensing receiver 1906 may be in different BSSs, and sensing transmitter 1910 and sensing receiver 1908 may be in a same BSS. In examples, sensing receiver 1906 and sensing transmitter 1910 may participate in sensing measurement exchange 1912. Also, the sensing receiver 1908 and sensing transmitter 1910 may have communication link 1914 (also referred to as associated communication channel) established therebetween. In an implementation, communication between sensing receiver 1906 and sensing transmitter 1910, and communication between sensing receiver 1908 and sensing transmitter 1910 may occur on frequency channel “f₁” and there may be coverage overlapping area 1916 between the sensing receiver 1906 and sensing transmitter 1910. In an example, the channel of sensing receiver 1908 is the same as the channel of a beacon frame of sensing receiver 1906. According to an implementation, sensing transmitter 1910 may receive a beacon frame of sensing receiver 1906 on the same channel as a beacon frame of sensing receiver 1908, e.g., “f₁” and may stay tuned to the channel for further communications from sensing receiver 1906 (e.g., PASN or sensing measurement exchanges). In some implementations, communication between sensing receiver 1906 and sensing transmitter 1910 may occur on frequency channel “f₁”, and communication between sensing receiver 1908 and sensing transmitter 1910 may occur on a different frequency channel (for example, “f₂”). In an example, the channel of sensing receiver 1908 may be different than the channel of the beacon frame of sensing receiver 1906.

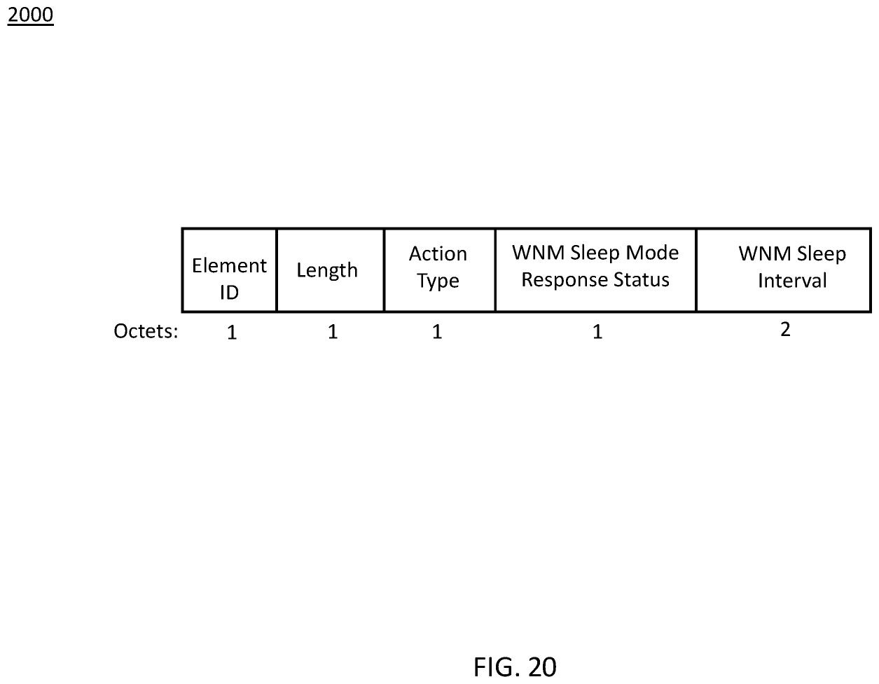

According to an implementation, to enable sensing transmitter 1910 to receive a transmission from sensing receiver 1906 on the channel of sensing receiver 1906 and stay tuned to the channel of sensing receiver 1906 for further communications (e.g., PASN or sensing measurement exchanges), sensing transmitter 1910 may indicate to sensing receiver 1908 that it is entering into a sleep mode. In examples, if sensing transmitter 1910 implements Wireless Network Management (WNM) capabilities, then sensing transmitter 1910 may use a WNM Sleep Mode element. Example format 2000 of the WNM Sleep Mode element is depicted in FIG. 20. In an example, the Action type field of the WNM Sleep Mode element may be used to identify the type of WNM sleep mode request and response. For example, an Action Type value of 0 indicates that sensing transmitter 1910 is entering WNM sleep mode, and an Action Type value of 1 indicates that sensing transmitter 1910 is exiting WNM sleep mode.

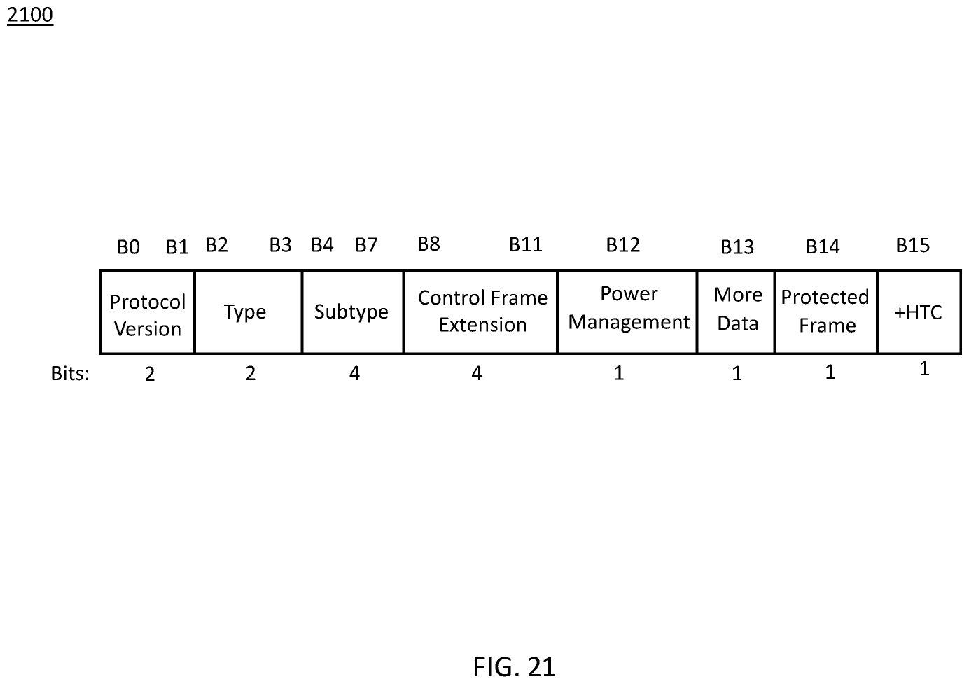

In examples, sensing transmitter 1910 may use a Power Save (PS) mode, where sensing transmitter 1910 enters into a “Doze” state in which sensing transmitter 1910 is not able to transmit or receive PPDUs. When sensing transmitter 1910 changes power management mode, then sensing transmitter 1910 may inform sensing receiver 1908 about this using a Power Management subfield within a Frame Control field of transmitted frames. FIG. 21 depicts format 2100 of a Frame Control field with Power Management bit, according to some embodiments. In an example, sensing transmitter 1910 may remain in its current power management mode until it informs sensing receiver 1908 of a power management mode change via a frame exchange sequence that includes an acknowledgement from sensing receiver 1908. In an example, the Power Management subfield may be same for all MPDUs in an A-MPDU. In examples, sensing receiver 1908 may buffer data for sensing transmitter 1910 when sensing transmitter 1910 is in PS mode.

In an implementation, a mechanism to enable sensing transmitter 1910 to periodically move to a PS mode may be provided at an application layer, for example, by sensing algorithm 538-1. Further, in examples, a mechanism to enable sensing transmitter 1910 to periodically move to the PS mode may be provided by at a MAC layer, for example by sensing agent 536-1. In an example, the mechanism may be sent to sensing transmitter 1910 by the relevant station management entity (SME) of sensing receiver 1908 in advance, for example upon association. In examples, sensing transmitter 1910 may periodically move to the PS mode using the same or similar mechanisms already specified in IEEE 802.11 standards to provide the same or similar functionality. In an implementation, when sensing transmitter 1910 in the PS mode with sensing receiver 1908, sensing transmitter 1910 may tune its receiver to the channel of the beacon frame of sensing receiver 1906 to receive a transmission from sensing receiver 1906.

For ease of explanation and understanding, the description provided is in the context of sensing transmitter 504-1 with sensing receiver 502-1, however sensing transmitter 504-1 may interact with remaining sensing receivers 502-(2-M), with no loss of generality. According to some embodiments, one or more of channels of plurality of sensing receivers 502-(1-M) may be different from the channel of the beacon frame of sensing receiver 502-1. In examples, remaining sensing transmitters 504-(2-N) may also be in interaction with sensing receiver 502-1.

Referring back to FIG. 5, in an implementation, sensing transmitter 504-1 may receive a transmission request from sensing receiver 502-1. In an example, the transmission request may include a timing information update. In an example, the timing information update may include a Partial TSF of sensing receiver 502-1. In an implementation, upon receiving the transmission request, sensing transmitter 504-1 may tune a receiver of sensing transmitter 504-1 to a channel of sensing receiver 502-1. Further, sensing transmitter 504-1 may engage the receiver to receive the transmission request according to the local timing information.

According to an implementation, sensing transmitter 504-1 may update the local timing information according to the timing information update. In an implementation, sensing transmitter 504-1 may transmit a transmission response responsive to the transmission request to sensing receiver 502-1. In an example, the transmission response may include the timestamp (which is the same timestamp generated by timestamp generation block 544-1) based on updated local timing information.

In an implementation, when resynchronization timer 546-1 associated with sensing receiver 502-1 expires, sensing agent 536-1 or sensing algorithm 538-1 may clear a synchronization flag associated with sensing receiver 502-1. In some implementations, sensing transmitter 504-1 may resynchronize local timing information associated with sensing receiver 502-1 after expiration of resynchronization timer 546-1 associated with sensing receiver 502-1, or when synchronization flag associated with sensing receiver 502-1 is cleared. In examples, a time interval of resynchronization timer 546-1 may be determined according to a measurement of timing drift between TSF timer 524-1 of sensing receiver 502-1 and TSF timer 545-1 of sensing transmitter 504-1.

According to an example, the transmission request may include a sensing measurement setup request frame and the transmission response may include a sensing measurement setup response frame. In an example, sensing receiver 502-1 may send the transmission request including the sensing measurement setup request frame to request a sensing measurement setup with sensing transmitter 504-1. The format of the sensing measurement setup request frame is shown in FIG. 7A. The measurement setup ID field in the sensing measurement setup request frame may indicate a measurement setup ID that identifies assigned parameters in the sensing measurement parameters element to be used in the corresponding sensing measurement instances. The format of the sensing measurement parameters element is shown in FIG. 7B. Further, the format of the sensing measurement parameters field is shown in FIG. 7C. In examples, the sensing measurement report subfield and measurement report type subfield may be reserved as sensing transmitter 504-1 may not make sensing measurements or transmit sensing measurement reports.

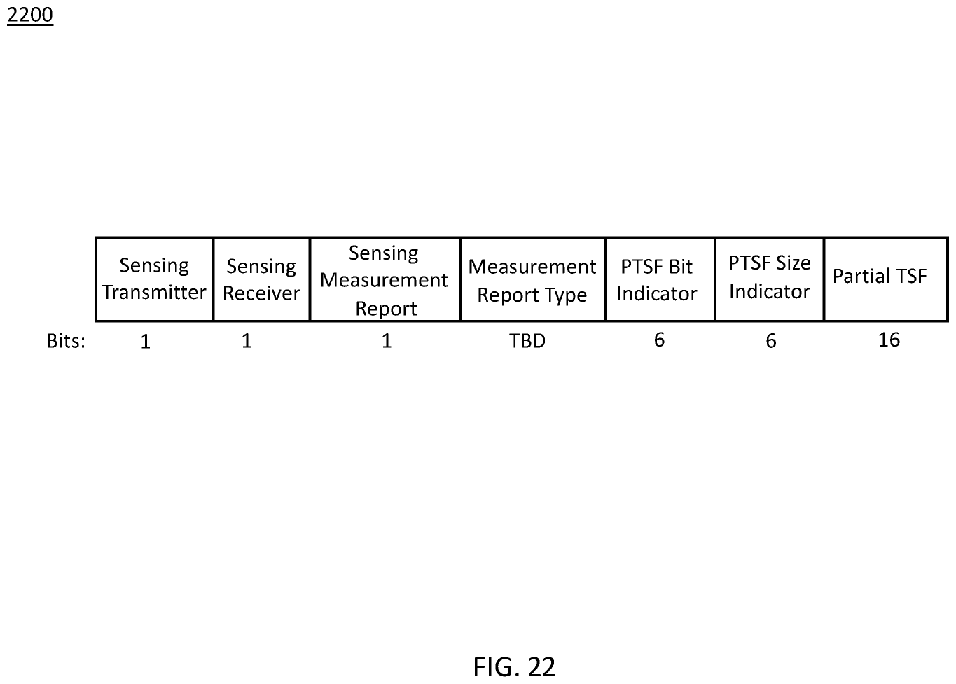

In an implementation, sensing transmitter 504-1 may be addressed in the sensing management setup request frame using AID/RSID of sensing transmitter 504-1 or MAC address of sensing transmitter 504-1, which may be included for example as part of the sensing measurement parameters element of the sensing measurement setup request frame. In an implementation, sensing receiver 502-1 may include the Partial TSF in the sensing measurement parameters field of the sensing measurement parameters element in the sensing measurement setup request frame. FIG. 22 depicts format 2200 of sensing measurement parameters fields with Partial TSF fields, according to some embodiments. In examples, a field (PTSF bit indicator field) is included in the sensing measurement parameters. The PTSF bit indicator field may be used to indicate which 16 bits of TSF timer 524-1 are included in the 16 bit Partial TSF. For example, the PTSF bit indicator field may be at least 6 bits, allowing the representation of a number between 0 and 47 (some values are not used). The number expressed by the PTSF bit indicator field may be used to represent the bit position of the lowest bit of the 16 bit Partial TSF. For example, if the PTSF Bit indicator field value is 6, then the Partial TSF starts at bit 6 of TSF timer 524-1. In examples, if the Partial TSF is 16 bits long, then bits 6:21 of TSF timer 524-1 are included as the Partial TSF.

Further, in examples, a field (PTSF size indicator field) is included in the sensing measurement parameters. The PTSF size indicator field may be used to indicate the number of bits of TSF timer 524-1 that are included in the Partial TSF field. For example, the PTSF size indicator field may be at least 6 bits, allowing the representation of a number between 0 and 63. As TSF timer 524-1 is 64 bits, the PTSF size indicator field can indicate any range of TSF timer 524-1. In some examples, combinations of the Partial TSF field, the PTSF bit indicator field, and PTSF size indicator field may be included in the sensing measurement parameters.

As described earlier, according to an implementation, in response to receiving the transmission request including the sensing measurement setup request frame from sensing receiver 502-1, sensing transmitter 504-1 may transmit the transmission response including the sensing measurement setup response frame to sensing receiver 502-1. The format of the sensing measurement setup response frame is depicted in FIG. 7D.

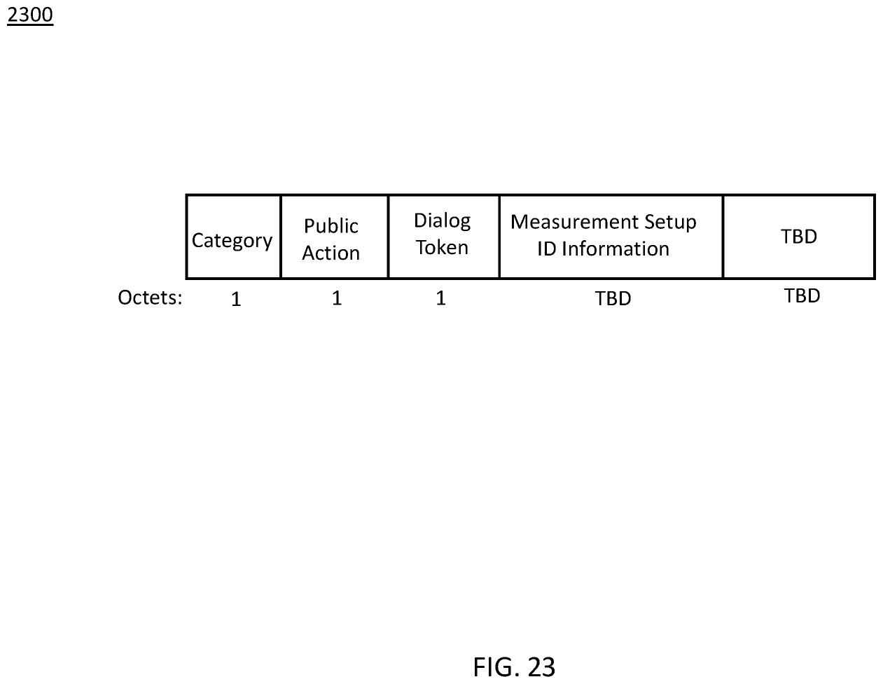

In an implementation, the sensing measurement setup may continue until terminated by a sensing measurement setup termination frame. In an implementation, sensing receiver 502-1 may send the sensing measurement setup termination frame to sensing transmitter 504-1 to terminate the sensing measurement setup. FIG. 23 depicts format 2300 of the sensing measurement setup termination frame action field, according to some embodiments. FIG. 23 is a reproduction of Figure 9-1139e of IEEE P802.11bf/D0.1. According to an implementation, sensing transmitter 504-1 may acknowledge the sensing measurement setup termination frame and exit the sensing measurement setup with sensing receiver 502-1.

According to an implementation, prior to receiving the transmission request or prior to the sensing measurement setup between sensing transmitter 504-1 and sensing receiver 502-1, sensing transmitter 504-1 may engage in a PASN procedure with sensing receiver 502-1. In examples, this establishes security keys necessary for sensing transmitter 504-1 to receive and decode messages in the sensing measurement setup, as well as for sensing transmitter 504-1 to encode and send messages in the sensing measurement setup. The PASN procedure is explained in Section 12.12 of Draft P802.11az_D4.1. In an implementation, sensing receiver 502-1 may indicate that it is capable of performing PASN authentication by including an indication in a beacon frame or a probe response (which are the same beacon frame and probe response from which sensing transmitter 504-1 obtains TSF timer 524-1 of sensing receiver 502-1).

In some embodiments, the beacon frame or the probe response may be sent without a PASN procedure if there are no following sensing measurement exchanges. In examples, the beacon frame or the probe response may be a part of the PASN procedure, and the PASN procedure may complete the authentication and negotiate security keys which allows sensing transmitter 504-1 to receive transmissions from sensing receiver 502-1. In examples, after sensing transmitter 504-1 obtains the TSF timer 524-1 from the beacon frame or the probe response from sensing receiver 502-1, sensing transmitter 504-1 may initiate and complete the PASN procedure. Once the PASN procedure has been completed, sensing transmitter 504-1 and sensing receiver 502-1 may participate in a sensing measurement exchange.

According to some examples, the transmission request may include a sensing polling trigger frame and the transmission response may include a CTS-to-self frame. In an example, sensing receiver 502-1 may send the transmission request including the sensing polling trigger frame to sensing transmitter 504-1. In examples, once the sensing measurement setup is established between sensing transmitter 504-1 and sensing receiver 502-1, multiple sensing measurement instances may take place. A sensing measurement instance is a time interval when sensing measurements are obtained, for example via a trigger-based (TB) sensing measurement instance where sensing receiver 502-1 is the sensing initiator. In examples, the TB sensing measurement instance includes one or more of the following phases: polling phase, NDPA sounding phase, trigger frame (TF) sounding phase, and reporting phase. Examples of TB sensing measurement instances are shown in FIG. 10A and FIG. 10B. The TB sensing measurement instance (example 2) of FIG. 10A is shown in an expanded form in FIG. 11A and FIG. 11B.

In an implementation, in the polling phase, sensing receiver 502-1 may send the sensing polling trigger frame to sensing transmitter 504-1 that is assigned to be polled in the TB sensing measurement instance and expected to participate during the availability period, and the polling phase is the first exchange in all TB sensing measurement instances for the sensing measurement setup. In examples, sensing transmitter 504-1 may be addressed by a User Info field in the sensing polling trigger frame. The sensing polling trigger frame may be a control frame on MAC layer. In examples, the sensing polling trigger frame may have a format as illustrated in FIG. 15A. The format of the Common Info field of the sensing polling trigger frame is also described in FIG. 15A. The Trigger Type subfield (B0 . . . B3) of the Common Info field identifies the Trigger frame variant and its encoding is defined in Table 1 in addition to a new Trigger Type subfield value for the sensing polling trigger frame.

TABLE 1
New Trigger type subfield of the Common Info field

| Trigger Type subfield value | Trigger frame variant |
|---|---|
| 0 | Basic |
| 1 | Beamforming Report Poll (BFRP) |
| 2 | MU-BAR |
| 3 | MU-RTS |
| 4 | Buffer Status Report Poll (BSRP) |
| 5 | GCR MU-BAR |
| 6 | Bandwidth Query Report Poll (BQRP) |
| 7 | NDP Feedback Report Poll (NRFP) |
| 8 | Ranging |
| 9 | Sensing Poll |
| 10-15 | Reserved |

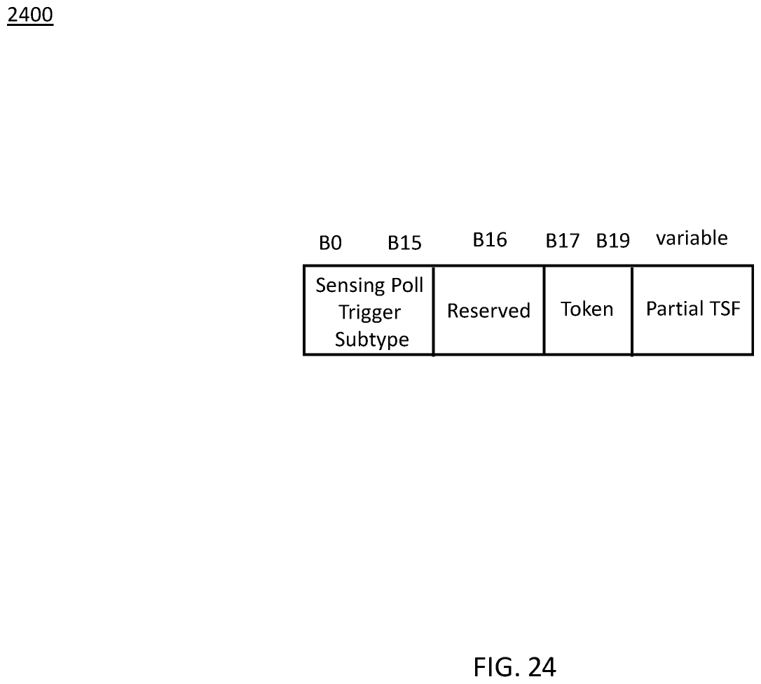

FIG. 24 depicts format 2400 of the Trigger Dependent Common Info subfield of the Common Info field within the sensing polling trigger frame, according to some embodiments. FIG. 24 is a reproduction of Figure 9-64la from Draft P802.11az_D4.1. In examples, potential values of the sensing poll trigger Subtype subfield in the Trigger Dependent Common Info subfield of the Common Info field within the sensing polling trigger frame are defined in Table 2 provided below.

TABLE 2
Sensing Polling Trigger Subtype subfield values

| Sensing Poll Trigger | |
|---|---|
| subfield value | Sensing Poll Trigger frame subvariant |
| Bits 0-7 | Number of bits included in the Partial TSF |
| Bits 8-13 | Bit position of LSB of the Partial TSF |
| Bits 14-15 | Reserved |

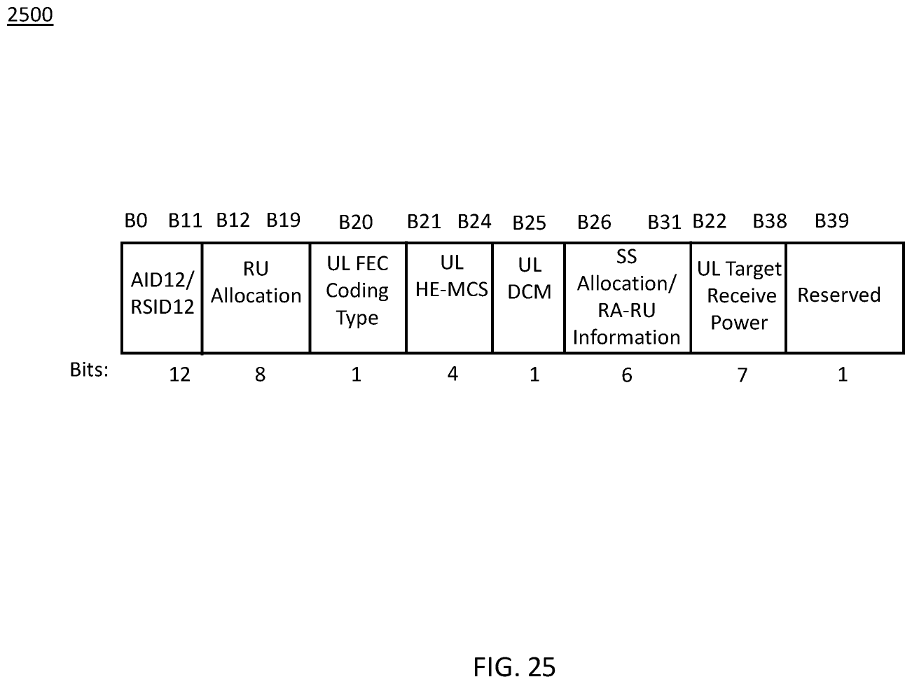

In an implementation, sensing receiver 502-1 may assign an RU allocation to sensing transmitter 504-1 in the User Info List of the sensing polling trigger frame. FIG. 25 depicts example 2500 of User Info field format for sensing polling trigger frame, according to some embodiments. FIG. 25 is a reproduction of Figure 9-64lc from Draft P802.11az_D4.1.

According to an implementation, in response to receiving the sensing polling trigger frame, sensing transmitter 504-1 may request to participate in the TB sensing measurement instance by responding with a CTS-to-self frame in its designated RU allocation.

According to some examples, the transmission request may include a sensing sounding trigger frame and the transmission response may include a sensing transmission. In an example, sensing receiver 502-1 may send the transmission request including the sensing sounding trigger frame to sensing transmitter 504-1. In examples, in the TF sounding phase, sensing receiver 502-1 may solicit a sensing transmission (which is an NDP transmission) from sensing transmitter 504-1 that responded with the CTS-to-self frame. In an implementation, sensing receive 502-1 may transmit a sensing sounding trigger frame to sensing transmitter 504-1 to solicit a Responder-to-Initiator (R2I) NDP transmission. In an example, the sensing sounding trigger frame may allocate uplink resources for sensing transmitter 504-1 to transmit the sensing transmission. In examples, sensing transmitter 504-1 may be addressed by a User Info field in the sensing sounding trigger frame. The sensing sounding trigger frame is a control frame on MAC layer. In examples, the sensing sounding trigger frame may have a format as illustrated in FIG. 15A. The format of the Common Info field of the sensing sounding trigger frame is also illustrated in FIG. 15.

The Trigger Type subfield of the Common Info field in the sensing sounding trigger frame identifies the Trigger frame variant and its encoding may be defined as shown in Table 3 (which includes a combination of Table 9-46 of Draft P802.11REVme_D1.1 and Table 9-30c from Draft P802.11az_D4.1) in addition to a new Trigger Type subfield value for the sensing sounding trigger frame.

TABLE 3
New Trigger type subfield of the Common Info field

| Trigger Type subfield value | Trigger frame variant |
|---|---|
| 0 | Basic |
| 1 | Beamforming Report Poll (BFRP) |
| 2 | MU-BAR |
| 3 | MU-RTS |
| 4 | Buffer Status Report Poll (BSRP) |
| 5 | GCR MU-BAR |
| 6 | Bandwidth Query Report Poll (BQRP) |
| 7 | NDP Feedback Report Poll (NRFP) |
| 8 | Ranging |
| 9 | Sensing Sounding |
| 10-15 | Reserved |

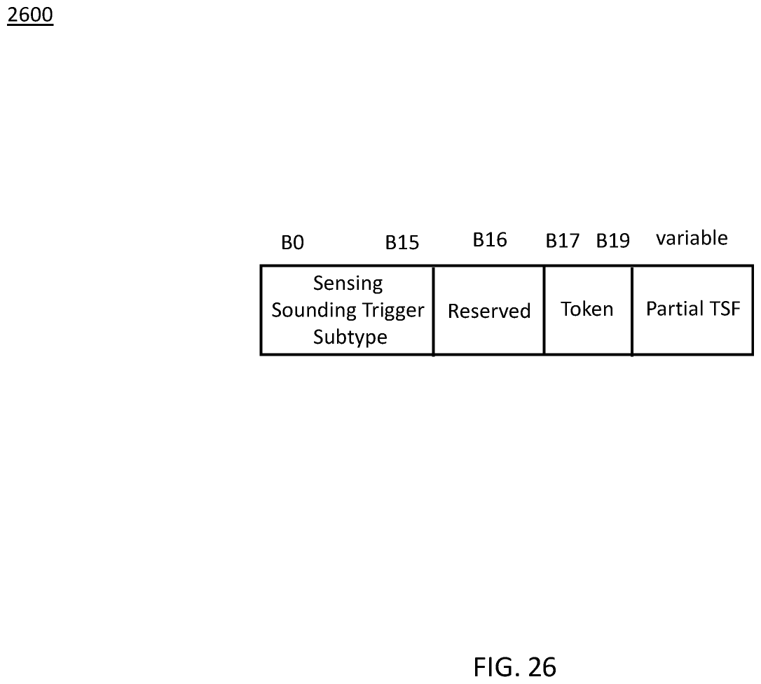

FIG. 26 depicts format 2600 of the Trigger Dependent Common Info subfield of the Common Info field within the sensing sounding trigger frame, according to some embodiments. FIG. 26 is a reproduction of Figure 9-64la from Draft P802.11az_D4.1. In examples, potential values of the sensing sounding trigger Subtype subfield in the Trigger Dependent Common Info subfield of the Common Info field within the sensing sounding trigger frame are defined in Table 4 provided below.

TABLE 4
Sensing Sounding Trigger Subtype subfield values

| Sensing Sounding | |
|---|---|
| Trigger Subtype | |
| subfield value | Sensing Sounding Trigger frame subvariant |
| Bits 0-7 | Number of bits included in the Partial TSF |
| Bits 8-13 | Bit position of LSB of the Partial TSF |
| Bits 14-15 | Reserved |

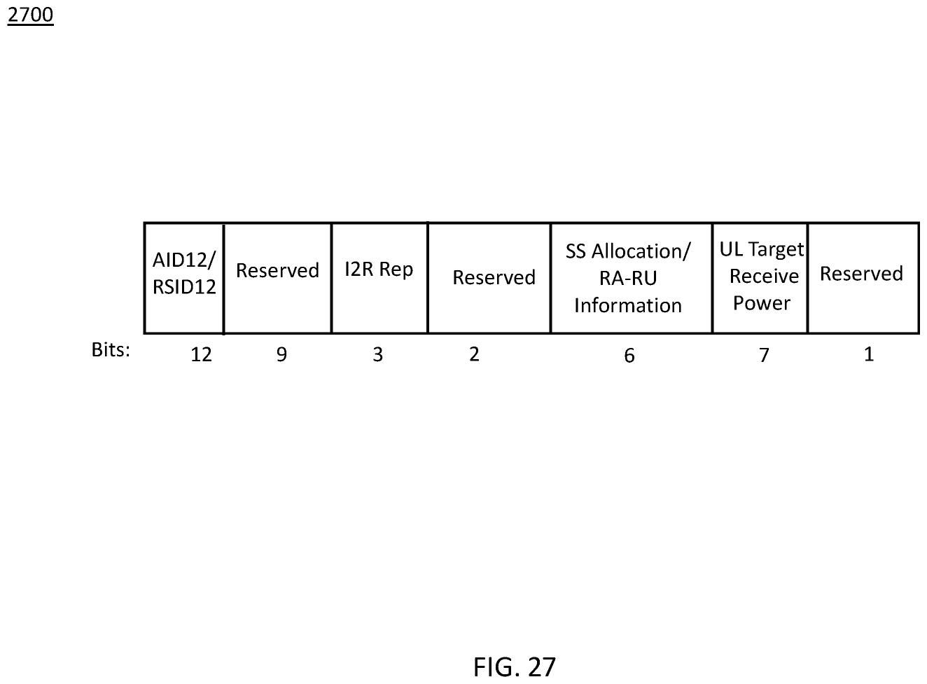

In an implementation, sensing receiver 502-1 may assign an RU allocation to sensing transmitter 504-1 for the sensing transmission in the User Info List of the sensing sounding trigger frame. FIG. 27 depicts example 2700 of User Info field format for the sensing sounding trigger frame, according to some embodiments. FIG. 27 is a reproduction of Figure 9-64ld from Draft P802.11az_D4.1.

According to an implementation, sensing transmitter 504-1 may use the Partial TSF received in the sensing sounding trigger frame to update the local timing information and the timer offset value.

In examples, a general sensing trigger frame may be defined, and subtypes are defined for sensing polling and sensing sounding. The sensing trigger frame may have a format as illustrated in FIG. 15A. The format of the Common Info field of the sensing trigger frame is also illustrated in FIG. 15A. As described above, the Trigger Type subfield of the Common Info field in the trigger frame identifies the Trigger frame variant. An example of its encoding for the general sensing trigger frame variant is shown in Table 5 (which includes a combination of Table 9-46 of Draft P802.11REVme_D1.1 and Table 9-30c from Draft P802.11az_D4.1) in addition to a new Trigger Type subfield value for the sensing trigger frame.

TABLE 5
New Sensing Trigger type subfield of the Common Info field

| Trigger Type subfield value | Trigger frame variant |
|---|---|
| 0 | Basic |
| 1 | Beamforming Report Poll (BFRP) |
| 2 | MU-BAR |
| 3 | MU-RTS |
| 4 | Buffer Status Report Poll (BSRP) |
| 5 | GCR MU-BAR |
| 6 | Bandwidth Query Report Poll (BQRP) |
| 7 | NDP Feedback Report Poll (NRFP) |
| 8 | Ranging |
| 9 | Sensing |
| 10-15 | Reserved |

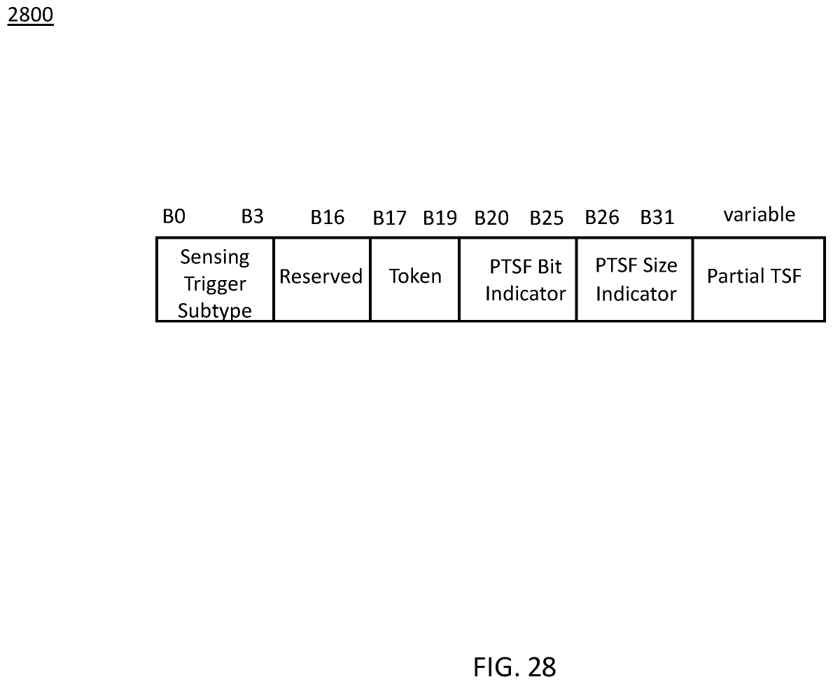

The format of the Trigger Dependent Common Info subfield of the Common Info field may be added to the Trigger Dependent Common Info subfield to carry the Partial TSF and information describing the Partial TSF, as described by the sensing polling trigger frame. An adapted Trigger Dependent Common Info Subfield of this example is shown in FIG. 28. In particular, FIG. 28 depicts example 2800 of Sensing Trigger Dependent Common Info subfield, according to some embodiments. FIG. 28 is a modification of Figure 9-64la from Draft P802.11az_D4.1.

In examples, potential values of the Sensing Poll Trigger Subtype subfield in the Trigger Dependent Common Info subfield of the Common Info field within the sensing trigger frame are defined in Table 6 provided below.

TABLE 6
Sensing Trigger Subtype subfield values

| Sensing Trigger subfield value | Sensing Trigger frame subvariant |
|---|---|
| 0 | Poll |
| 1 | Sounding |
| Bits 2-3 | Reserved |

Referring back to FIG. 5, in an implementation, when sensing transmitter 504-1 receives the beacon frame or the probe response from sensing receiver 502-1 including TSF timer 524-1, sensing transmitter 504-1 may set its local timing information (local version of TSF timer 524-1) to the received TSF timer 524-1 or may calculate a timer offset value as the difference between TSF timer 524-1 and TSF timer 545-1. In an example, the received TSF timer 524-1 may include the full 8-octet TSF value. In examples, a time offset between TSF timer 524-1 and TSF timer 545-1 may be referred to as ΔClock. In an implementation, sensing transmitter 504-1 may increment TSF timer 524-1 and TSF timer 545-1 with each system timing unit (abbreviated to TU), however, the clock at sensing receiver 502-1 and the clock at sensing transmitter 504-1 may have different clock drifts (within an allowable tolerance), such that the TU for TSF timer 524-1 and the TU for TSF timer 545-1 may be slightly different, resulting in drift between the local timing information (local version of TSF timer 524-1) and TSF timer 545-1. However, this drift is not captured in ΔClock.

In examples, assuming that T0 is TSF timer 524-1 when the beacon frame (or the probe response) is broadcast, while T0′ is TSF timer 545-1 when the beacon frame (or the probe response) from sensing receiver 502-1 is received at sensing transmitter 504-1. In an example, a timer offset (T_{offset}) may be defined as the difference between TSF timer 524-1 received in the beacon frame or the probe response and TSF timer 545-1 when sensing transmitter 504-1 receives the beacon frame or the probe response. In examples, let T_{flight} represent the time of flight which is the transmission time from sensing receiver 502-1 to sensing transmitter 504-1, and let T_{proc} represent the sensing transmitter 504-1 processing time, which is time between when a signal is received by sensing transmitter 504-1 and when the signal is processed by sensing transmitter 504-1 for a frame. The timer offset (T_{offset}) between TSF timer 524-1 and TSF timer 545-1 may be mathematically represented as:

$${T}_{offset} = T {0}^{′} - T 0 = Δ Clock + {T}_{flight} + {T}_{proc} \qquad ( 9 )$$

In examples, adjusted TSF timer 545-1 (aligned to TSF timer 524-1, also referred to as adjusted OBSS STA TSF timer) may be calculated as follows:

$$Adjusted OBSS STA TSF Timer = OBSS STA TSF Timer - {T}_{offset} \qquad ( 10 )$$

where, adjusted OBSS STA TSF Timer is an example of adjusted TSF timer 545-1 of sensing transmitter 504-1 and OBSS STA TSF Timer is an example of TSF timer 545-1 of sensing transmitter 504-1.

In an example, the timer offset value may be stored at sensing transmitter 504-1. In examples, the size of the timer offset may vary up to 64 bits (which is the size of the TSF timer 524-1). In examples, the timer offset may be stored as an 8 bit value, a 16 bit value, a 24 bit value, a 32 bit value, a 40 bit value, a 48 bit value, or a 56 bit value.

In examples, local timing information (a local version of TSF timer 524-1) may be stored at sensing transmitter 504-1. In an example, two methods of representing the local timing information in 64 bits are shown in Table 7 and Table 8 provided below. Table 7 divides the lower two octets into three parts-bits 0 to 5, bits 6 to 21, and bits 22 to 31. A partial TSF utilizing bits 6-21 ([21:6] in notation) is standardized in IEEE 802.11 as a Partial TSF field. For ease of representation, local timing information, also referred to as OBSS STA-AP TSF timer is abbreviated to OSA-TSF in Tables 7 and 8.

TABLE 7
First example representation of an OBSS STA-AP TSF Timer

| Bits | [63:48] | [47:32] | [31:22] | [21:6] | [5:0] |
|---|---|---|---|---|---|
| | OSA-TSF | OSA-TSF | OSA-TSF | OSA-TSF | OSA-TSF |
| | [63:48] | [47:32] | [31:22] | [21:6] | [5:0] |

TABLE 8
Second example representation of an OBSS STA-AP TSF Timer

| | | | | |
|---|---|---|---|---|
| Bits | [63:48] | [47:32] | [31:16] | [15:0] |

| | | | |
|---|---|---|---|
| OSA-TSF | OSA-TSF | OSA-TSF | OSA-TSF |
| [63:48] | [47:32] | [31:16] | [15:0] |

In an implementation, plurality of sensing transmitters 504-(1-N) may maintain the local timing information or the timer offset value. In example, plurality of sensing transmitters 504-(1-N) may time their retuning and sensing transmissions based on the local timing information or adjusted TSF timers 545-(1-N). In an example, OBSS STA-AP TSF timers (local timing information) or adjusted TSF timers 545-(1-N) maintained by plurality of sensing transmitters 504-(1-N) are the same within a tolerance, which for example allows sensing receiver 502-1 to combine sensing transmissions from plurality of sensing transmitters 504-(1-N).

In an example, after the initial synchronization of the local timing information with TSF timer 524-1 by the beacon frame or the probe response, or the initial calculation of the timer offset value, there may be a time drift of the local timing information or adjusted TSF timer 545-1 due to the difference in the oscillator of sensing receiver 502-1 and the oscillator of sensing transmitter 504-1. In examples, this may result in inaccuracy in the timing of retuning of sensing transmitter 504-1 when sensing transmitter 504-1 expects to receive its sensing triggers, and in the timing of sensing transmission of sensing transmitter 504-1. In an example, the time drift of the oscillator of sensing transmitter 504-1 may be around +/−100 parts per million (ppm), or +/−100 ppm, and the time drift of the oscillator of sensing receiver 502-1 may also be around +/−100 ppm. In some examples, the difference between the time drift of the oscillator of sensing transmitter 504-1 and the oscillator of sensing receiver 502-1 may be up to +/−200 ppm. In examples, because of the time drift, the local timing information may need to be periodically resynchronized with TSF timer 524-1. In some examples, the timer offset value needs to be recalculated.

In examples, the resynchronization of the local timing information with TSF timer 524-1 may be achieved using the Partial TSF. In examples, the Partial TSF subfield includes 16 bits of TSF timer 524-1. In an example, the Partial TSF carries bits [21:6] of TSF timer 524-1. Other 16 bit ranges of TSF timer 524-1 may be carried in the Partial TSF. In an example, if there was no time drift between the oscillator of sensing receiver 502-1 and the oscillator of sensing transmitter 504-1, then the bits of the Partial TSF should be equal to same bit range of the local timing information. However, as previously described, the oscillator of sensing receiver 502-1 and the oscillator of sensing transmitter 504-1 may drift with respect to each other.

In examples, when sensing receiver 502-1 determines that a resynchronization task for plurality of sensing transmitters 504-(1-N) should be run, then sensing receiver 502-1 may send a Partial TSF using one of the methods previously described. In examples, the size of the Partial TSF (i.e., the number of bits) or the selection of TSF timer 524-1 that are used in the Partial TSF (i.e., which bits of TSF timer 524-1 are included in the Partial TSF may be preconfigured). For example, the size of the Partial TSF may be signaled to sensing transmitter 504-1 using the PTSF Size Indicator, as previously described. In examples, the Partial TSF may be greater than 16 bits in length. In some examples, the Partial TSF may extract different portions of the 64 bits of TSF timer 524-1. In an example, the Partial TSF may represent a windowed version of TSF timer 524-1. In examples, the bits of TSF timer 524-1 to include in the Partial TSF are indicated by a combination of the PTSF Size Indicator and the PTSF Bit Indicator as previously described.

Further, in examples, sensing transmitter 504-1 may overwrite the equivalent bits of the local timing information with the received Partial TSF. For example, the received Partial TSF including bits [21:6] of TSF timer 524-1 overwrites bits [21:6] of the local timing information, thereby resynchronizing the local timing information to TSF timer 524-1, to the resolution of the lowest bit of the Partial TSF. The windowed bit range of TSF timer 524-1 that is captured in the Partial TSF will determine the maximum accuracy of the time synchronization between the local timing information and TSF timer 524-1, as well as a minimum resynchronization time.

In an example, where the Partial TSF includes bits [21:6], the Partial TSF field is used to update the timer offset at sensing transmitter 504-1. In an example, the timer offset may be updated based on Equation (11) provided below.

$${T}_{offset} ( updated ) = {T}_{offset} + [ Adjusted OBSS STA TSF Timer [ 21 : 6 ] - Partial TSF [ 21 : 6 ] ] \qquad ( 11 )$$

In examples, sensing receiver 502-1 may determine that a resynchronization task for sensing transmitter 504-1 should be run if a resynchronization timer (such as resynchronization timer 525-1 associated with sensing transmitter 504-1) reaches a certain value (if resynchronization timer 525-1 associated with sensing transmitter 504-1 counts up from zero) or reaches zero (if resynchronization timer 525-1 associated with sensing transmitter 504-1 counts down from a certain value). In examples, if resynchronization timer 546-1 for sensing receiver 502-1 in sensing transmitter 504-1 expires, then sensing transmitter 504-1 may not send any sensing transmissions to sensing receiver 502-1 until sensing transmitter 504-1 is able to resynchronize the local timing information or recalculate the timer offset value, for example until sensing transmitter 504-1 receives a Partial TSF or until sensing transmitter 504-1 receives a full TSF timer 524-1, via a beacon frame or a probe response frame.

In an example, when resynchronization timer 546-1 for sensing receiver 502-1 in sensing transmitter 504-1 expires, sensing transmitter 504-1 may clear the synchronization flag for sensing receiver 502-1. In examples, sensing transmitter 504-1 may not send any sensing transmissions to sensing receiver 502-1 when the synchronization flag is not set, that is when the synchronization flag is cleared. In examples, when sensing transmitter 504-1 resynchronizes the local timing information or recalculates the timer offset value (for example when sensing transmitter 504-1 receives and implements the Partial TSF field, or when sensing transmitter 504-1 receives a full TSF timer 524-1, via a beacon frame or a probe response), then sensing transmitter 504-1 may set the synchronization flag for sensing receiver 502-1.

In examples, when resynchronization timer 546-1 for sensing receiver 502-1 in sensing transmitter 504-1 is running (indicating that sensing transmitter 504-1 is synchronized with sensing receiver 502-1), or when the synchronization flag for that sensing receiver 502-1 is set, any scheduled event (e.g., a channel change or reception of a sensing trigger frame) that refers to sensing receiver 502-1 uses the local timing information for sensing receiver 502-1 or the adjusted TSF timer 524-1 for sensing receiver 502-1, as a time reference.

In examples, the maximum time period between resynchronization events is calculated by sensing receiver 502-1 based on TSF timer 524-1 drift, which may be bounded by the required precision of the clock reference (e.g., XTAL (crystal oscillator) or VCO) for sensing transmitter 504-1. In examples, both sensing receiver 502-1 and sensing transmitter 504-1 clock references (and therefore TSF timer values) may drift at around +/−100 ppm. In examples, sensing transmitter 504-1 may measure the TSF timer drift (TSF_{drift}) by calculating the timer offset (T_{offset}) for two different beacon frame broadcasts by sensing receiver 502-1, for example at T0 and T1 (resulting in T_{offset-TO} and T_{offset-T1}). In examples, the TSF timer drift (TSF_{drift}) for sensing receiver 502-1 may be determined as follows:

$$T {0}^{′} - T 0 = {T}_{offset - TO} \qquad ( 12 )$$

$$T {1}^{′} - T 1 = {T}_{offset - T 1} \qquad ( 13 )$$

$${TSF}_{drift} = {T}_{offset - T 1} - {T}_{offset - TO} \qquad ( 14 )$$

In examples, the rate of drift may be calculated as follows:

$$\frac{d ( {TSF}_{drift} )}{dt} = \frac{{TSF}_{drift}}{OBSS STA TSF Timer ( T 1 ) - OBSS STA TSF Timer ( T 0 )} \qquad ( 15 )$$

In examples, a synchronization time may expire when TSF_{drift} exceeds a specified threshold.

In an implementation, sensing receiver 502-1 may include a Partial TSF in every sensing polling trigger frame or sensing sounding trigger frame. In examples, sensing transmitter 504-1 may determine when to apply a Partial TSF field received in a sensing polling trigger frame or sensing sounding trigger frame from sensing receiver 502-1 to local timing information for that sensing receiver 502-1. In examples, sensing transmitter 504-1 may determine when to recalculate the timer offset value for sensing receiver 502-1 depending on TSF_{drift} or on the expiration of resynchronization timer 546-1 for sensing receiver 502-1.

In examples, the PTSF Bit Indicator field or the PTSF Size Indicator field may be varied by sensing receiver 502-1 to make updates to the local timing information or to the timer offset value. An example is shown in Table 9 for a 16 bit Partial TSF.

TABLE 9
Signaling of different locations of the Partial TSF (16 bits)

| Location | PTSF Size | PTSF Bit | | |
|---|---|---|---|---|
| of 16 bits | Indicator | Indicator | Wraparound Time (s) | Time Unit (us) |
| [15:0] | 16 | 0 | 0.065535 | 1 |
| [21:6] | 16 | 6 | 4.19 | 64 |
| [25:10] | 16 | 10 | 67 | 1024 |
| [31:16] | 16 | 16 | 4294.9 | 65536 |
| [47:32] | 16 | 32 | 281470681 | 4294967296 |
| [63:48] | 16 | 48 | 18446462598732 | 281474976710656 |

In examples, the greater the precision, the more frequently a resynchronization algorithm may need to be run. The resynchronization algorithm may be adjusted dynamically based on, for example, a measure of channel occupancy of system 500. For example, if system 500 performs sensing between sensing receiver 502-1 and sensing transmitter 504-1 in a scanning mode (which requires a coarse measurement done infrequently), then the period between resynchronization may need to be longer, which may require the Partial TSF to span a different number of bits or to include a different range of bits of the full TSF timer 524-1. In examples, if system 500 performs accurate sensing between sensing receiver 502-1 and sensing transmitter 504-1 in a detection mode (which requires a more precise measurement done more frequently), then the period between resynchronization may need to be shorter, which may require the Partial TSF to span a different number of bits or to include a different range of bits of the full TSF timer 524-1.

Considering an example of a Partial TSF 16 bits [21:6], a wraparound time may be around 4.19 s, resolution time unit may be 2⁶ μs=64 μs, and the accuracy of the local timing information with respect to TSF timer 524-1 may be around 64 μs. In examples, the resolution of the local timing information or the timer offset value may not be larger than the resolution of the Partial TSF field.

A period t of the resynchronization of the local timing information or the timer offset value (given a maximum clock drift of x) may be defined as below:

$$x * t <= 64 μs \qquad ( 16 )$$

$$t <= 64 μs / x \qquad ( 17 )$$

In examples, the maximum x is around +/−100 μs/s, therefore the resynchronization period is defined by:

$$t <= 64 μs / ( 100 μs / s ) = 0.64 s \qquad ( 18 )$$

The period of the resynchronization of x should be less than 0.64 s, which is decided by the bit location of the Partial TSF given for example by the PTSF Bit Indicator field as previously described.

In examples, sensing receiver 502-1 may use the Partial TSF to resynchronize the local timing information, even if the Partial TSF size is less than the 64 bit TSF timer size. This may be achieved by varying the range of the bits of TSF timer 524-1 that are sent in the Partial TSF. In an example, the bit location of the Partial TSF may be configured from the highest 16 bits [63:48] of TSF timer 524-1 to the lowest 16 bits [15:0] of TSF timer 524-1 over four consecutive sensing polling trigger frames or sensing sounding trigger frames. In this manner, the four Partial TSF values could be used to resynchronize the local timing information, by replacing each 16 bit segment of the local timing information with 16 bits in the Partial TSF.

Table 10 illustrates the local timing information prior to full resynchronization using Partial TSF. For ease of representation, local timing information, also referred to as OBSS STA-AP TSF timer is abbreviated to OSA-TSF in Table 10.

TABLE 10
OBSS STA-AP TSF Timer prior to resynchronization

| | | | | |
|---|---|---|---|---|
| Bits | [63:48] | [47:32] | [31:16] | [15:0] |

| | | | |
|---|---|---|---|
| OSA-TSF | OSA-TSF | OSA-TSF | OSA-TSF |
| [63:48] | [47:32] | [31:16] | [15:0] |

In examples, after the first Partial TSF [63:48] is received, the most significant 16 bits of the local timing information are resynchronized as shown in Table 11 provided below. For ease of representation, local timing information, also referred to as OBSS STA-AP TSF timer is abbreviated to OSA-TSF in Table 11.

TABLE 11
OBSS STA-AP TSF Timer after the first Partial TSF

| | | | | |
|---|---|---|---|---|
| Bits | [63:48] | [47:32] | [31:16] | [15:0] |

| | | | |
|---|---|---|---|
| Partial TSF | OSA-TSF | OSA-TSF | OSA-TSF |
| [63:48] | [47:32] | [31:16] | [15:0] |

In examples, after the second Partial TSF [47:32] is received, the next most significant 16 bits [47:32] of the local timing information are resynchronized as shown in Table 12 provided below. For ease of representation, local timing information, also referred to as OBSS STA-AP TSF timer is abbreviated to OSA-TSF in Table 12.

TABLE 12
OBSS STA-AP TSF Timer after the second Partial TSF

| Bits | [63:48] | [47:32] | [31:16] | [15:0] |
|---|---|---|---|---|
| | Partial TSF | OSA- TSF | OSA-TSF | OSA-TSF |
| | [63:48] | [47:32] | [31:16] | [15:0] |
| | Partial TSF | Partial TSF | OSA-TSF | OSA-TSF |
| | [63:48] | [47:32] | [31:16] | [15:0] |

In examples, after the third Partial TSF [31:16] is received, the next most significant 16 bits [31:16] of the local timing information are resynchronized as shown in Table 13 provided below. For ease of representation, local timing information, also referred to as OBSS STA-AP TSF timer is abbreviated to OSA-TSF in Table 13.

TABLE 13
OBSS STA-AP TSF Timer after the third Partial TSF

| Bits | [63:48] | [47:32] | [31:16] | [15:0] |
|---|---|---|---|---|
| | Partial TSF | OSA- TSF | OSA-TSF | OSA-TSF |
| | [63:48] | [47:32] | [31:16] | [15:0] |
| | Partial TSF | Partial TSF | OSA-TSF | OSA-TSF |
| | [63:48] | [47:32] | [31:16] | [15:0] |
| | Partial TSF | Partial TSF | Partial TSF | OSA-TSF |
| | [63:48] | [47:32] | [31:16] | [15:0] |

In examples, after the fourth Partial TSF [15:0] is received, the LSB [15:0] of the local timing information are resynchronized as shown in Table 14 provided below. For ease of representation, local timing information, also referred to as OBSS STA-AP TSF timer is abbreviated to OSA-TSF in Table 14.

TABLE 14
OBSS STA-AP TSF Timer after the fourth Partial TSF

| Bits | [63:48] | [47:32] | [31:16] | [15:0] |
|---|---|---|---|---|
| SENS | Partial TSF | OSA- TSF | OSA-TSF | OSA-TSF |
| NDPA TI | [63:48] | [47:32] | [31:16] | [15:0] |
| SENS | Partial TSF | Partial TSF | OSA-TSF | OSA-TSF |
| NDPA T2 | [63:48] | [47:32] | [31:16] | [15:0] |
| SENS | Partial TSF | Partial TSF | Partial TSF | OSA-TSF |
| NDPA T3 | [63:48] | [47:32] | [31:16] | [15:0] |
| SENS | Partial TSF | Partial TSF | Partial TSF | Partial TSF |
| NDPA T4 | [63:48] | [47:32] | [31:16] | [15:0] |

After the resynchronization using the four Partial TSF as described above, sensing transmitter 504-1 may perform a sensing transmission to sensing receiver 502-1, as at that point the local timing information is fully resynchronized.

FIG. 29 depicts flowchart 2900 for transmitting, by a sensing transmitter, a transmission response responsive to a transmission request received from a sensing receiver, according to some embodiments.

In a brief overview of an implementation of flowchart 2900, at step 2902, networking device operating as a sensing transmitter (for example, sensing transmitter 504-1) may obtain timing information from an unassociated access point (for example, sensing receiver 502-1). At step 2904, networking device operating as the sensing transmitter may generate local timing information according to the timing information. At step 2906, networking device operating as the sensing transmitter may receive a transmission request from the unassociated access point. The transmission request includes a timing information update. At step 2908, networking device operating as the sensing transmitter may update the local timing information according to the timing information update. At step 2910, networking device operating as the sensing transmitter may transmit a transmission response responsive to the transmission request. The transmission response may include a timestamp based on updated local timing information.

Step 2902 includes obtaining, by the sensing transmitter, timing information from an unassociated access point. According to an implementation, networking device operating as sensing transmitter 504-1 may be configured to obtain timing information from sensing receiver 502-1. In an example, the timing information may be an access point TSF timer (for example TSF timer 524-1 of sensing receiver 502-1). In an implementation, sensing transmitter 504-1 may receive the timing information in a beacon frame broadcast by sensing receiver 502-1. In some implementations, sensing transmitter 504-1 may receive the timing information in a probe response from sensing receiver 502-1 transmitted responsive to a probe request of sensing transmitter 504-1.

Step 2904 includes generating, by the sensing transmitter, local timing information according to the timing information. According to an implementation, networking device operating as sensing transmitter 504-1 may be configured to generate local timing information according to the timing information. In examples, the local timing information is a timer offset value determined according to a difference between the timing information and a sensing transmitter TSF timer (for example, TSF timer 545-1). In an example, sensing transmitter 504-1 may determine a timestamp by combining the sensing transmitter TSF timer value with the timer offset value. Further, in an example, the local timing information may be maintained and incremented at sensing transmitter 504-1. In some examples, the local timing information may be incremented at sensing transmitter 504-1 according to a local clock. In some implementations, resynchronization of the local timing information is performed after expiration of a resynchronization timer (for example, resynchronization timer 546-1 associated with sensing receiver 502-1). In examples, a time interval of the resynchronization timer may be determined according to a measurement of timing drift between sensing receiver 502-1 and sensing transmitter 504-1. In some embodiments, sensing transmitter 504-1 may obtain additional timing information from a plurality of additional sensing transmitters 504-(2-N). Further, sensing transmitter 504-1 may generate additional local timing information according to the additional timing information.

Step 2906 includes receiving, by the sensing transmitter, a transmission request from the unassociated access point. The transmission request includes a timing information update. According to an implementation, networking device operating as sensing transmitter 504-1 may be configured to receive a transmission request from sensing receiver 502-1. In an example, the transmission request may include the timing information update. In examples, the timing information update may be a Partial TSF of sensing receiver 502-1. In some implementations, sensing transmitter 504-1 may tune a receiver of sensing transmitter 504-1 to a channel of sensing receiver 502-1. Further, sensing transmitter 504-1 may engage the receiver to receive the transmission request according to the local timing information.

Step 2908 includes updating, by the sensing transmitter, the local timing information according to the timing information update. According to an implementation, networking device operating as sensing transmitter 504-1 may be configured to update the local timing information according to the timing information update.

Step 2910 includes transmitting, by the sensing transmitter, a transmission response responsive to the transmission request. The transmission response including a timestamp based on updated local timing information. According to an implementation, networking device operating as sensing transmitter 504-1 may be configured to transmit a transmission response responsive to the transmission request. In an example, the transmission response may include a timestamp based on updated local timing information. In an example, the transmission request may include a sensing measurement setup request frame and the transmission response may include a sensing measurement setup response frame. In some examples, the transmission request may include a sensing sounding trigger frame and the transmission response may include a sensing transmission. Further, in some examples, the transmission request may include a sensing polling trigger frame and the transmission response may include a CTS-to-self frame.

FIG. 30A and FIG. 30B depict flowchart 3000 for transmitting, by a sensing transmitter, a transmission response responsive to a transmission request received from a sensing receiver, according to some embodiments.

In a brief overview of an implementation of flowchart 3000, at step 3002, networking device operating as a sensing transmitter (for example, sensing transmitter 504-1) may receive timing information from an unassociated access point (for example, sensing receiver 502-1). In an example, the timing information may be received in a beacon frame broadcast by the unassociated access point. At step 3004, networking device operating as the sensing transmitter may generate local timing information according to the timing information. At step 3006, networking device operating as the sensing transmitter may tune a receiver of the sensing transmitter to a channel of the unassociated access point. At step 3008, networking device operating as the sensing transmitter may engage the receiver according to the local timing information. At step 3010, networking device operating as the sensing transmitter may receive a transmission request from the unassociated access point. The transmission request includes a timing information update. At step 3012, networking device operating as the sensing transmitter may update the local timing information according to the timing information update. At step 3014, networking device operating as the sensing transmitter may transmit a transmission response responsive to the transmission request. The transmission response may include a timestamp based on updated local timing information.

Step 3002 includes receiving timing information from an unassociated access point, where the timing information is received in a beacon frame broadcast by the unassociated access point. According to an implementation, networking device operating as sensing transmitter 504-1 may be configured to receive timing information from sensing receiver 502-1, where the timing information is received in a beacon frame broadcast by sensing receiver 502-1. In an example, the timing information may be an access point TSF timer (for example TSF timer 524-1 of sensing receiver 502-1). In some implementations, prior to receiving the transmission request, sensing transmitter 504-1 may engage in a PASN procedure with sensing receiver 502-1.

Step 3004 includes generating, by the sensing transmitter, local timing information according to the timing information. According to an implementation, networking device operating as sensing transmitter 504-1 may be configured to generate local timing information according to the timing information. In examples, the local timing information is a timer offset value determined according to a difference between the timing information and a sensing transmitter TSF timer (for example, TSF timer 545-1). In an example, sensing transmitter 504-1 may determine a timestamp by combining the sensing transmitter TSF timer value with the timer offset value. Further, in an example, the local timing information may be maintained and incremented at sensing transmitter 504-1. In some examples, the local timing information may be incremented at sensing transmitter 504-1 according to a local clock. In some embodiments, sensing transmitter 504-1 may obtain additional timing information from a plurality of additional sensing transmitters 504-(2-N). Further, sensing transmitter 504-1 may generate additional local timing information according to the additional timing information.

Step 3006 includes tuning a receiver of the sensing transmitter to a channel of the unassociated access point. According to an implementation, networking device operating as sensing transmitter 504-1 may be configured to tune a receiver of sensing transmitter 504-1 to a channel of sensing receiver 502-1.

Step 3008 includes engaging the receiver according to the local timing information. According to an implementation, networking device operating as sensing transmitter 504-1 may be configured to engage the receiver according to the local timing information.

Step 3010 includes receiving, by the sensing transmitter, a transmission request from the unassociated access point. The transmission request includes a timing information update. According to an implementation, networking device operating as sensing transmitter 504-1 may be configured to receive a transmission request from sensing receiver 502-1. In an example, the transmission request may include the timing information update. In examples, the timing information update may be a Partial TSF of sensing receiver 502-1. In some implementations, prior to receiving the transmission request, sensing transmitter 504-1 may engage in a PASN procedure with sensing receiver 502-1.

Step 3012 includes updating, by the sensing transmitter, the local timing information according to the timing information update. According to an implementation, networking device operating as sensing transmitter 504-1 may be configured to update the local timing information according to the timing information update.

Step 3014 includes transmitting, by the sensing transmitter, a transmission response responsive to the transmission request. The transmission response including a timestamp based on updated local timing information. According to an implementation, networking device operating as sensing transmitter 504-1 may be configured to transmit a transmission response responsive to the transmission request. In an example, the transmission response may include a timestamp based on updated local timing information. In an example, the transmission request may include a sensing measurement setup request frame and the transmission response may include a sensing measurement setup response frame. In some examples, the transmission request may include a sensing sounding trigger frame and the transmission response may include a sensing transmission. Further, in some examples, the transmission request may include a sensing polling trigger frame and the transmission response may include a CTS-to-self frame.

FIG. 31A and FIG. 31B depict flowchart 3100 for resynchronizing local timing information, according to some embodiments.

In a brief overview of an implementation of flowchart 3100, at step 3102, networking device operating as a sensing transmitter (for example, sensing transmitter 504-1) may transmit a probe request to an unassociated access point (for example, sensing receiver 502-1). At step 3104, networking device operating as the sensing transmitter may receive, responsive to the probe request, a probe response from the unassociated access point. In an example, the probe response may include timing information. At step 3106, networking device operating as the sensing transmitter may generate local timing information according to the timing information. At step 3108, networking device operating as the sensing transmitter may receive a transmission request from the unassociated access point. The transmission request includes a timing information update. At step 3110, networking device operating as the sensing transmitter may update the local timing information according to the timing information update. At step 3112, networking device operating as the sensing transmitter may transmit a transmission response responsive to the transmission request. The transmission response may include a timestamp based on updated local timing information. At step 3114, networking device operating as the sensing transmitter may resynchronize the local timing information after expiration of a resynchronization timer.

Step 3102 includes transmitting, by a sensing transmitter, a probe request to an unassociated access point. According to an implementation, networking device operating as sensing transmitter 504-1 may be configured to transmit a probe request to sensing receiver 502-1.

Step 3104 includes receiving, by the sensing transmitter and responsive to the probe request, a probe response from the unassociated access point, wherein the probe response includes timing information. According to an implementation, networking device operating as sensing transmitter 504-1 may be configured to receive, responsive to the probe request, a probe response from sensing receiver 502-1. In an example, the probe response may include timing information. In an example, the timing information may be an access point TSF timer (for example TSF timer 524-1 of sensing receiver 502-1).

Step 3106 includes generating, by the sensing transmitter, local timing information according to the timing information. According to an implementation, networking device operating as sensing transmitter 504-1 may be configured to generate local timing information according to the timing information. In examples, the local timing information is a timer offset value determined according to a difference between the timing information and a sensing transmitter TSF timer (for example, TSF timer 545-1). In an example, sensing transmitter 504-1 may determine a timestamp by combining the sensing transmitter TSF timer value with the timer offset value. Further, in an example, the local timing information may be maintained and incremented at sensing transmitter 504-1. In some examples, the local timing information may be incremented at sensing transmitter 504-1 according to a local clock. In some embodiments, sensing transmitter 504-1 may obtain additional timing information from a plurality of additional sensing transmitters 504-(2-N). Further, sensing transmitter 504-1 may generate additional local timing information according to the additional timing information.

Step 3108 includes receiving, by the sensing transmitter, a transmission request from the unassociated access point. The transmission request includes a timing information update. According to an implementation, networking device operating as sensing transmitter 504-1 may be configured to receive a transmission request from sensing receiver 502-1. In an example, the transmission request may include the timing information update. In examples, the timing information update may be a Partial TSF of sensing receiver 502-1. In some implementations, prior to receiving the transmission request, sensing transmitter 504-1 may engage in a PASN procedure with sensing receiver 502-1.

Step 3110 includes updating, by the sensing transmitter, the local timing information according to the timing information update. According to an implementation, networking device operating as sensing transmitter 504-1 may be configured to update the local timing information according to the timing information update.

Step 3112 includes transmitting, by the sensing transmitter, a transmission response responsive to the transmission request. The transmission response including a timestamp based on updated local timing information. According to an implementation, networking device operating as sensing transmitter 504-1 may be configured to transmit a transmission response responsive to the transmission request. In an example, the transmission response may include a timestamp based on updated local timing information. In an example, the transmission request may include a sensing measurement setup request frame and the transmission response may include a sensing measurement setup response frame. In some examples, the transmission request may include a sensing sounding trigger frame and the transmission response may include a sensing transmission. Further, in some examples, the transmission request may include a sensing polling trigger frame and the transmission response may include a CTS-to-self frame.

Step 3114 includes resynchronizing the local timing information after expiration of a resynchronization timer. According to an implementation, networking device operating as sensing transmitter 504-1 may be configured to resynchronize the local timing information after expiration of a resynchronization timer (for example, resynchronization timer 546-1 associated with sensing receiver 502-1). In examples, a time interval of the resynchronization timer may be determined according to a measurement of timing drift between sensing receiver 502-1 and sensing transmitter 504-1.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

1-32. (canceled)

33. A method for Wi-Fi sensing carried out by a sensing responder and including at least one processor configured to execute instructions, the method comprising:
receiving, by the sensing responder, timing information from an unassociated access point;
receiving, based on the timing information, by the sensing responder, a first transmission request from the unassociated access point, the first transmission request including a timing information update;
transmitting, by the sensing responder, a first transmission response responsive to the first transmission request;
updating, by the sensing responder, the timing information based on the timing information update;
receiving, based on the updated timing information, by the sensing responder, a second transmission request from the unassociated access point; and
transmitting, by the sensing responder, a second transmission response responsive to the second transmission request.

34. The method of claim 33, wherein the first transmission request includes a sensing measurement setup request frame and the first transmission response includes a sensing measurement setup response frame.

35. The method of claim 33, wherein the first transmission request includes a sensing sounding trigger frame and the first transmission response includes a sensing transmission.

36. The method of claim 33, wherein the first transmission request includes a sensing polling trigger frame and the first transmission response includes a CTS-to-self frame.

37. The method of claim 33, wherein the timing information is an access point TSF timer of the unassociated access point.

38. The method of claim 37, wherein the timing information update is a timer offset value determined according to a difference between the timing information and a sensing responder TSF timer.

39. The method of claim 37, wherein the timing information update is a Partial TSF of the unassociated access point.

40. The method of claim 33, wherein the timing information is maintained and adjusted at the sensing responder according to a local clock.

41. The method of claim 33, wherein the unassociated access point is a first unassociated access point, the method further comprising:
receiving, by the sensing responder, additional timing informations from a plurality of additional unassociated access points;
obtaining, by the sensing receiver, additional timing information updates from the plurality of additional unassociated access points;
updating, by the sensing receiver, the additional timing informations based on the additional timing information updates;
receiving, based on the additional timing information updates, by the sensing receiver, additional transmission announcements from the plurality of additional unassociated access points; and
receiving, by the sensing receiver, additional sensing transmissions following the additional transmission announcements.

42. The method of claim 33, wherein the timing information is received in a probe response transmitted responsive to a probe request of the sensing responder.

43. A system for Wi-Fi sensing comprising:
a sensing responder including at least one processor configured to execute instructions for:
receiving timing information from an unassociated access point;
receiving, based on the timing information, by the sensing responder, a first transmission request from the unassociated access point, the first transmission request including a timing information update;
transmitting, by the sensing responder, a first transmission responsive to the first transmission request;
updating, by the sensing responder, the timing information based on the timing information update;
receiving, based on the updated timing information, by the sensing responder, a second transmission request from the unassociated access point; and
transmitting, by the sensing responder, a second transmission response responsive to the second transmission request.

44. The system of claim 43, wherein the first transmission request includes a sensing measurement setup request frame and the first transmission response includes a sensing measurement setup response frame.

45. The system of claim 43, wherein the first transmission request includes a sensing sounding trigger frame and the first transmission response includes a sensing transmission.

46. The system of claim 43, wherein the first transmission request includes a sensing polling trigger frame and the first transmission response includes a CTS-to-self frame.

47. The system of claim 43, wherein the timing information is an access point TSF timer of the unassociated access point.

48. The system of claim 47, wherein the timing information update is a timer offset value determined according to a difference between the timing information and a sensing responder TSF timer.

49. The system of claim 47, wherein the timing information update is a Partial TSF of the unassociated access point.

50. The system of claim 43, wherein the timing information is maintained and adjusted at the sensing responder according to a local clock.

51. The system of claim 43, wherein the unassociated access point is a first unassociated access point, the at least one processor being further configured for:
receiving, by the sensing responder, additional timing informations from a plurality of additional unassociated access points;
obtaining, by the sensing receiver, additional timing information updates from the plurality of additional unassociated access points;
updating, by the sensing receiver, the additional timing informations based on the additional timing information updates;
receiving, based on the additional timing information updates, by the sensing receiver, additional transmission announcements from the plurality of additional unassociated access points; and
receiving, by the sensing receiver, additional sensing transmissions following the additional transmission announcements.

52. The system of claim 43, wherein the timing information is received in a probe response transmitted responsive to a probe request of the sensing responder.
